(19) United States
(12) Patent Application Publication
(10) Pub. No.: US 2023/0028153 A1
(43) Pub. Date: Jan. 26, 2023

(54) Arrangement For Moving Fenestration Panels

(71) Applicant: KAV Hungária Kft., Budapest (HU)

(72) Inventor: Károly Lovász, Gödöllö (HU)

(73) Assignee: KAV Hungária Kft, Budapest (HU)

(21) Appl. No.: 17/786,336

(22) PCT Filed: Dec. 17, 2020
(86) PCT No.: PCT/HU2020/050060

§ 371 Date: Jun. 16, 2022

(30) Foreign Application Priority Data
Dec. 20, 2019 (HU) P1900452

(51) Int. Cl. E06B 3/50; E06B 3/92; E06B 3/46

(52) U.S. Cl. CPC E06B 3/509; E06B 3/924; E06B 3/4645

(57) ABSTRACT

The invention is an arrangement for moving fenestration panels, comprising
fenestration panels (12a-12d) each having two guiding elements protruding respect to each of opposite guide sides, and
two track constructions (5) having identical paths, each adapted oppositely arranged for guiding the two guiding elements.

In the arrangement the track constructions (5) are adapted to be arranged in a lower and upper structure portion, comprising
first, second and third main track element (10a-10c) adapted to be arranged beside each other, and
connector track elements (26a′-32b″) adapted for interconnecting the first and second main track element (10a, 10b), and the second and third main track element (10b, 10c), a track element-connecting pair (32a, 32b) of them is configured being suitable for separated transferring of the guiding elements of each fenestration panels (12a-12d) between the main track elements (10a-10c).

### TECHNICAL FIELD

The invention relates to an arrangement for moving fenestration panels.

### BACKGROUND ART

Glazed and other assembled facade panels (fenestration elements) of residential houses, communal buildings, restaurants need to be moved on a daily basis due to their use (airing/ventilation, opening for terrace access, etc.) and for cleaning purposes. Today, if panels (glazed fenestration elements/sashes) weighing more than 400 kg need to be moved, the only feasible option is to apply a parallel sliding door system, wherein the only opening option is parallel sliding. The upper weight limit of the best sliding door systems is only 1000 kg even in the case of sliding panels.

Fenestration elements (windows or door sashes) currently in use have the following opening types:
Fixed—the panel cannot be moved;
Tilting—the top edge is displaced in the direction of the interior and assumes a ventilation rest position;
Turning—one of the lateral edges is moved in the direction of the interior and opens at a certain angle;
Turning-tilting—a mixture of the latter two modes that can be operated by turning the handle in the appropriate direction;
Folding (accordion)—several sashes (vents, wings) can be arranged to be retained in a bottom and a top rail track in an “accordion” fashion applying hinges adapted for joining the lateral edges;
Sliding without fixed panel arranged beside it—the sash runs along a rail, i.e. it can be slid dry along a rail track affixed to the inside or outside wall face utilizing a rolling carriage or a brush rail;
Sliding with fixed panel arranged beside it—the sash runs along a rail, i.e. it can be slid dry along a rail track affixed to the inside or outside of the fixed (even glazed) panel, utilizing a rolling carriage or a brush rail;
Sliding-tilting—by turning the handle in the appropriate direction a tilt (ventilation/airing) function can be accessed, or, if the handle is turned further to another handle position the sash can be slid along a rail structure affixed to the upper frame from the inside applying a roller ironing. Shortcomings of the system: relatively low weight limits, prone to failure, robust appearance (conventional frame-sash connection);
Multi-rail sliding door—multiple sashes run along multiple rails, i.e. they can slide dry along rail tracks extending along the inside or outside faces of fixed elements utilizing rolling carriages or brush rails. The number and arrangement of the sashes are limited by the number of the included rails and by geometry, as the aim is to achieve the greatest openable surface area possible. In the activated state, all of the moving sashes can be arranged in a staggered configuration behind or in front of the fixed sashes;
Lifting-sliding—the sashes can move along one or more rails, the entire sash frame being placed on the rail by turning a handle functioning as a lever, utilizing a roller carriage that can be pushed out downward from a bottom chamber of the sash, so that the sash can slide along the outside or inside face of the fixed elements. The number and arrangement of the sashes are limited by the number of the included rails and by geometry, as the aim is to achieve the greatest openable surface area possible. In the activated state, all of the moving sashes can be arranged in a staggered configuration behind or in front of the fixed sashes;
Parallel opening—a sash can be lifted out from a plane, parallel to its rest position, in the direction of the interior or the exterior, with the help of ironing scissors elements (friction stays) disposed on the sides or opposite each other at the bottom and the top;
Outward lifting—the bottom edge moved outward, assuming a ventilation-rest position. Applied primarily for windows in highrise office buildings;
Pivoting—the sash can turn about a completely horizontal or completely vertical axis that connects two opposite sides of the sash. Nowadays, this configuration is only utilized for roof windows and entrance doors;
Stackable glazed wall with rails—the fully or partially glazed sashes—having a suspended roller mechanism at the top and free-floating or rail-guided roller configuration at the bottom—can be “stacked” manually or by motorized means, as in a conveyor system. The rail track may have a custom layout, and may include switches, collecting tracks, etc. The advantage of the system is that the panels of the entire glazed surface (even as long as 20m) can be stacked and concealed relatively easily; its disadvantages are that only relatively narrow glazed panels can be applied, it has poor load-bearing capacity, and insufficient wind sealing. It is applied infrequently in thermal bridge-free version, and has many limitations. It can only be built in at a vertical orientation; the elements at the endpoints have open or slide functions, moreover, the entire row can only be pulled sideways like a train, in a sequence, one after the other.

According to the above, a number of patent documents are related to moving fenestration elements in relation to opening and closing such elements.

HU 223 805 B1 patent discloses a window wherein the window sashes—that are arranged below each other in the closed state—can be opened by sliding them along a guide groove system. Such a state is also illustrated in the document wherein the window sashes are recessed into the wall portion under the window.

The rail system of the approach disclosed in HU 223 805 B1 is configured according to needs arising from the window function, and allows for movements that are required to fulfill this function (see FIGS. 1a-1h of the document).

In the base position the window sashes are situated below each other. The closed state of the base position can be opened by tilting the lower window sash: the upper edge of the lower window sash is displaced outward along a horizontal rail, followed by moving the lower window sash behind the upper one by passing its bottom edge along a curved rail having an appropriate shape (FIGS. 1a-1c).

After that—because the lower window sash is not in its place—the upper window sash can be descended into the position assumed by the lower sash in the base position (FIG. 1d), while the window situated in the rear can be descended into the wall portion under the window (FIG. 1e) and can there be put aside (see the subsequent figures; like with the opening of the lower window sash from the base position, this can be performed utilizing rails arranged in the wall portion under the window: the lower part of the sash is introduced to the corresponding storage rack along an inclined rail, followed by finally tilting in place the upper part). This approach includes a dedicated rail portion (reversible guide section) adapted for introducing the upper window sash into the wall portion under the window, with the help of which the upper window sash can also be introduced into the wall portion under the window (FIGS. 1f-1h).

The above described approach has the disadvantage that the window sashes can only be moved in a constrained manner, and a number of situations can occur wherein they block each other.

In GB 1 263 866 moving (laterally sliding) of panels separated by divider ribs is disclosed. The panels can be transferred between independent tracks utilizing a mechanism.

Likewise, a dedicated mechanism is adapted for placing the panels between tracks in U.S. Pat. No. 4,574,524 and CN 204370956 U. According to the latter document, when transferred on another track, a door may assume a position in front of another one, however, according to FIG. 11 of the document, the configuration hinders the exchange of the doors.

In JP 2010024800 A a construction for moving panes is disclosed. In the construction, the wheels of a four-wheeled trolley are seated on hung rails, with a pane retained in the trolley hanging therefrom. Corresponding to the four-wheeled trolley, double rails are arranged in a rectangular fashion, whereby they can provide for moving the panes (also providing for an appropriate change of direction at the corners) along a rectangular closed path (due to that, of course the trolleys of the different panes cannot pass each other). According to the description, the construction is an entrance/exit construction that could be utilized as an alternative of revolving doors. Based on FIGS. 1 and 2 of the document, the 3-3 windows at both ends of the apparatus do not close against each other, instead, the outermost ones can slide behind the middle one such that they can fulfil the closed path.

In KR100806171 an approach is disclosed wherein panels are pushed and pulled back and forth along rails.

A common disadvantage of the approach of the above referenced Japanese language document and the prior art approaches cited above is their relatively low variability in moving the panels and panes (in many cases this stems from their intended function).

In view of the known approaches, there is a demand for an arrangement for moving fenestration panels that eliminates the drawbacks of prior art such arrangements to the greatest possible extent.

### DESCRIPTION OF THE INVENTION

The primary object of the invention is to provide an arrangement for moving fenestration panels, which is free of the disadvantages of prior art approaches to the greatest possible extent, i.e. eliminates the drawbacks of prior art arrangements.

A further object of the invention is to provide an arrangement for moving fenestration panels that has higher variability—as far as the movement and possibilities for moving of the panels is concerned—than the known approaches, and can be operated more effectively than these.

The objects of the invention can be achieved by the arrangement for moving fenestration panels according to claim 1. Preferred embodiments of the invention are defined in the dependent claims.

In contrast to conventional sliding door systems, wherein the sliding doors travel along parallel tracks without crossing each other's paths, in the arrangement for moving fenestration panels according to the invention the tracks running parallel with the ground-plan line are repeatedly interrupted by transverse-direction tracks (in a matrix-like fashion), the tracks forming an interconnected network (this can also be called a “raster-net rail/track-rail system”).

Repeating of the connector track elements (or called transverse-direction tracks) allows for increasing or decreasing (of course, within certain limits) the width of the fenestration panels (sashes) without hindering operation, because the location of the support and the upper guide is determined, for a given sash, by the distance between the axes of the transverse-direction tracks. In the case of conventional sliding doors, variable sash width either cannot be achieved at all, or, if it can be implemented, it is unserviceable; therefore, the option to apply variable-width sashes (vents, wings) provides outstanding freedom to the building designer for making the appearance of a given building unique.

Thanks to its movement principle, the arrangement according to the invention is primarily adapted for implementing fenestration products that are suited for filling large-sized wall openings (having great height and width) or—in case of a need—it can be fully opened.

In the arrangement for moving fenestration panels according to the invention, preferably
the panels (sashes) are interchangeable,
the simultaneous, mutually independent sideways movement of the panels (sashes) can be achieved,
the guiding elements (or called “wing shafts”) are preferably not lifted out (particularly from the closed state) at an angle of 90°.

To our knowledge, there is no existing arrangement for moving fenestration panels implementing such functions.

### BRIEF DESCRIPTION OF THE DRAWINGS

Preferred embodiments of the invention are described below by way of example with reference to the following drawings, where

FIG. 1 is a schematic drawing illustrating, in a closed state, an embodiment of the arrangement according to the invention for moving fenestration panels,

FIG. 2 shows a side view illustrating the embodiment of FIG. 1 of the arrangement according to the invention,

FIG. 3 shows a top view of the arrangement of FIG. 1 (in so-called ground-plan view),

FIG. 4 is a schematic drawing illustrating, in an open state, the embodiment of the arrangement according to the invention shown in FIG. 1,

FIG. 5 shows a side view illustrating the embodiment of the arrangement according to the invention shown in FIG. 4,

FIG. 6 shows a top view of the arrangement of FIG. 4,

FIG. 7 is a detail drawing of FIG. 1, showing a view and a top view in a single drawing,

FIG. 8 corresponds to the detail drawing of FIG. 7, indicating details shown in magnified views below,

FIG. 9A shows a magnified view of the bottom enframed detail of FIG. 8,

FIG. 9B shows the detail of FIG. 9A, also indicating the internal structure of the panel and the threshold,

FIG. 9C illustrates the internal structure of the ball roller shown in FIGS. 9A and 9B,

FIG. 10A shows a magnified view of the top enframed detail of FIG. 8,

FIG. 10B shows a detail according to FIG. 10A, also indicating the internal structure of the frame and the panel,

FIG. 11A shows a magnified view of the enframed detail of FIG. 7,

FIG. 11B shows the detail according to FIG. 11A, also showing further details,

FIG. 12 is a detail drawing similar to FIG. 7 showing the tilted state of the panel,

FIG. 13 is a side drawing corresponding to FIG. 12, showing in a frame the detail to be illustrated in a magnified view below,

FIG. 14A shows a magnified view of the enframed detail of FIG. 13,

FIG. 14B shows the detail of FIG. 14A, also depicting the internal structure of the frame and the panel,

FIG. 15 is a top view drawing illustrating the track construction of the embodiment of the invention illustrated in FIGS. 1-3,

FIGS. 16A-16G illustrate various panel arrangements on the track construction shown in the top view drawing of FIG. 15,

FIG. 17A illustrates, in side view, panels arranged on different main track elements,

FIG. 17B shows a contracted side view based on FIG. 17A,

FIGS. 18A-18B are spatial drawings illustrating, in closed and open state, an embodiment that is similar to the one depicted above, showing the bottom portion of the panels,

FIGS. 19A-19B illustrate the closed and open states of FIGS. 18A-18B in another view,

FIGS. 20A-20B show the top portion of the embodiment of FIGS. 18A-18B in closed and open state,

FIGS. 21A-21B show a further view of the top portion of the embodiment of FIGS. 18A-18B,

FIGS. 22A-22E illustrate various views of the brush holder element shown in FIG. 11B,

FIG. 23 is a schematic drawing illustrating a further embodiment of the arrangement for moving fenestration panels according to the invention,

FIGS. 24A and 24B are schematic drawings illustrating the opening and tilting of the fenestration panel illustrated in FIG. 23,

FIGS. 25A and 25B show views illustrating the closed and open state of a first closure type,

FIGS. 25C and 25D show views illustrating the closed and open state of the closure type depicted in FIGS. 25A-25B,

FIGS. 26A and 26B show views illustrating the closed and open state of a second closure type,

FIGS. 26C and 26D show views illustrating the closed and open state of the closure type depicted in FIGS. 26A-26B, and

FIG. 26E is a rotated view illustrating the connection element utilized in FIGS. 26A-26B.

### MODES FOR CARRYING OUT THE INVENTION

The arrangement according to the invention is adapted for moving fenestration panels (or, called alternatively, fenestration elements), so it can also be called a (fenestration) panel moving arrangement, simply a fenestration arrangement, or a fenestration moving arrangement, or even a logistic system moving fenestration elements.

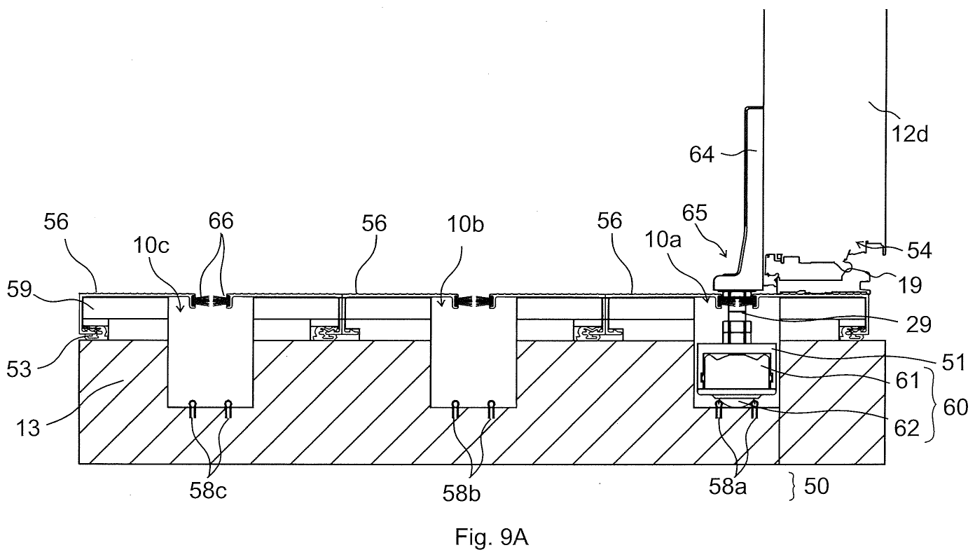

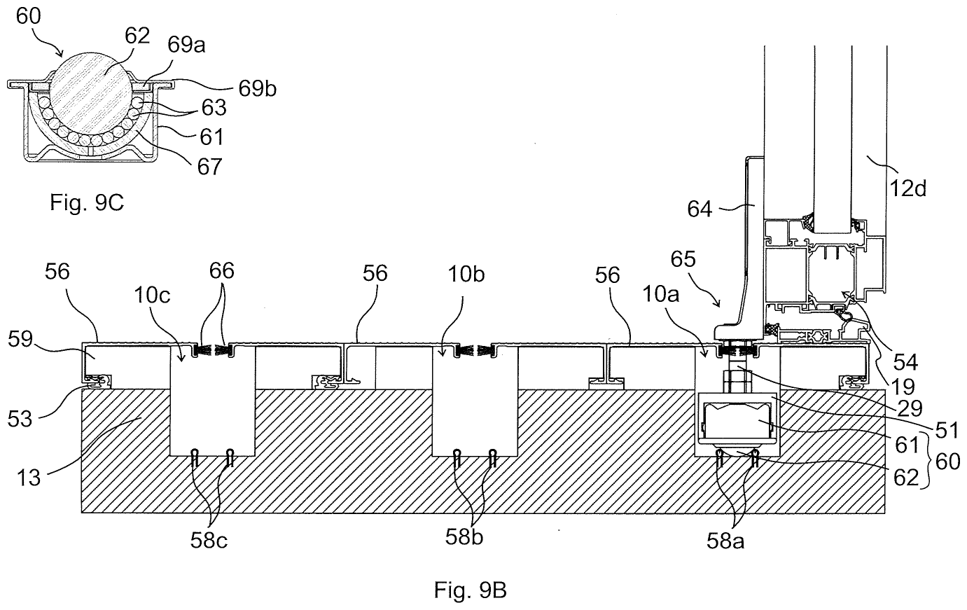

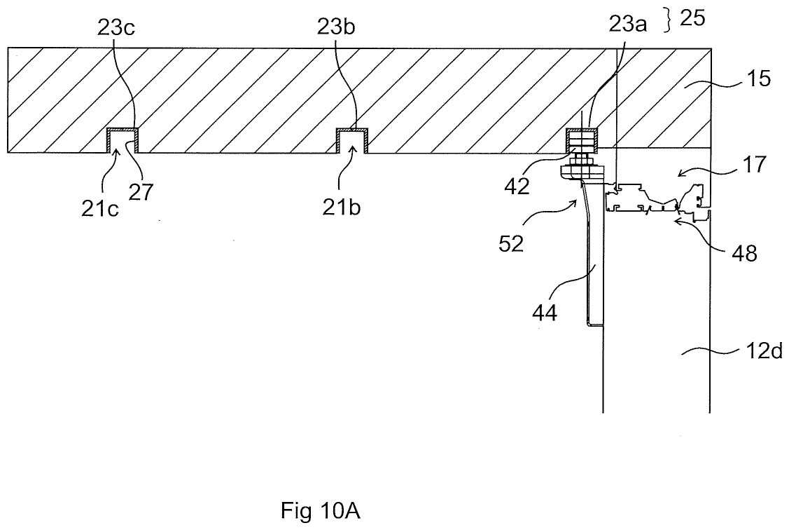

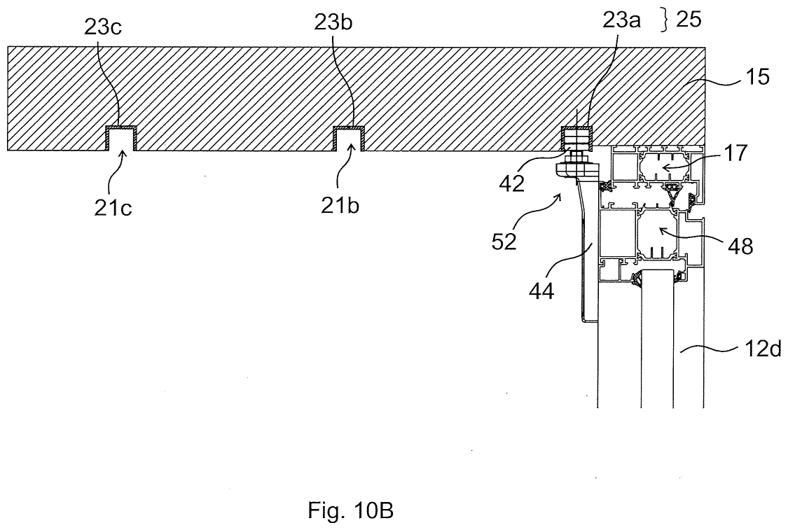

The arrangement according to the invention for moving the fenestration panels comprises
fenestration panels each having two guiding elements protruding respect to each of opposite (mutually opposite) guide sides thereof (two for each guide side; see e.g. fenestration panels 12a-12d in FIG. 1, and an embodiment of the guiding elements to be arranged at the top and the bottom are illustrated in FIGS. 9A and 10A; of course—as it is illustrated in the figures—the respective two guiding elements correspond to each of the oppositely situated/top and bottom guide sides), and
two track constructions having identical paths, each adapted oppositely arranged (i.e. when oppositely arranged) for guiding the two guiding elements protruding respect to each of the opposite guide sides of the fenestration panels (one track construction for guiding two guiding elements; see an embodiment of the lower track construction in FIG. 3; the respective track constructions correspond to the guiding elements being at the oppositely arranged guide sides, essentially at the top and the bottom, see below; the track construction could also be called a track system or track arrangement).

In the arrangement according to the invention the two track constructions are adapted to be arranged in a lower (architectural) structure portion and in an upper (architectural) structure portion (expediently also arranged opposite each other), respectively, (i.e. the track constructions are arranged in a bottom-top way; the (architectural) structure portion can be any such structure that can receive the track construction, i.e. for example they can be called a lower and an upper receiving structure, or their bottom-top arrangement could be formulated in other ways), each of the track constructions comprises
a first, a second and a third main track element adapted to be arranged beside each other (next to each other, alongside each other; see an embodiment of the main track elements also in FIG. 3; see below the advantages—especially related to variability—of utilizing three track elements), and
connector track elements adapted for interconnecting the first main track element and the second main track element, as well as (for interconnecting) the second main track element and the third main track element (these are described in relation to an embodiment related to FIG. 3; the connector track elements interconnect adjacent main track elements, so according to this definition, non-adjacent main track elements are not interconnected directly, but via two connector track elements), wherein a respective track element-connecting pair of the connector track elements (accordingly, the connector track elements form pairs, i.e. one pair is formed between the first and second main track elements, and another pair is formed between the second and third main track elements) is configured being suitable for separated transferring (passing) of the two guiding elements of each of the fenestration panels corresponding to the given track construction (one track element-connecting pair for two guiding elements) between the respective main track elements (separated transferring of, between the respective main track elements, two guiding elements, corresponding to the given track construction, of each of the fenestration panels; i.e. between the first and second main track elements, and between the second and third main track elements).

Each of the track constructions are to be arranged in a lower structure portion and in an upper structure portion, respectively (one for each). This is essentially to say that at the bottom and at the top, and—because the track constructions (track structures) have the same path (route, line)—it follows that the panels will essentially be oriented vertically and will be moved in a vertical position (this does not hold true when, for example, they are brought in a tilted state), but a basic requirement during the movement is—and the track elements guide the panels accordingly—that the lower and upper guiding elements forming the pairs have to be in the same track element at the bottom and on the top on the same path, i.e. these run “parallelly” in the lower and upper track constructions.

The track constructions to be arranged at the bottom and at the top have therefore the same path, i.e. the track elements run identically at the bottom and at the top, the track constructions have mutually matchable configurations. This is necessary in order that the panels can be moved along the unity constituted by the upper and lower track constructions without getting stuck, in a vertical position. As it will be shown, they have the same path, but their configuration is not entirely the same because the lower and upper track constructions—according to their respective functions—are expediently configured for guiding different types of guiding rollers (the lower guiding roller could also be termed “supporting roller” while still using the term “guiding roller” for the upper) so in a different manner, i.e., in the illustrated embodiment, by means of rail pairs and troughs, respectively.

Accordingly, the track construction is not called “rail system” because rails are present in certain configurations thereof; it can however be termed a “track element arrangement”. Certain parts of the track construction are termed “track elements”; according to the above, a distinction is made between main and connector track elements (track portions). As illustrated in the figures, the main track element provides the main direction of the movement, while the connector (connecting) track elements (track switchers between the main track elements) are adapted for interconnecting the main track elements. In the illustrated embodiment the track elements are formed in a recessed manner, i.e. they are configured with an indentation (recess) and a rail pair therein (at the bottom) and a recess (at the top); at the same time, these can be considered elements because they can be formed by appropriately configuring the surroundings.

According to the above, the lower and upper track constructions encompass the panel such that the oppositely arranged guiding elements thereof are received in these, i.e. the guiding elements have to be arranged (at the bottom and also at the top) in the track constructions.

Therefore, the basic requirement related to the mutually analogous lower and upper track constructions is that they have to comprise three main track elements and at least one track element-connecting pair (track element-connection pair) between the first and the second main track element and at least one such pair between the second and the third track elements. As it will be demonstrated below, it can be made a requirement that especially between the first and the second main track elements, but also between the second and the third main track elements to be arranged a dedicated track element-connecting pair for each panel.

According to the above, the main track elements are adapted to have a side-by-side arrangement. In the embodiments illustrated in the figures, the main track elements are straight, run parallel to each other, are arranged spaced apart from each other with a gap, and are interconnected by the connector track elements.

According to the figures this also holds true for the parking track portions in the parking track block.

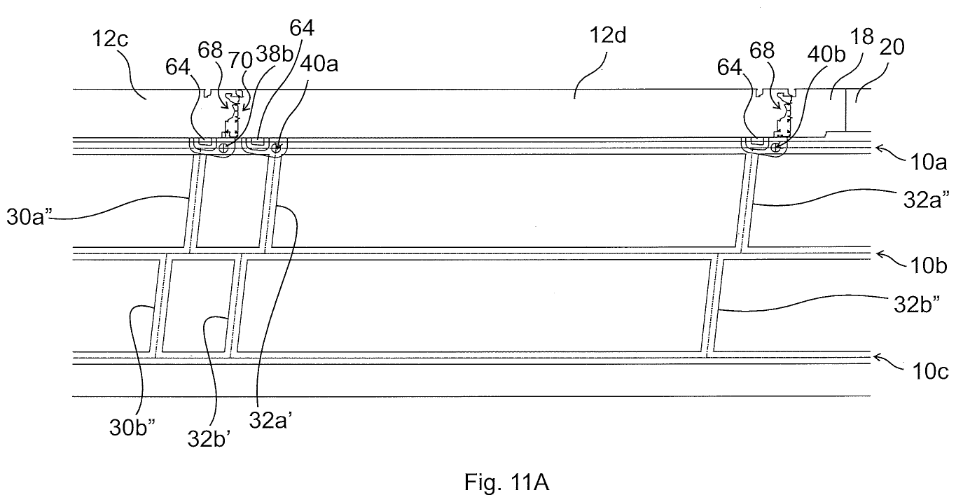

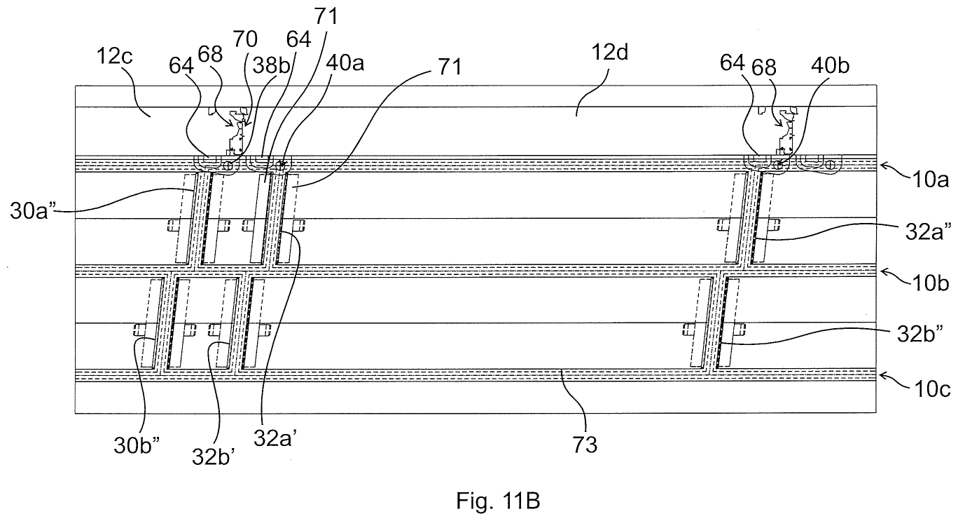

The side-by-side arrangement is necessary for forming a track construction from the track elements (with the main track elements being completed by the connector track elements). The distance of the main track elements from each other is affected by the thickness of the panels (their extension perpendicular to the main track elements) and the arrangement of the guiding elements, as this is what determines how the panels get arranged with respect to the main track element (cf. e.g. FIG. 11A). It is, of course, has to be ensured that the panels can be moved behind each other along adjacent main tracks without hindering each other.

A panel preferably not only comprises two guiding elements along a guide side but has exactly two, i.e. in an embodiment there cannot be arranged more guiding elements along a guide side than this. In such a case the two guiding elements are of course situated along a straight line, i.e., in other words, it can be considered to be supported along a (straight) line.

The connector track elements of the track element-connecting pair are of course situated between the same main track elements, so both are situated between a first and a second, or between a second and a third main track element.

As it is also pointed out herebelow, the panels can be glazed (glass panels in some type of frame) or filled in a solid way, or—as with conventional doors and windows, typically disposing the filling part in a frame—may have other types of filling. The configuration details of the invention related to this are not relevant, i.e. they can be freely chosen and created.

The guiding element can be implemented in several ways (for example, like in the illustrated embodiment, differently at the top and the bottom). It is preferably formed by means of a guiding roller (in this case, the track construction is adapted for guiding that; the guiding roller forms a part of the guiding element), but other solutions can also be conceived, for example utilizing only a protruding element (an element with a shaft-like configuration) at the top, or even also at the bottom that is guided in some manner (in this case the track construction guides directly the guiding element rather than an element forming a part of the guiding element). It is also possible to apply electromagnetic feet instead of rollers, for magnetic levitation support at the bottom and friction-free guiding at the top; applying a suitably configured control these can even be operated (moved) automatically (of course, a 90° track pass-through can also be feasible in such cases). In all of these cases it is needed to ensure expediently as easy movability as possible inside the track elements, by providing a well sliding relationship (even by lubrication) between the elements being in contact.

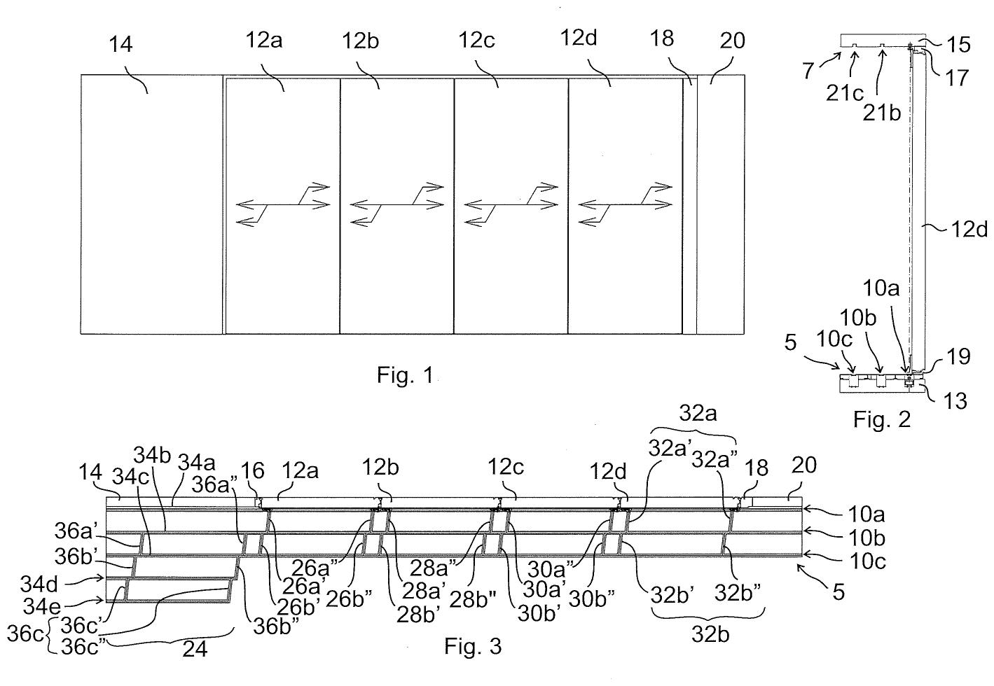

As touched above, two respective guiding elements are arranged at each of the oppositely situated guide sides (two for each) of the fenestration panels. This is applied according to the following reasons: The panels are run in the track construction on downwards-protruding guiding elements, i.e. two guiding elements are needed to ensure that a given panel does not become tilted. The two guiding elements at the top are needed so that they guide the panel in a coordinated manner also at the top in the track construction having the same path. Accordingly, as with the guide sides, the two lower guiding elements and the two upper guiding elements are situated on the panel opposite each other, i.e. the lower and upper guiding elements are “paired” also in this manner, or to put it in another way, they are aligned along an axis (this is illustrated by the vertical dashed-dotted line in FIG. 2). In this case, the paired lower and top guiding elements—provided the panel is in the vertical position—arrive at a given point of the identically configured track constructions, for example at a junction formed between the track elements, at the same time.

In relation to the guiding elements, it was also given above that they protrude respect to the opposite guide sides of the panels. Each panel will be naturally guided along its two opposite sides; the panels typically having a rectangular shape (their size is considerably large when seen from the front so they can also be called fenestration sashes), it depends on the panel's thickness to what extent it can be regarded as essentially rectangular block-shaped, or, as it will be shown—in the case of a slightly “oblique” shape—as having a parallelogram based prism-shape; however, thin panels also have guide sides (besides that, even a very thin panel can be regarded as a rectangular block or prism), and also those which have a significant thickness (accordingly, the guide side can also be called “guide face”). The guiding elements protrude with respect to these guide sides precisely in order to fulfil their guiding function. The term “panel” is thus used according to the above, referring to a large surface-area plate with a typically low thickness compared to that. In relation to the panels, it was specified above that there is a plurality of them, preferably it can also be specified that the arrangement comprises at least three panels, or even at least four of them. In such cases variability can manifest itself to an even greater degree.

The guiding elements are therefore responsible for guiding; the guide side itself (as its name indicates, it is only related to the guiding) will not be guided, but only the guiding elements connected to the panels, which—like in the illustrated cases—can be connected to the face of the panel adjacent to the guide side (this is the “large” side of the panel) but can also protrude from the guide face itself (the phrase “protruding respect to the guide side” is meant to include this as well; it is not expedient to affix them to the side facing the adjacent panels or the closing lateral element (i.e. fixed panels) because those sides are typically responsible for sealing, however, they can also be connected thereto). The guide sides themselves can be observed in FIG. 3 wherein the panels are shown in top view, i.e. precisely their guide sides that can be seen.

FIG. 1 shows an embodiment of the arrangement according to the invention comprising four fenestration panels 12a-12d. FIG. 1 is a schematic front view of this embodiment, while the side drawing of FIG. 2 and the top drawing of FIG. 3 that show the panels 12a-12d and other features in more detail also relate to this embodiment.

FIGS. 1-3 show a base position corresponding to a closed state of the arrangement. This state is called closed state because the panels 12a-12d are connected to each other and to the first and second closing lateral elements 14, 20 such that the fenestration panels 12a-12d close/cover the opening that they can also free up (in a manner detailed below). Accordingly, the panels are responsible for covering (“closing”) an opening; besides that, in relation to the invention the qualifier “fenestration” can optionally be omitted from before the noun “panel”.

In FIG. 2 the closed state is shown in a sectional view taken across one of the panels. The section shown in the figure is taken across the panel 12d (any other panel could have been chosen). Because in this state the panels 12a-12d are placed beside each other, the other panels are not visible in the figure. At the same time, in the side view of FIG. 2 a first (lower) track construction 5 being in a lower structure portion 13 and a second (upper) track construction 7 being in an upper structure portion 15 are shown. The sectional view according to FIG. 2 shows only a few from the track constructions 5, 7. In FIG. 3, the track construction 5 according to this embodiment is shown in top view.

In FIG. 2 in the lower structure portion 13 a lower first main track element 10a, a lower second main track element 10b, a lower third main track element 10c, and, in the upper structure portion 15, an upper first main track element 21a, an upper second main track element 21b, and an upper third main track element 21c are also shown. It can be observed that in the base position the panels (thus the panel 12d shown in FIG. 2) are arranged at the bottom and at the top, respectively, in the appropriate first main track elements 10a and 21a.

In FIG. 2 guiding elements arranged at the bottom and at the top of the panel 12d are shown, the configuration of these elements according to this embodiment is described below in relation to a magnified drawing. In FIG. 2 there is also shown a straight line (indicated by dash-dot) interconnecting the guiding elements and illustrating that in this embodiment the guiding elements are slightly arranged sidewise with respect to the panel 12d.

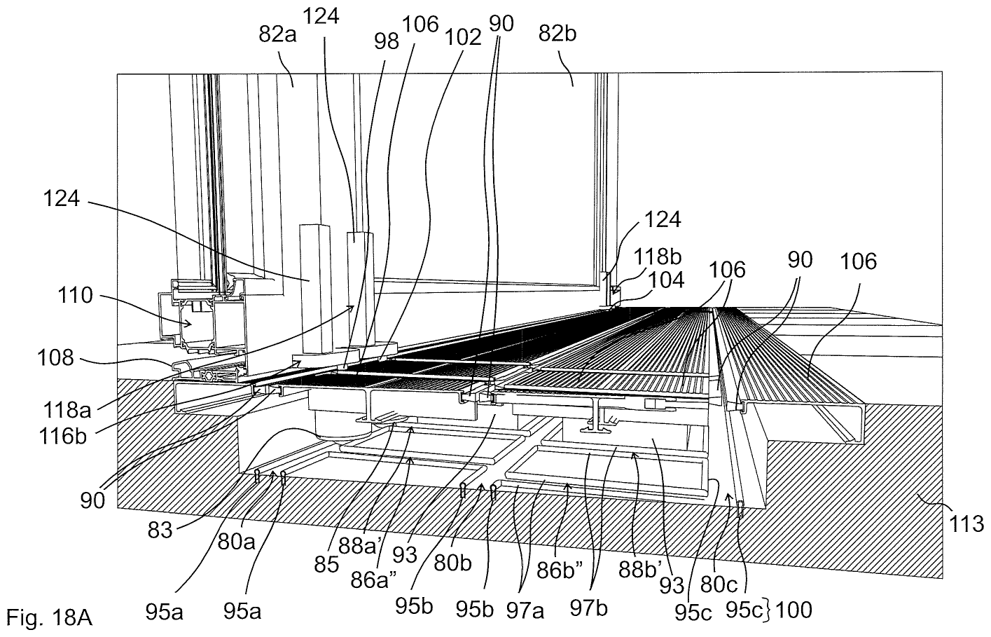

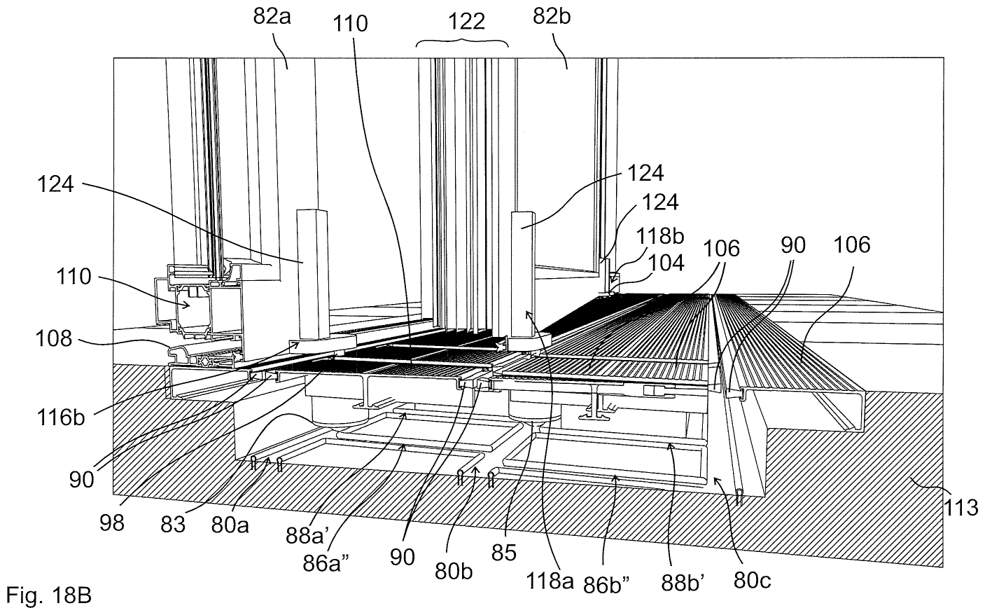

The top view of FIG. 3 illustrates several characteristics of the invention in an embodiment. The details that are also shown in FIG. 1 correspond to the top of FIG. 3; in FIG. 3 the closing lateral elements 14, 20 and the panels 12a-12d that (in the closed state) are arranged between them are shown arranged along a line. The first closing lateral element 14 has a first lateral sealing portion 16 against which the corresponding sealing portion of the panel 12a seals, while the second closing lateral element 20 has a second lateral sealing portion 18 (this latter is shown in FIG. 11A also in a top view). The closing lateral elements 14, 20 are typically such extension elements running along the vertical longitudinal direction of the panel that seal against the sides of the panel provided with sealing portions (cf. FIG. 11A and the open states of FIGS. 18B, 19B, 20B, and 21B).

The sealing portion can also be called a portion/side equipped with sealing elements, because it typically provides sealing such that sealing element (for example sealing rubber) are arranged on the circumference or only along some of the edges. Such sealing elements are applied also in conventional fenestrations, and these can also be observed in FIGS. 9B, 10B, or in FIGS. 18B, 19B, 20B and 21B showing the open sealing portion.

Preferably, the rubber sealings on the sealing portions are not intended for tangential-direction shifting movement of the two panels; the illustrated sealing will fail if subjected to such loads. If, however, they are displaced in a manner that is consistent with their operation as linear sealings (for which they were developed) they will operate. The panels move like a wing being opened; the sealing element of the sealing portion is configured accordingly.

In addition to the closing lateral elements 14, 20 and the panels 12a-12d arranged along a single line, in FIG. 3 a track construction 5 is also shown. As it is observable also in FIG. 2, the track construction 5 comprises three main track elements: the first main track element 10a, the second main track element 10b, and the third main track element 10c that—thanks to the top view visualization—can be better observed in FIG. 3 than in FIG. 2. The configuration of the track construction 5 defines a main direction of movement, according to which the connector track elements are also set (inclined) in the direction of the parking track block. An opposite-direction movement is also possible and the connector track elements can also be oriented in that direction (essentially mirroring the track construction), while it is also not necessary that they are oriented in the direction of the block of parking tracks (if at all such a block is included).

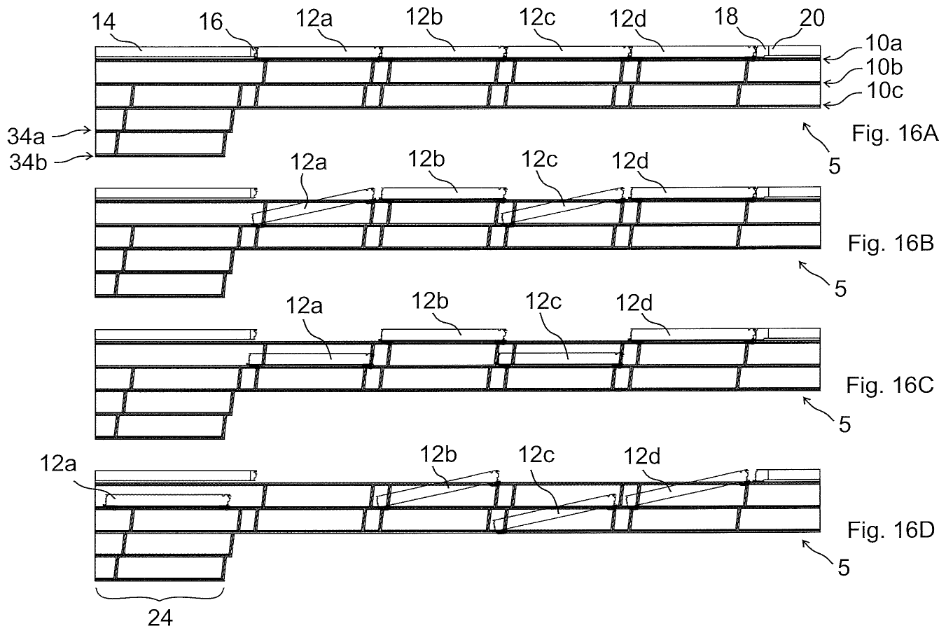

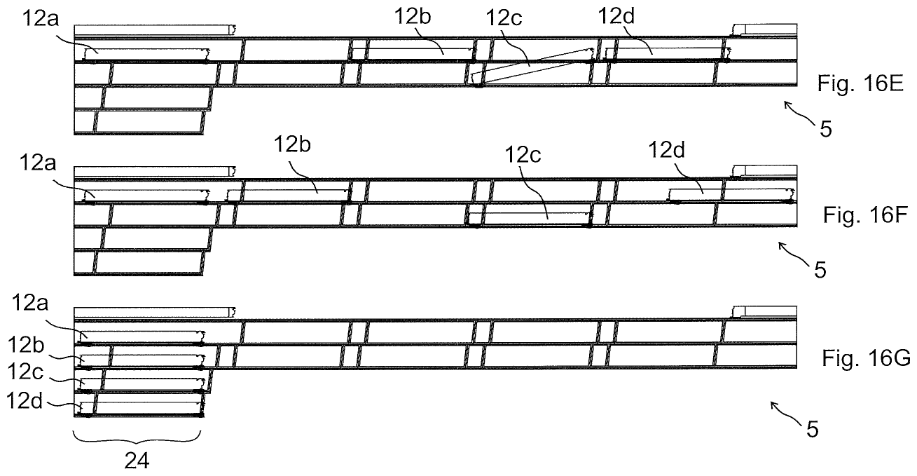

As it is also illustrated in FIG. 3, in the present embodiment the main track elements 10a-10c extend along the entire width of the arrangement, but in relation to that it also noted that—as in the present embodiment each panel is arranged (thanks to its guiding elements) such that the panel itself is situated beside the track element receiving the guiding elements—the panels 12a-12d cannot be pulled in front of the closing lateral elements 14, 20 along the first main track element 10a, so the track elements situated here does not inevitably needed. Furthermore, there can be such laterally outermost arranged track element parts along which in principle the panel does not travel during the movements, but other outermost track element portions can also be utilized during arranging the panels 12a-12d (cf. FIGS. 16A-16G, especially FIGS. 16F and 16G).

Based on FIG. 3, the way of arrangement (allocation) of the connector track elements according to the present embodiment is presented. Firstly, let us disregard the portion shown in front of the closing lateral element 14 on the left of FIG. 3, which portion corresponds to the parking track block 24 (the panels can be collected in the region corresponding to the parking track block 24 in case they are all to be put aside, cf. the description of the parking tracks below and FIG. 16G). To the right relative to this portion the main track elements 10a-10c and the connector track elements arranged between them are shown. As indicated by their reference numerals, the connector track elements are expediently considered as forming pairs for each main track element pair. These pairs were termed “track element-connecting pairs” above. As shown in FIG. 3, in this embodiment one such pair belongs to each panel, both for the pair of main track elements situated closer to the panels 12a-12d arranged in their base position (the pair constituted by the first and second main track elements 10a, 10b) and for the track element pair situated further (i.e. the pair constituted by the main track elements 10b, 10c). This arrangement lends a high degree of variability (in other words, supervariability) to this embodiment.

According to the above, from right to left in FIG. 3 a first and a second connector track element 32a′ and 32a″—that are arranged between the main track elements 10a and 10b—form a first track element-connecting pair 32a. A second track element-connecting pair 32b is indicated for connector track elements 32b′, 32b″ on the right, this is formed by the first and second connector track elements 32b′, 32b″ arranged between main track elements 10b and 10c. These also holds true for the similarly numbered first, second, third and fourth connector track elements 30a′, 30a″, 30b′ and 30b″, first, second, third and fourth connector track elements 28a′, 28a″, 28b′, 28b″, and for the first, second, third and fourth connector track elements 26a′, 26a″, 26b′ and 26b″ in the case of which the track element-connecting pairs can be identified (and, optionally, numbered) accordingly, by interconnecting the elements with the same alphabetic identifier. As shown in FIG. 3, a connector track element 36a″ of the parking track block 24 and the connector track element 26b′ are situated beside each other.

The block corresponding to the parking tracks enables the user to unify two rooms that in the closed state are divided by the panels of the arrangement according to the invention (for example, a room and a terrace/environment or indoors), which can be done by “stacking” the sashes inside or behind a wall, that is, applying the block corresponding to the parking track.

In FIG. 3 a kind of cyclicity can be observed in the configuration which allows for modular construction that equally facilitates design and assembly. For example, a prefabricated track matrix—preferably also comprising crossings—can be created which can be laid out beside each other with appropriate interruptions (inserting straight sections) and thus an “endless” structure can be made with calculable manufacturing and installation costs, in an optimal package. This configuration option can be expedient for serial production, because—as pointed out above—a degree of cyclicity, repeatability can be implemented. Each module may extend from one crossing to another. Crossings may also be implemented as separate modules (arranged cyclically: module with panel length+crossing module+module with panel length+crossing module, etc.).

Accordingly, the embodiment of FIGS. 1-3 is an embodiment wherein in a base position of the fenestration panels corresponding to a closed state the guiding elements of the fenestration panels are arranged in the first main track element (i.e. a feature is specified here in relation to the base position occurring in the installed state) and a separate track element-connecting pair of connector track elements corresponds to each of the fenestration panels between the first main track element and the second main track element (i.e. each panel has its own pair, as illustrated in FIG. 3). Main track elements with ascending reference numerals were introduced above. Since the numbered track elements are in numeric order, the first one will evidently be an outermost (extreme-position) track element. It is also self-explanatory that numbering starts at the location where the panels are arranged in the base position.

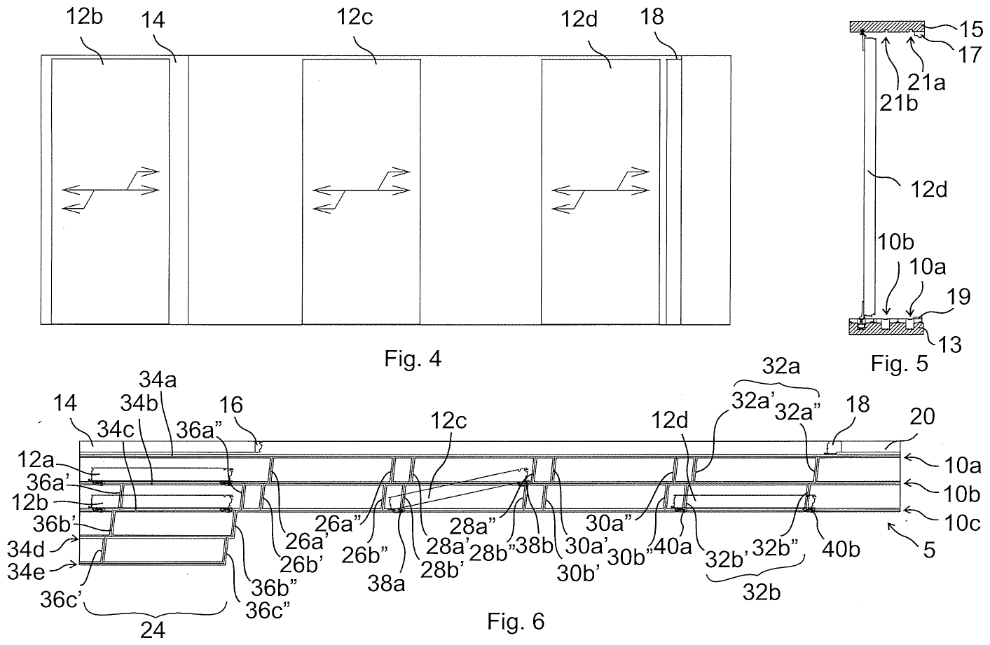

According to the above, the base position corresponding to the closed state of the fenestration panels is the status shown in FIGS. 1-3. In contrast to that, in FIGS. 4-6 an exemplary open state (a shifted state) is illustrated. It is evident from the manner of moving the panels that several different open states are possible (the panels can be arranged in any order when the closed state is opened up in some way), the closed state is, however, a unique one: all panels are in their base position. (the closed state can also be regarded variable in that the order of the panels can be changed; this is important for example if the panels are not identical).

The embodiment illustrated in FIGS. 1-3 it is also fulfilled that a separate track element-connecting pair of the connector track elements (for the outermost-lying connector track element, a track element-connecting pair 32b) corresponds to each of the fenestration panels between the second main track element and the third main track element. In this embodiment—which brings about even greater variability than what is provided by the fulfilment of the condition related to the connector track elements between the first and second main track elements —, therefore, also the interconnection between the second and third main track elements is provided separately for each panel.

Variability is therefore greatly increased by applying the three main track elements which also improves the interchangeability of the panels. For example, if one of the panels is solid and the other is transparent, the interchanging of the solid panel for the transparent one is achievable. With more than two panels, the inclusion of three main track elements increases variability to an even greater extent, as any given panel can be interchanged (swapped) for any other without restriction.

Furthermore, in the embodiment according to FIGS. 1-3, connection locations
of first track element-connecting pairs of the connector track elements between the first main track element and the second main track element, and
of second track element-connecting pairs of the connector track elements between the second main track element and the third main track element to the second main track element

to the second main track element are shifted with respect to each other along a longitudinal direction of the second main track element (see the relative shift between the track element-connecting pairs 32a and 32b).

It is expedient to apply some shift such that the panel transferred from the first to the second main track element does not slide further right away between the second and third track elements. If a weightier panel (wing) that has gained speed starts to move, it will not be able to slide onto a further adjacent main track element due to its inertia.

If some shift is included, the panel can be comfortably transferred from the first to the second main track element, the second main track element slightly removes inertia in that direction, and at further movement it can be decided to pass the panel onto the third main track element or to push it along the second main track element.

As mentioned above, in FIG. 3 a block 24 corresponding to the parking tracks is shown that will be described below. As shown in FIG. 3, in the block 24 of the track element there is arranged (as a continuation of the main track elements 10a-10c) a first, a second, and a third parking track portion 34a-34c (these may be formed integrally with the main track elements 10a-10c rather than as an extension thereof, in which case individual segments of the track element called differently).

As it was targeted above, in the present embodiment the parking track portion 34a will not be in use because it is not possible to slide a panel thereon due to the closing lateral element 14. This also means that the panels 12a-12d can be introduced into the block 24 corresponding to the parking tracks from the second and third main track elements 10b, 10c. Arriving on one of these (they can be moved on to the third track element 10c earlier), the panels 12a-12d can therefore enter the block 24. If they arrive on the second main track element 10b, then they can switch from one track element to another also inside the block 24. The panels 12a-12d can be transferred (which gets there) between the second and the third main track elements 10b-10c via a first and second connector track element 36a′ and 36a″, followed by passing them onto a first auxiliary parking track portion 34d, and from there onto a second auxiliary parking track portion 34e via track element-connecting pairs constituted by a third and fourth connector track element 36b′, 36b″ and a fifth and sixth connector track element 36c′, 36c″, respectively (a track element-connecting pair 36c constituted by a fifth and sixth connector track element 36c′, 36c″ is indicated in FIG. 3).

Accordingly, the embodiment illustrated in FIG. 3 is an embodiment wherein each of the track constructions comprises, adapted to be arranged along the first closing lateral element and/or the second closing lateral element (according to the and/or option a parking track block can be arranged along any or both closing lateral elements):
a second parking track portion and a third parking track portion being connected, respectively, to the second main track element and to the third main track element, as a continuation thereof (according to the above, the embodiment configured this way does not necessarily comprise the first parking track portion; the parking track portions could also be called parking track elements), and
one or more auxiliary parking track portion, adapted for arranging beside the third parking track portion (obviously, opposite the second parking track portion), in such a number that a summed number of the second parking track portion, the third parking track portion and the one or more auxiliary parking track portion is equal to or greater than the number of the fenestration panels (in the illustrated embodiment, the number of these equals the number of the panels, i.e. it is four with the two included auxiliary parking track portions, however, more than two auxiliary parking track portions can also be formed), and each auxiliary parking track portion is connected to the third parking track portion or to an adjacent auxiliary parking track portion situated closer to it than the third parking track portion by a track element-connecting pair of connector track elements (the sequentially arranged auxiliary parking track portions can be connected according to these options depending on their place in the sequence; as it was illustrated, a further track element-connecting pair can also be inserted between the second parking track portion and the third parking track portion).

In FIGS. 4-6, the embodiment according to FIGS. 1-3 is illustrated in an open state. A particular exemplary arrangement of the panels 12a-12d can be summarized based on FIG. 6. In relation to FIG. 6 it is specified where each of the panels 12a-12d is located, however, for easier interpretation of the invention it is important to note that in the illustrated case the panels 12a-12d are not differentiated from each other, so the actual location of the particular panels may be different from what is indicated in the drawing as the panels 12a-12d are arbitrarily interchangeable.

Accordingly, in the schematic front view of FIG. 4 the following panels are shown, from left to right: 12b, 12c, 12d, while in FIG. 5 a sectional view taken across the panel 12d is shown (i.e. not a cut-away view because on the left the panel 12d is shown, so in a cut-away view the panel 12c should also be shown). In the state shown in FIG. 5, the panel 12d has therefore already been transferred to the third main track elements 10c, 21c considering the lower and upper track constructions 5, 7 (cf. FIG. 2, where the occupied main track elements 10c, 21c of FIG. 5 are marked). The manner of transferring can also be understood based on FIG. 6.

In relation to FIG. 6, the movement options of each of the panels 12a-12d is described. Let us consider first the panel 12a. In the base position, this panel is situated directly beside the closing lateral element 14 (cf. FIG. 3). From this position, via the track element-connecting pair constituted by the connector track elements 26a′, 26a″ it can be transferred—in the lower track construction 5 and in the corresponding portion of the upper track construction 7—from the first main track element 10a onto the second main track element 10b, and then it can be shifted to the position shown in FIG. 6, onto the second parking track portion 34b. This is the simplest way of transferring the panel 12a to the position shown in FIG. 6.

To reach the position it assumes on the third parking track portion 34c, the panel 12b has to follow a more complex route. Initially—in the base position, cf. FIG. 3—the panel 12b is the second one from the closing lateral element 14. In the base position, therefore, it is situated in the first main track element 10a in the track construction 5, from where it has to be transferred to the position shown in FIG. 6. There are several ways to achieve this; two main options are presented below:

1.

In case the panel 12a has been moved earlier to the position shown in FIG. 6, then expediently the following transfer option can be applied (it is also required that the panel 12c has not yet been moved to its position shown in FIG. 6 which from this aspect is a “blocking position”). In such a case, starting from the base position, it can be transferred from the first main track element 10a to the second track element 10b in two ways: by first sliding it there via the connector track elements 26a′ and 26a″ on the first track element 10a (since, according to our initial assumption, the panel 12a is not there anymore), or—in a more straightforward manner—via the connector track elements 28a′ and 28a″ (the other pairs of connector track elements (the connector track elements 30a′, 30a″ or the connector track elements 32a′, 32a″) situated between the main track elements 10a and 10b could also be utilized, but that would involve unnecessary panel movements in a direction opposite the target position).

Because according to our initial assumption the second parking track portion 34b is already blocked by the panel 12a, it is necessary to transfer the panel 12b onto the third main track element 10c. There are two expedient options for that—i.e. without unnecessary movement to the right, also depending on which connector track elements have been chosen between the main track elements 10a-10b-either applying the pair constituted by the connector track elements 26b′ and 26b″, or the pair constituted by the connector track elements 28b′ and 28b″.

When the panel 12b is already on the third main track element 10c, all that is required for it to assume the position on the third parking track portion 34c (shown in FIG. 6) is that it has to be pushed along the third main track element 10c onto the third parking track portion 34c.

2.

If we assume that the panel 12b is displaced from its base position than the panel 12a, then the following mode of transfer can also be applied (transfer modes can be combined arbitrarily corresponding to the configuration of the track constructions, provided that blocking of other panels is resolved, for example by pushing them away). For this mode of moving the panels it is also assumed that the panel 12c is not in the blocking position illustrated in FIG. 6.

Then, the movement can be performed such that the base position of the panels 12a-12d is broken by displacing the panel 12b, transferring the panel 12b from the first main track element 10a onto the second main track element 10b. After that, the panel 12b can be slid along the second main track element 10b onto the second parking track portion 34b, and then it can be transferred via the connector track elements 36a′ and 36a″ onto the third parking track portion 34c. Thereafter, the panel 12a can also be transferred onto the second parking track portion 34b relatively simply (expediently via the connector track elements 26a′ and 26a″, and the second main track element 10b).

The two modes of movement of above were described in order to demonstrate the variability provided by the track construction 5 (and the appropriately arranged track construction 7).

In the following the possible movements of the panels 12c and 12d is also described in detail, also specifying how the panels 12a-12d move corresponding to the arrangement of the guiding elements in the configuration of this embodiment. These findings are therefore also valid for the movement of the panels 12a-12b, but for the sake of transparency in their case only the “big movements” were described. In FIG. 6 first and second guiding elements 38a, 38b of the panel 12c, and first and second guiding elements 40a, 40b of the panel 12d can be observed.

First, the manner of moving the panel 12c is described. As shown in FIG. 6, the panel 12c is positioned such that the first guiding element 38a thereof is arranged in the third main track element 10c, while the second guiding element 38b is arranged in the second main track element 10b. As illustrated also in FIG. 6, in the present embodiment the panels 12a-12d are not transferred between the main track elements 10a-10c such that the longitudinal direction of the panels (as shown in the figure) is parallel to the main track elements 10a-10c (it is shown in FIGS. 1 and 4 that the panels 12a-12d have an even longer dimension in the vertical direction, but in the top views of FIGS. 3 and 6 the longitudinal direction thereof should be interpreted as the direction of their side visible in the figures). Moreover, it is not possible to move the panels 12a-12d between the main track elements 10a-10c with their longitudinal direction being parallel thereto. This is due to the relationship of the distance between the guiding elements and the distance between the connector track elements in the track element-connecting pairs,

Because in the present embodiment a distance between the connector track elements in the track element-connecting pairs is smaller than a distance between the guiding elements corresponding to the same panel (i.e. to a given side thereof, as shown in FIGS. 3 and 6). This can also be inferred from the position of the panel 12c in FIG. 6, because in FIG. 6 the first guiding element 38a of the panel 12c is situated precisely at the connector track element 28a′—on the third main track element 10c—, while its second guiding element 38b is situated precisely at the connector track element 28a″—on the second main track element 10b—(cf. FIG. 11A where it is shown for the panel 12d that the portion of the guiding element 40a responsible for guiding—i.e. in this case, the guiding roller, see below for details, in this figure the connecting shaft connected to the guiding roller is shown from this, with the location of the centre of it corresponding to the point of contact between the roller ball and the ground—is situated further inward with respect to the end portion of the panel 12d being on the left in the figure than the corresponding portion of the guiding element 40b).

The position of the panel 12c shown in FIG. 6 is a characteristic position because this position illustrates well how a panel is transferred between the main track elements. That will therefore be described below referring to the panel 12c, but the description can also be applied for other panels transferred on other connector track elements.

The situation shown in FIG. 6 may therefore conceivable when the first guiding element 38a of the panel 12c has just passed along the connector track element 28b′. The state just before passing can be imagined (for now disregarding, for the sake of simplicity, the effect of “carry-over” from the main track element 10a, i.e. the turning of the second guiding element 38b onto the connector track element 28a″) as follows: the guiding element 38a is situated on the second main track element 10b at the other end of the connector track element 28a′ facing the second main track element 10b, and the second guiding element 38b—at a fixed distance from the first guiding element 38a determined by the panel 12c—is also situated on the second main track element 10b. According to the figure, in such a state, due to the relative dimensions the second guiding element 38b is situated on the second main track element 10b slightly to the right with respect to the crossing of the connector track element 28b″ and the second main track element 10b.

From this state, the first guiding element 38a can therefore be passed onto the connector track element 28b′, and according to this passing it pulls the second guiding element 38b to the left of the figure. The second guiding element 38b is then pulled on until it reaches the connector track element 28b″. As soon as it has reached it (this is illustrated in FIG. 6), it is turned onto the connector track element 28b″ in accordance with the intention of transferring the panel 12c onto the third main track element 10c. The exact position of the guiding element 38a at this point depends on the relative distance of the guiding elements 38a and 38b. It is only due to the particular dimensions that in FIG. 6 the first guiding element 38a has just been transferred onto the third main track element 10c at this point; with other dimensions such a situation may occur wherein at this point it is still located in the connector track element 28b′, or it has already passed the crossing of the connector track element 28b′ and the third main track element 10c.

Transferring the panel 12c onto the third main track element 10c is continued from the state shown in FIG. 6 by passing the second guiding element 38b along the connector track element 28b″, while the first guiding element 38a continues to progress along the third main track element 10c to the left in the figure. When also the second guiding element 38b passes through the connector track element 28b″, then the panel 12c is finally transferred onto the third main track element 10c, and thus the transferring process is finished.

Breaking of the base position corresponding to the closed state, i.e. opening up the unity formed by the fenestration panels 12a-12d can also be understood based on the above-described process (for more details on this see the description of FIG. 16B below), as the two processes are similar. As it is apparent from a comparison with FIG. 1 or FIG. 11A, the panels 12a-12d are situated on the first main track element 10a also in such a way that a connector track element is located right at their first (in the figure, left) guiding element, while their other guiding element (on the right in the figure) is shifted with respect to the corresponding connector track element.

The shape of the panels 12a-12d is generally parallelogram-like (see also below), i.e. in top view their sides facing the adjacent panels or closing lateral elements are inclined (oblique, having an inclined angle), so the locations where the adjacent panels meet or where a panel and a closing lateral element meet are such locations where two (generally, because seals have complex shapes) inclined sides meet. The openability of the panels is determined by the direction of the inclination. As shown in FIG. 6, the inclination tilts to the right in top view, so a panel can be displaced (“opened”) from its position by moving it along that connector track element (from the connector elements corresponding to the given panel) that is situated on the left. This is why the guiding element situated at this portion of the panel is arranged at a connector track element in the base position.

By pulling the given guiding element along that connector track element it will pull with itself the other guiding element, and after a relatively small amount of pulling, this other guiding element will also reach the connector track element corresponding to that. The required amount of pulling is determined by the location of this connector track element. Only such an amount of displacement is required due to opening (lifting out) of the other side of the panel that allows for the friction-free release of the overlapping seal (improved by a rubber sealing) from between the pulled-away side of the panel and the adjacent panel or closing lateral element.

The positioning of the panel 12d as illustrated in FIG. 6 can be understood on the basis of the foregoing. The panel 12d was expediently moved between the first and second main track elements 10a, 10b via the connector track elements 32a′, 32a″, and between the second and third main track elements 10b, 10c via the connector track elements 32b′, 32b″.

However, contemplating the above description it could also be argued that FIG. 6 does not show the state right after transferring the panel onto the third main track element 10c, because the first guiding element 40a is situated at the connector track element 32b′ rather than the second guiding element 40b at the connector track element 32b″ (as would be the case if the panel 12d had just been pulled over). The panel 12d has therefore assumed the state shown in FIG. 6 by being transferred from the second main track element 10b onto the third main track element 10c, and then moved slightly to the right of the figure, such that the first guiding element 38a is located at a connector track element, namely the connector track element 32b′.

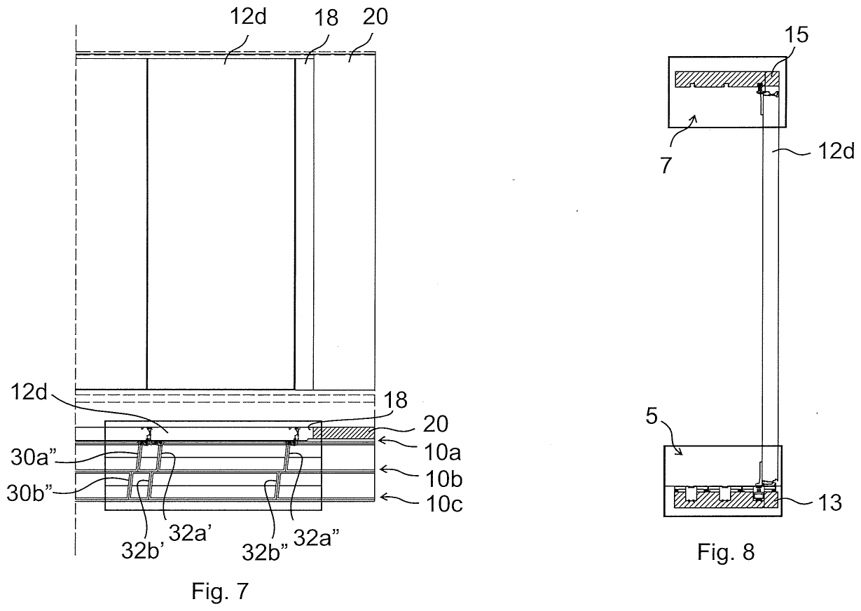

In FIG. 7 a detail of FIGS. 1 and 3 is shown wherein the corresponding parts are aligned below one another, with additional details—that will be described in relation FIG. 11B showing a magnified view of the enframed part of the figure—being also visible between the main track elements 10a-10c.

In FIG. 7 there is shown how the position of the panel 12d and the closing lateral element 20 can be identified in top and front views, based on which the relationship of the panels 12a-12d illustrated in FIGS. 1 and 3 in different views can be understood even better.

FIG. 8 shows a sectional view that is very similar to FIG. 2, with the enframed regions at the bottom and the top of the figure being shown in magnified views in FIG. 9A and FIG. 10A, respectively.

In FIG. 9A therefore there is shown the bottom enframed portion of the section according to FIG. 8, i.e. FIG. 9A somehow “unfold” the above illustrated embodiment, showing the possible implementation details of the lower track construction 5, in an example, illustrating the parts called a “raster-net rail system”.

In accordance with FIG. 8 (and with the analogous FIG. 2), in FIG. 9A a side view section of the present embodiment is shown, illustrating a possible realization of the lower first, second, and third main track elements 10a, 10b, 10c. FIG. 9A shows a section that crosses only the main track elements 10a-10c but does not cross any connector track elements. Accordingly, it only shows that the first, second, and third main track elements 10a, 10b, 10c are implemented applying first, second, and main rail pairs 58a, 58b, 58c, respectively.

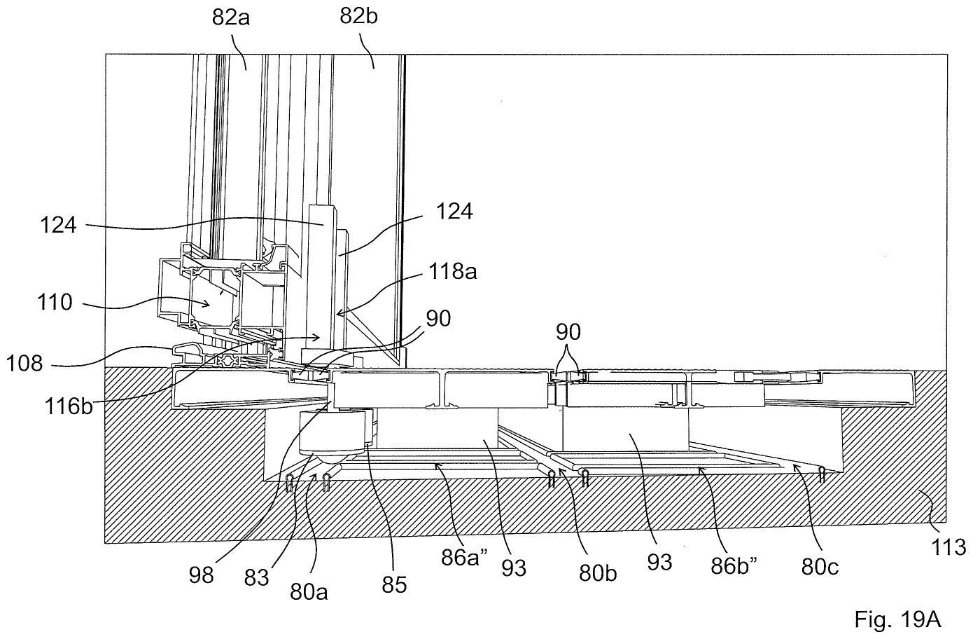

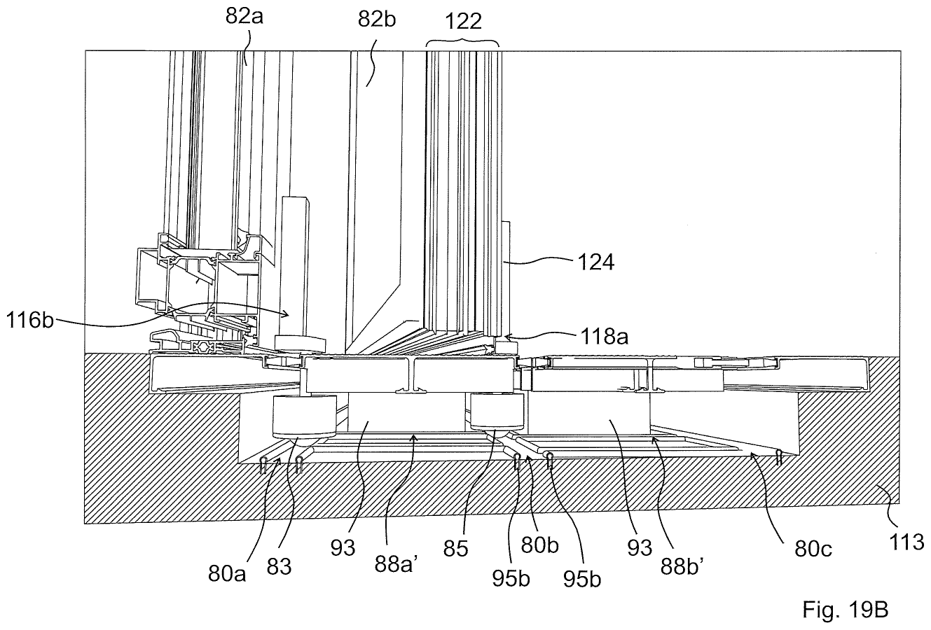

However, from FIGS. 3 and 6 described above, and also from FIGS. 18A-19B to be described below it can be understood that in case the main track elements 10a-10c are implemented applying main rail pairs 58a-58c, then expediently the connector track elements (and expediently the block corresponding to parking tracks) are also implemented applying rail pairs (cf. FIGS. 18A-19B showing connector track elements implemented applying rail pairs, however, based on these figures the manner of implementing the block corresponding to parking tracks utilizing rail pairs can also be easily conceived).

The solution with bearing rollers (see the roller illustrated in FIG. 9C that can also be called a bearing roller with balls as the large ball is encompassed by smaller bearing balls) run along the edges of two rails, i.e. along a rail pair (made for example of aluminium) in order to provide large load bearing capacity, and to ensure that the panels can be moved comfortably with long service life. Besides that, the application of a rail pair offers advantages like the ability to self-clean and having a side-by-side arrangement (one side is the edge of a first track while the other is the edge of a second track). Under “self-cleaning ability” it is meant that in addition to minimizing debris getting smeared (due to gravity, debris will fall down between the double rails and will not get smeared on the rails), collecting particulate debris and liquids that get into the arrangement from above in a linear fashion, i.e. between the rails (without causing operating obstruction) is also provided. The operation of the arrangement will thus not be hindered by such debris because there is simply a place where dirt can accumulate without causing obstruction.

In FIG. 9A there is also shown a guiding element 65, i.e. a section crossing the guiding element 65 is shown. Accordingly, the configuration details of the guiding element 65 can also be observed.

The guiding element 65 is affixed to the panel 12d (for example, a movable glass panel) with the help of an elongated first console 64. The guiding element 65 is a lower guiding element, as it is apparent from the illustration of the panel 12d. Expediently, all lower guiding elements (for the other panels 12a-12c) can be configured like the guiding element 65 (cf. FIG. 11A wherein guiding elements having console 64 are also depicted, however, they are identified by reference numerals 38b, 40a and 40b for differentiation, while in FIG. 6 there is also shown the guiding element 38a; all of the illustrated lower guiding elements can have the same configuration as the guiding element 65).

The console 64 has an L-shaped section, with the shorter side of the L pointing outward. A connecting shaft 29 adapted for connecting a first guiding roller 60 to the console 64 (and via the console 64, to the panel) is connected from outside to the shorter side. The first guiding roller 60 has a roller housing (casing) 61 retained in a retaining element 51 secured by means of double (double strained) nuts (female screws) to the end of the connecting shaft 29, with a roller ball 62 being arranged in the roller housing 61.

In FIG. 9A, therefore, the following components are shown from top to bottom: a ball roller (roller with ball), a(n aluminium) socket (cup) with a lathe-machined nut at the top, a threaded screw rod (as a connecting shaft 29) and first counter nut, an upper counter nut (slightly obstructed by the brush sealing), a console 64 with internal thread for retaining the screw rod (crossing the horizontal portion of the L-shaped part), the threaded screw having at its top end a configuration for receiving an Allen key.

These components are assembled as follows: the ball roller is introduced (together with its housing) into the machined aluminium socket from the bottom. The threaded screw rod is then screwed into the top portion of the socket and is secured applying the first counter nut. The upper counter nut is screwed on the upper part of the threaded screw rod, and this is then screwed into the threaded body of the console 64, followed by counter-screwing thereon the upper counter nut.

Height adjustment is performed as follows: after loosening the upper counter nut, the console 64 (and the panel 12d) can be lifted from above by an Allen key by clockwise rotation, or, applying counter-clockwise rotation, descended; when the desired height is achieved it is fixed by tightening the upper counter nut.

The first guiding roller 60 is therefore preferably a ball roller, of which a preferred internal configuration is shown in FIG. 9C. The retaining element 51 can preferably be implemented as a custom-configured (see in the figure) cylindrical aluminium socket for receiving the ball roller (see the figure for the manner of retaining; the cylindrical or cylinder-like configuration is meant to refer to the extension of the connecting shaft 29).

In a configuration example, the rail pair is implemented as a stainless rail pair (see the rail pairs e.g. in FIG. 18A). The ball roller is preferably a high-capacity type that can be run along the rail pair as shown in FIG. 9A. This roller can preferably be of the type applied in packaging technology for linear and point guiding for supporting the objects to be conveyed; the rollers are configured such that they can function adequately also if turned upside down (see a preferred internal configuration of the ball roller below in relation to FIG. 9C). In accordance also with FIG. 9A, the connecting shaft 29 can preferably be implemented as a custom-configured (see the figure) steel threaded rod, with counter-screwed double hexagonal nuts adapted for adjusting (increasing or decreasing) the height level of the panel (wing). In the example, the console 64 can be an aluminium console affixed to the fenestration panel (fenestration sash).

According to the above, in this embodiment preferably
the main track elements and the connector track elements of the first track construction adapted to be arranged in the lower structure portion are formed by means of an interconnected rail system (in the embodiment illustrated in FIG. 9A, a rail system 50, see also a rail system 100 illustrated in FIG. 18A; the rail system does not necessarily have to have a recessed configuration) of main rail pairs (such as the main rail pairs 58a-58c above) and connector rail pairs (as shown in FIG. 18A), respectively, and
first guiding elements (see e.g. the guiding elements 65) of the fenestration panels corresponding to the first track construction adapted for arranging in the lower structure portion each have (first guiding elements each have) a first guiding roller adapted for guiding on the rail system.

In this embodiment, preferably furthermore, the first guiding roller has a roller housing and a roller ball arranged therein and adapted for guiding on the rail system.

In the case of the invention, in some cases the ironing rotation point (pivot point; i.e. the guiding roller, ball roller) has to function in 2 dimensions while it is connected to a fenestration system with an ironing operation system and profile configuration designed for being operated in 1 dimension. The ironing is expediently implemented applying 2-dimensional ball rollers of the type utilized in conveyors (i.e. having high load bearing capacity; see FIG. 9C) in an “upside down” orientation, the ball rollers being placed on a conventional, outside-affixed rotation ironing, i.e. preferably a “hybrid ironing” is created. In this case, the location of the shaft of the ball roller (this is the connecting shaft referred to above) relative to the panel is also of importance (cf. FIG. 2, that fits to the contact point of the ball).

If the rotation points are set at different locations than what is shown, then the track path may change, as well as the edges of the panels move along a different path with respect to the current case. This may be necessary in case the material of the frame- or the filler material of the panels requires an alternative support position, or in case the thickness of the panels and/or the distance of the main rails would change significantly, or the path (in plan view) of the rail is a broken line or arcuate. Relocating the rotation point can be performed exclusively based on CAD design, after adjusting the single required parameter all the other parameters are adjusted accordingly, while retaining the layout and fixing principles.

The panels can be moved manually (which is also aided by particular technical configuration details, for example the inclined configuration of the connector track elements with respect to the main track elements), but motorized moving of the panels can also be conceived. The invention does not include the mode of moving the panels at this level; it is expedient to take into account that the bottom portion of the arrangement may be exposed to precipitation water.

In an embodiment of the invention the guiding element is arranged (retaining the operating principle of the outside-affixed rotation ironing) at the inside plane of the panel. Accordingly, in an embodiment the arrangement according to the invention is installed such that the guiding elements and thereby the track construction (cf. FIG. 3) are arranged on the so-called “inside” of the fenestration elements (for example in the case of dividing indoor and outdoor). The primary advantage of arranging the rotation point to the inner side is its being located on the protected side (hence it is called “inner”), it is however not necessarily aesthetic. It can be expedient to arrange the rotation point inside (at the protected side), but in a concealed manner (cf. FIG. 11A showing that, with the guiding elements being arranged along the inner side, the panels naturally assume their base position corresponding to the closed state such that they are arranged beside the outermost-lying rail; of course in an embodiment of the arrangement the guiding elements have to be arranged in an identical way on all panels, such that the panels can be arranged side-by-side, as well as fitted and sealed against each other, i.e. a closed state can be established).

In the following, further configuration details of the substructure shown in FIG. 9A are described. At the bottom the structure portion 13 is shown with hatching that is divided into two by a vertical line on the right of the first main track element 10a. In an implementation example, the larger portion situated to the left of the line is a load-transfer frame made of fabricated non-insulated (thermal-bridge) extruded extended aluminium that is supported on sound- and thermal-insulating block material being free of water intake (for example, Purenit, a very dense functional construction material; a polyurethane product based on hard foam having high thermal insulation value; if the fenestration arrangement separates indoor and outdoor regions, then preferably this portion is arranged indoors), while the portion situated to the right of the divider line is an insulated (thermal bridge-free) aluminium substructure with high load-bearing capacity and water evacuation that is mechanically fixed to the indoor bulk material (if the fenestration arrangement is applied for separating indoor and outdoor regions, then preferably this portion is arranged outdoors).

In FIG. 9A threshold cover profile elements 56 are shown that are affixed above the structure portion 13 receiving the rail pairs 58a-58c for covering the spatial region receiving the rails. In the portion of the threshold cover profile elements 56 protruding over the rail pairs 58a-58c mutually oppositely arranged brush sealings 66 are applied such that—in addition to an improved aesthetic appearance—debris can be prevented from easily entering to the rail pairs 58a-58c. As shown at the first main track element 10a (shown on the right of the figure), the connecting shaft 29 penetrates between the brush sealings 66, locally bending the brush bristles out of the way (the threaded rod is run between the brush sealings 66). It is also shown here that the console 64 of the guiding element 65 is preferably arranged such that the shorter side thereof extends relatively close to the brush sealings 66, so no wider gaps can be seen from the outside when the guiding element 65 is moving.

The threshold cover profile elements 56 are fitted on a block 59 (see the leftmost threshold cover profile element 56, the configuration is similar for the others as well). It is shown in FIG. 9A that the block 59 consists of two portions arranged at each side of the third main track element 10c (the main track element 10c separates from each other the components surrounding it, so the latter have to be fixed accordingly; there are arranged two half-profiles that are fixed by clips at their returning portions), with the rim of the returning portion of the threshold cover profile element 56 protruding beside narrower one situated at the bottom, by means of which it is secured utilizing the clips 53. In addition to that, the upper portion of the block 59 is surrounded by the returning portion of the threshold cover profile element 56 such that it is supported on the block 59. Preferably, the floor level is defined by the upper edge of the threshold cover profile elements 56.

In FIG. 9A meeting of the bottom portion of the panel 12d and a threshold profile 19 (preferably made of thermal bridge-free aluminium) is shown (against which the panel 12d is sealed, see FIG. 9B). FIG. 9A also shows the outlines of the panel 12d and the threshold profile 19, the inner portions of which being illustrated in FIG. 19B (the internal configuration of these components, i.e. also of the panels is of secondary importance from the aspect of the invention, because the invention basically relates to an arrangement adapted for (i.e. allowing) the moving of the panels, so the configuration and structure of the panel is of secondary importance from the aspect of the invention).

FIG. 9B differs from FIG. 9A in that it also shows the internal structure of the panel 12d and the components connected to it (in a sectional view, i.e. not only the outlines as shown in FIG. 9A), otherwise the same magnified detail is shown as in FIG. 9A. The wing frame can be made of aluminium profile wherein the insertion can be installed utilizing glazing beads and a wedging (technically knocked) rubber liner with thickness chosen for it to fit it against the frame; the insertion can be made of thermally insulating glass, plate or tabular cover sheet material applied for covering walls, almost anything that has a flat shape, can be cut to size and has sufficient thickness. In this case, therefore, the frame is the wing profile, with the insert element (which in this case is thermal-insulating glass) being clamped therein.

In the case of FIG. 9B, the panel 12d is a glazed panel, wherein the glass is retained in (encompassed by) a profile element 54 as is customary in fenestration technology. In FIG. 9B the profile element 54 is shown, which is an aluminium profile element in an example in a sectional view taken across the glass pane. As shown in FIG. 9B in the interior of the panel 12d, the glass is retained by the profile element 54. It is also shown that a tubular sealing element that provides sealing against the threshold profile 19 (namely, the outside waterstop thereof) protrudes from the profile element 54 slightly to the left from the middle thereof. It can also be observed that a tongue (beard) element of the profile element 54 extends downward along the console 64, with a stop seal element protruding from its end, sealing against the end portion of the threshold profile 19 facing the console 64.

In FIG. 9C the internal configuration of a guiding roller 60 implemented as a ball roller (other types of ball roller can also be applied, even if it is made a requirement that the roller should be a ball roller, however, the internal configuration of an exemplary roller is described) is shown.

FIG. 9C shows how the roller ball 62 is arranged in the roller housing 61. In the roller housing 61 there is arranged a socket 67, with bearing balls 63 surrounding the roller ball 62 inside the roller housing 61 being seated therein. The hemispheric-shaped socket 67 (in sectional view it seems to have a semicircular shape) is closed by a ring 69a encompassing the roller ball 62 such that it cannot fall out of the roller housing 61. The ring 69a is retained in place by a covering element 69b that has an outward-turning rim fitting around the roller ball 62.

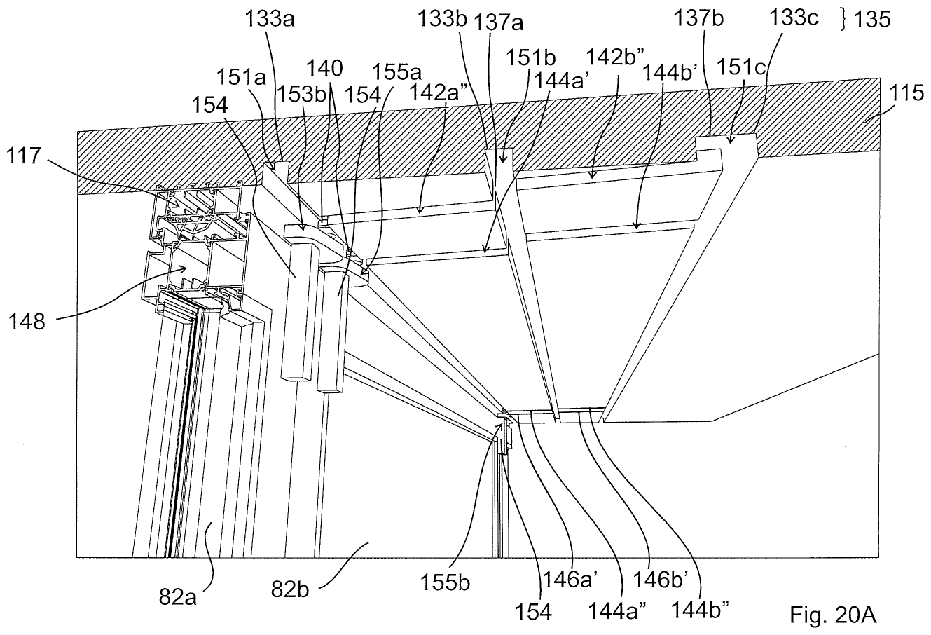

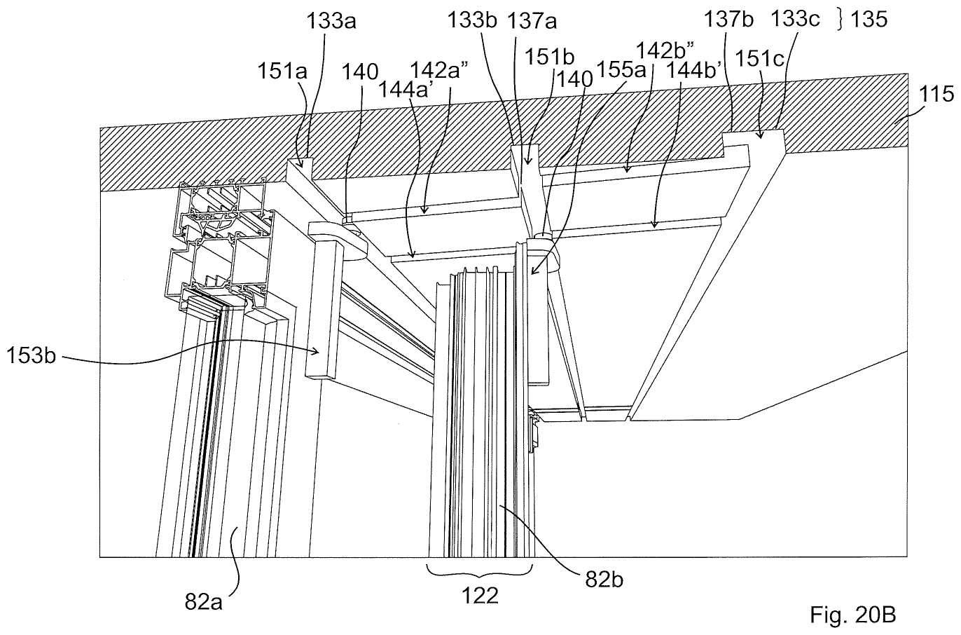

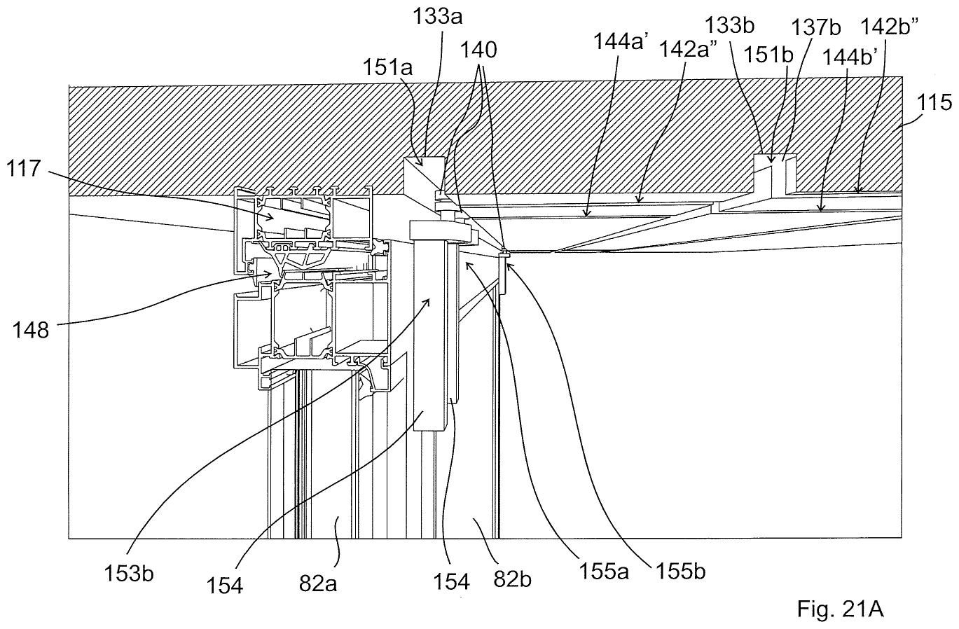

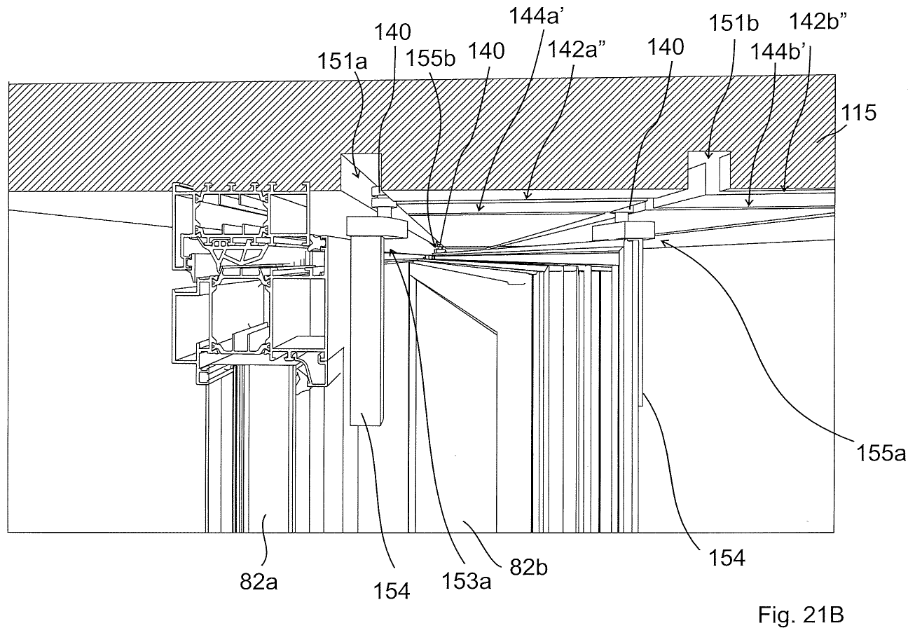

In FIG. 10A, the top enframed portion of FIG. 8 is shown in a magnified view. Accordingly, the second and third main track elements 21b and 21c formed in the upper structure portion 15 are shown in a magnified view in FIG. 10A. In FIG. 10A there can be seen in a magnified view a guiding roller 42 that forms a part of a second guiding element 52 and is implemented as a roller adapted to turn about a vertical axis and runs along the sides of the upper main track elements 21a-21c configured as a U-shaped trough (see below in more detail; in the section shown in the figure the first track element 21a is filled (occupied) by the guiding roller 42 but its outline can also be seen). Preferably not only the main track elements 21a-21c but also the connector track elements are also configured in this manner in the upper structure portion 15 (cf. FIG. 20A-21B).

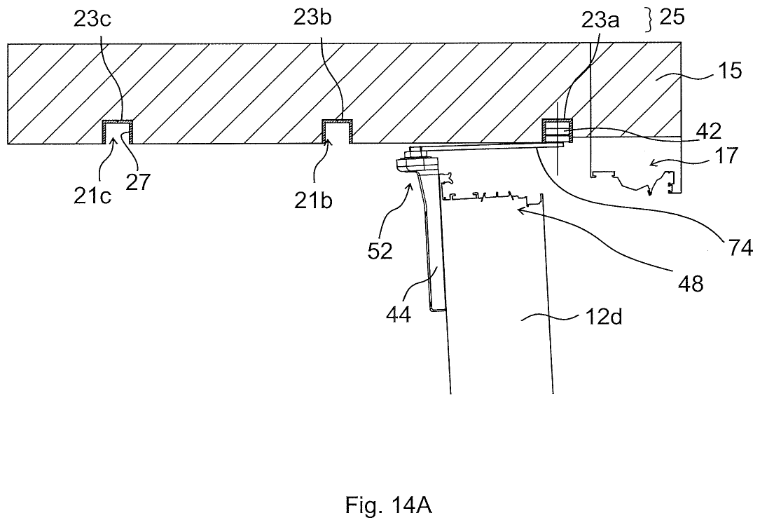

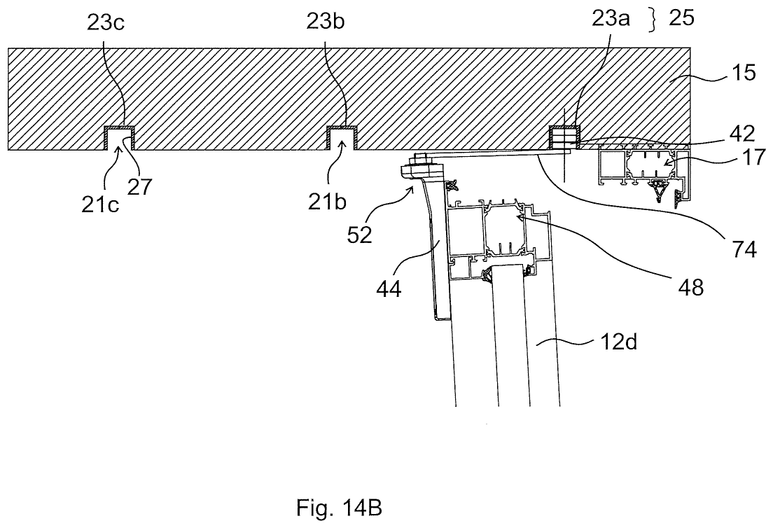

Accordingly, in this embodiment preferably
the main track elements and connector track elements (examples are shown in FIGS. 20A-21B) of the second track construction adapted to be arranged in the upper structure portion are formed by means of an interconnected guiding trough system (a guiding trough system 25 is shown in FIG. 10A, while a guiding trough system 135 is shown in FIGS. 20A-20B) of main guiding trough and connecting guiding troughs (first, second and third main guiding troughs 23a, 23b, 23c are shown in FIG. 10A, while both types of guiding trough can be observed in FIGS. 20A-21B) having guiding side walls (a guiding side wall 27 is shown in FIGS. 10A and 14A in relation to the first main track element 21c; the main track elements 21a-21b also have guiding side walls of the same configuration), respectively, and
the second guiding elements of the fenestration panels corresponding to the second track construction adapted for arranging in the upper structure portion each have a second guiding roller adapted for guiding on guiding side walls of a guiding trough system (according to the above, such an element is the guiding element 52 that has a guiding roller 42).

The bottom boundary line of the upper structure portion 15 shown in FIG. 10A preferably defines the level of the ceiling. The second guiding element 52 has a second console 44 adapted to affix thereof to the panel 12d, which is made of aluminium like the console 64 in an example. As it will be detailed below in relation to FIG. 14A, the guiding roller 42 is connected to the console 44 by an ironing scissors element 74 that is shown in closed state in FIG. 10A. It can also be comprehended from this figure that in case an ironing scissors element 74 is not arranged between the console 44 and the guiding roller 42, the upper guiding element also has to be configured in a similar way, by connecting the guiding roller directly to the console (for example by arranging the guiding roller around a shaft projecting from the console; the above requirements related to the second guiding roller therefore also apply to the configuration wherein an ironing scissors element is not applied).

As shown in FIG. 10A, the upper structure portion 15 is divided into two parts by a vertical line on the right of the figure. In an example, an aluminium superstructure having aluminium profiles is arranged in both parts, with thermal bridge-free profiles to the right of the divider line, and thermal bridge profiles to the left thereof.

The main guiding troughs 23a-23c shown in FIG. 10A are preferably formed by U-profile channels (preferably from aluminium); connecting guiding troughs may also be implemented in such a manner, also in accordance to their crossings with the main guiding troughs. In accordance with FIG. 10A, in an example the second guiding roller 42 is a double roller (including a double roller improves stability).

In FIG. 10A there is shown a frame profile 17 connected to the lower edge of the upper structure portion 15, in an example said profile has a thermal bridge-free configuration made of aluminium. In FIG. 10A, at the top of the panel 12d there is shown an outermost-lying portion formed with a profile element 48 that provides sealing against the frame profile 17 utilizing linear and movable rubber seal (for details of the sealing see also FIG. 10B).

In a manner analogous to FIG. 9B, FIG. 10B differs from FIG. 10A in that it also shows the internal structure of the panel 12d and the components connected to it (in a sectional view, i.e. not only the outlines as shown in FIG. 10A), otherwise the same magnified detail is shown as in FIG. 10A.

Accordingly, FIG. 10B the internal structure of the frame profile 17 (which is slightly different due to the differing outline that can be caused by the different fittings and seals; there is some extent of freedom in the configuration of these) is shown with a downward-extending “tongue” portion shown on the right, against which (or more precisely, against the seal protruding therefrom) the panel 12d is closed. In the closed state, sealing is also provided by another seal against the internal chamber of the frame profile 17 on the panel 12d, and the side of the shape of the frame profile 17 facing the panel 12d shows that in another way and in a different number, the seals could be arranged.

Like in FIG. 9B, in FIG. 10B there is shown that a tongue portion of the second profile element 48 extends up along the console 44, and a sealing thereon seals against the frame profile 17. As with the first profile element 54, the manner of retaining the glass panel in the profile element 48 can be seen (both profile elements form a part of the panel case, so they could also be called profile element portions).

Referring to FIGS. 9A-10B it is noted that it can be understood that the configuration of both the threshold profile 19 and the frame profile 17 allows that the panel 12d can be opened from these profile elements (cf. the description above related to breaking the closed state), and it can also be understood (as it is shown in FIGS. 14A-14B, above) that these profile elements also allow that the panel 12d (and also the other panels having the same configuration) can be tilted.

In FIG. 11A, the enframed portion of FIG. 7 is shown in a magnified view, based on which several details of the above described operation can be clearly understood. In the magnified detail view shown in FIG. 11A the edge of the panel 12c, the panel 12d, the sealing portion 18 and the second closing lateral element 20 are shown. In an example, the corresponding components shown in this figure can be identified as a raster-net rail system and a movable glass panel.

It can easily be seen in FIG. 11A that in the closed state corresponding to the base position the guiding element 40a of the panel 12d is situated precisely at the connector track element 32a′, while the guiding element 38b of the panel 12c and the guiding element 40b of the panel 12d are not.

Accordingly, in the embodiment illustrated above,
in a base position of the fenestration panels corresponding to a closed state the guiding elements of the fenestration panel are arranged in the first main track element (as it was shown above, this condition may be fulfilled on its own, without the condition set forth in the next paragraph), and
a separate track element-connecting pair of connector track elements corresponds to each of the fenestration panels between the first main track element and the second main track element (i.e. the number of the included pairs equals the number of the panels such that each pair can use its own “exit” from the first main track element towards the second main track element; this greatly improves variability), and in the base position of the fenestration panels at least one of the guiding element pairs of guiding elements of the fenestration panels located at opposite guide sides and corresponding to each other according to the (mutually) identical paths of the track constructions is arranged at a connector track element (see guiding element 40a in FIG. 11A that can be found at the connector track element 32a′ in the illustrated base position of the panel 12d).

The guiding element pairs referred to above are those guiding elements that are at an identical (corresponding) position in the lower and upper track constructions. According to the figures it will be shown below that in certain cases it is even more expedient if only one of these pairs is situated at a connector track element (i.e. that pair at which the panel is opened from the base position).

It is also clearly observable in FIG. 11A that in the illustrated embodiment the above cited condition that the distance between respective principal lines of the connector track elements of the track element-connecting pairs is smaller than the distance between the two guiding elements of the fenestration panels corresponding to the respective track constructions is fulfilled.

The track element-connecting pairs among the connector track elements can be determined unambiguously, because those pairs wherein the distance between the pair members is greater than the distance between the two guiding elements corresponding to the same panel cannot be considered, since it would not be possible the pass the panel along such a pair in a manner that each of the two guiding elements thereof advance along each of the two connector track elements, while too close pairs also do not come into consideration because it is apparent that they do not correspond to the same panel.

The distance between the connector track elements of the same track element-connecting pair can of course not be greater than the distance between the guiding elements (more precisely, the components being responsible for guiding, see in detail below) corresponding to a panel. On the one hand, this is meant by that the track element-connecting pairs of the connector track elements are configured being suitable for separated transferring of the two guiding elements of each of the fenestration panels corresponding to the given track construction between the main track elements. Additional aspects for appropriately configured track element-connecting pairs (also related to separated transferring) are described below.

The situation is a bit more complex if the panels do not have identical width. This is because, according to the principle of panel exchangeability and to the possibility of rearranging the panels, if for example a wider panel is to be inserted in the place of a narrower panel, it can be only realized if the corresponding appropriate distance (space) has also been provided. That is why a “matrix” was mentioned, i.e. the distance between the track connector elements is envisioned to be specified in steps (for example steps of 25 cm).

As it would not be possible to transfer a narrower panel on a track element-connecting pair dimensioned for a wider panel, the distance between the connector track elements of the track element-connecting pairs is chosen to match the narrowest applicable panel, because panels wider than that can be transferred on such a pair. This would also allow that in the base state the guiding element situated at the front (from the aspect of opening) can be positioned at the connector track element (providing a fixed order of panels in the base state).

In addition to that, the following can be set forth in relation to the minimum of the distance between the connector track elements of the same track element-connecting pair, naturally beside that if the members of the pair are too close to each other, that is not preferred because then they essentially do not form a distinct connection element, therefore in such a case they do not help the transfer between the main track elements on a short section.

What is important in relation to specifying these is the relationship between the distance of the connector track elements of the same pair and the distance between the guiding elements; these distances are both variable. In the present disclosure, the conditions are given such that the distance between the guiding elements is considered to be fixed, while the distance between the connector elements is regarded as variable, but based on the foregoing a reverse scenario is conceivable possible, or even one wherein both distances are variable.

In certain figures it can be observed (cf. FIG. 6 and see also FIG. 21B) that the distance between the connector track elements of a connecting pair is such that when the leading guiding element of the panel—considering its progress—has just passed the connector track element, i.e. at the moment it reaches the targeted main track element, the trailing guiding element thereof (considering also its progress) then just reaches the connector track element assigned to it in the pair. This defines the “pace” of the transfer, i.e. when one of the guiding elements has just passed the connector track element the other should start immediately.

This is a “point-like” requirement (pertaining to the narrowest panel in case the panels have variable width) regarding the relationship of the distances. Provided that the track construction has a clear layout, the distance at which the guiding elements have to be arranged from each other for a given track element-connecting pair in order that this requirement is fulfilled can be obtained (the scenario that they have a fixed distance have been abandoned here to make this sole assertion). And in case the distance between the guiding elements is fixed, then the location of the connector track elements can be obtained such that the above requirement is fulfilled.

A possibility to make this requirement a “non point-like” one is to set a requirement for the track construction and the arrangement of the guiding elements that the relationship between the distance of the guiding elements and the distance of the connector track elements within a pair relate to each other such that the trailing guiding element (considering the progress) should reach the corresponding connector track element of the track element-connecting pair no later than the moment when the leading guiding element has finished travelling along the connector track element corresponding thereto. If the trailing guiding element reaches this position earlier than that, i.e. it starts to travel therein before the leading completes the crossing, then the two guiding elements of the panel travel at the same time in the connector track elements corresponding to them. If this condition is made a requirement, then the transferring of the panel between the main track elements preferably does not take too long but is completed over a relatively short track section with respect to the main track elements.

If, however, the trailing guiding element gets there only after the leading one has got through, it is preferably because at any given time only one of the guiding elements of a given panel switches between the main track elements, i.e. is situated in the connector track element corresponding thereto.

Configuration limitations can also be formulated as follows: the distance between the connector track elements is smaller than the distance of the guiding elements, and besides that, as a minimum condition it can be specified for the distance of the connector track elements of a track element-connecting pair that the leading guiding element that has already got through should travel a maximum distance along the main track element after arriving thereon that equals the length of the connector track element (or a double or half thereof) until the trailing guiding element reaches the connector track element corresponding thereto. If the panels do not have identical width, then this requirement may pertain to the narrowest panel, in which case wider panels will travel more until the trailing one also reaches the corresponding connector track element (see the above description on variable panel width).

In the embodiment of FIG. 11A, wherein the connector track elements have a straight configuration, the term “principal line” of the connector track elements expediently refers to the centerlines of these straight connector track elements that is also indicated in the drawings in the case of the connector track elements, moreover, in FIG. 11A centerlines of the main track elements 10a-10c are also shown.

Such embodiment, however, can also be conceived wherein the connector track elements do not have a straight shape but, an embodiment is conceivable for example based on the present embodiment wherein the connector track elements are formed such that their shape slightly differs from the linear in a manner that the connector track elements are rounded off at their connection location to the main track elements.

The rounded-off portions may facilitate the introduction of the guiding elements of the panels onto the connector track element, while they have such a small size that they do not affect the manner of the transferring process of the panels between the main track elements (which process was described above for the straight connector track elements). By “small size” it is meant that the rounded-off portions extend along a small portion, for example along maximum 25%, on each side, of the length of the connector track element (“length” here refers to length measured along the principal line, i.e. a distance obtained by interconnecting the two main track elements by the principal line). Track switching is operable irrespective of whether it is implemented in an inclined angle, right angle, in an arc (in a rounded-off manner), or in an “S” curve defined by two arcuate sections. The shape of the track will determine the degree of comfort provided by the arrangement and it is also related to the mode of fitting the panels (sashes) to each other.

In case rounding-off is applied, the principal line of the connector track element will preferably be the straight line that can be obtained as a continuation of the linear portion thereof situated in the middle. Utilizing this straight line, the distance between the connector track elements can be determined (in the case of non-straight/linear track elements taking into account the distance of these lines).

If it holds true that a distance between respective principal lines of the connector track elements of the track element-connecting pairs is smaller than a distance between the two guiding elements of the fenestration panels corresponding to the respective track constructions, furthermore
the lateral sides interconnecting guide sides of the fenestration panels, adapted for being arranged to face adjacent fenestration panels or an adjacent fenestration panel and a closing lateral element are configured as sealing portions adapted for sealing against the portions of the adjacent fenestration panels or an adjacent fenestration panel and a closing lateral element that are to be arranged opposite the lateral sides, (the sealing portions of a panel may face adjacent panels, or, because several panels are included, an adjacent panel and a closing lateral element; in an embodiment this requirement may be fulfilled individually, i.e. not only in combination with the forthcoming ones), and
the sealing portions have an inclined configuration such that the guide sides have a parallelogram-like shape, and in the base position of the fenestration panels corresponding to a closed state thereof, a connector track element of the track element-connecting pair of the given fenestration panel is arranged (in the lower and upper track construction) near those guiding elements corresponding to the respective track constructions (in the case of complex guiding elements, the element thereof responsible for guiding, for example in the case of a guiding element having a guiding roller, the guiding roller, more precisely the roller ball thereof) to which sealing portion with inclined configuration having the inclined configuration starting in a direction opposite the main track elements towards inside of the fenestration panel is situated closer (cf. FIG. 11A, wherein the connector track element is arranged at the guiding element at that location where the inclination starts towards the inside of the panel, that is, where the panel has a corner protruding towards the track construction and this corner has to be opened; this type of arranging facilitates the opening, i.e. the panel is opened in the direction where such an arranging is found).

In the case of a fenestration element (e.g. considering a conventional window wing), the term “inclined configuration” refers to a “non-linear” configuration, but interrupted by steps and seals it extends in a given—inclined—direction such that the element can be fitted against its counterpart extending in the opposite direction. This inclination defines one side of the parallelogram-like shape, so this explanation also makes it easier to understand the concept “parallelogram-like”. The term “parallelogram-like” is taken to mean that the parallelogram (that characterizes the shape) has sides that are not straight lines but (the inclined sides) have various interruptions constituted by steps and seals. The longer sides of the parallelograms are typically straight lines, in line with the panel configuration (cf. the panel shape shown in FIG. 11A).

In order to make a parallelogram-like shape from a normal wing having a trapezoidal cross section a so-called conversion profile (“stulp”) can be applied, which is a column-like component that can be affixed by screws to the side of a wing and complementing the existing cross-section such that it becomes a parallelogram from the trapezoid.

If the conditions set forth above are fulfilled, an adequate sealing between adjacent components can be provided; and it is then possible to “open up” a panel when the guiding element at which the connector track element is situated in the base position is “started off” along the connector track element. Furthermore, in line with the condition specified for the distances, the inclined side that is tilted towards (tilted on) the next inclined side is brought out from behind said next inclined side, and then—when it is pulled away to a sufficient extent (by pulling it from behind the protruding corner of the adjacent inclined side)—it can be “started off” along the connector track element, now not disturbed by the inclined end given by the inclined side.

In relation to that, in FIG. 11A it can be observed that the mutually facing ends of the panels have a first sealing portion 68 and a second sealing portion 70, respectively, which seal against each other. The side of the panel 12d facing the closing lateral element 20 comprises such a sealing portion 68, with a sealing portion 18 having an end configuration similar to the second sealing portion 70 being arranged opposite to it.

Based on FIG. 11A it can be assessed that in this embodiment a principal line of each of the connector track elements is at a non-perpendicular angle with respect to the main track elements connected to the connector track element. This condition can also be fulfilled if the connector track elements are rounded off at their connection location to the main track elements. As it is illustrated also in FIG. 11A, in this embodiment a straight (linear) connector track element lies at an identical angle (or from another aspect, a mutually complementary to 180°) to both main track elements to which it is attached.

In an embodiment, in addition to the condition pertaining to the angle laid down in the previous paragraph it also holds true that (cf. the above description, these conditions are partially fulfilled therein as well, but in an embodiment only the following set as a requirement for the invention in addition to the condition related to the angle)
in the track element-connecting pairs of the connector track elements the distance between the principal lines of the connector track elements is smaller than the distance between the two guiding elements of the fenestration panels corresponding to the respective track constructions,
lateral sides interconnecting guide sides of the fenestration panels, adapted for being arranged to face adjacent fenestration panels or an adjacent fenestration panel and a closing lateral element are configured as sealing portions adapted for sealing against the portions of the adjacent fenestration panels or an adjacent fenestration panel and a closing lateral element that are to be arranged opposite the lateral sides,
the sealing portions have an inclined configuration such that the guide sides have a parallelogram-like shape, and in a base position of the fenestration panels corresponding to a closed state thereof, a connector track element of the track element-connecting pair of the given fenestration panel is arranged near those guiding elements corresponding to the respective track constructions to which the first sealing portion with inclined configuration having the inclined configuration starting in a direction opposite the main track elements towards inside of the fenestration panel is situated closer, and
the angle between the principal line of the connector track elements and the main track elements connected to the connector track element differs from the perpendicular such that the connector track element extends in a direction opposite with respect to the first sealing portion with the inclined configuration.

The condition formulated in the bullet point just before is fulfilled in FIG. 11A (and thus in the above embodiment illustrated in the figures), because the connector track elements start in the opposite direction (between the first and the second and also between the second and third main track elements) with respect to the direction of tilt of the panel, i.e. by opening the panel the panel is pulled along the angled connector track element, and it will also be possible to move the other guiding element thereof. This can also be fulfilled if the connector track element does not start in this direction, because the other end of the panel is pulled away also in the case of 90° lifting out (pulling out), and even if the given guiding element is getting further (as it is being pulled on the connector element) from the location that the other guiding element assumes in the closed state. This is of course also a geometrical issue, because in the case of lifting out at 90° the other end of a short panel will have relatively large displacement, at least in comparison to a long panel that will have much smaller displacement. With a 90° lifting (out) it may also happen that in the case of a long panel the displacement of the other end of the panel will not be sufficient for opening. This is why it may be expedient to require that lifting out is to be performed at an acute angle. This implies that—during the lifting out process—at the side corresponding to the location where the lifting out process is started (this will be the “leading” side or end) the connector track element diverges from the perpendicular inclining in a direction opposite the “trailing” side or end (this also holds true in FIG. 3).

It is also expedient to apply inclined (angled) connector track elements because it allows for releasing the overlap seal between the sealing portions without causing friction. In addition to that, our experience shows that displacing the panels in an inclined angle is also more comfortable in the case of manual operation; it somehow feels softer, “more ergonomic”. Perpendicular displacement is supported by automatic (motorized) operation, but, because manual operation is preferred, angled displacement is primarily applied. Manual operation can also be applied in the case of perpendicular displacement, i.e. in case the main and connector track elements lie at a right angle.

A guided movement of the panel (wing) wherein the wing is not momentarily stopped during track switching but the panel can switch tracks (at both of its support points) while still moving with a reduced speed (in the illustrated embodiments this condition is fulfilled) is called a “constrained-path” movement.

If a track angle of 90° is applied between the main and connector track elements, and a thereby the panels are lifted out from the closed state (and the wing edge seals are released) at a right angle, a so-called “not constrained path” solution is in play.

Furthermore, our experience indicates that this way the panel can also be given some momentum, allowing that it can be opened easily and can be transferred onto the second main track element, and, utilizing the momentum, even from the second main track element onto the third main track element.

In FIG. 11A, guiding elements 38b, 40a and 40b are shown in a top view. A console 64 (that can also be observed in FIG. 9A) can be seen at each of them; according to the arrangement of the console 64 the following can be set forth:

All guiding elements 38b, 40a, 40b have the same orientation, irrespective of whether they are arranged at the right or at the left side of the panel. The guiding elements 38b and 40b arranged at the right side of the panels 12c and 12d, respectively slightly extend over the end of the given panel 12c, 12d.

For the location of the guiding elements 38b, 40a, 40b it is relevant where the connecting shaft 29 (shown in FIG. 9A) branches off from the console (that the upward extending end of the console is at a laterally shifted position with respect to the connecting shaft is not important); this location is indicated by a small circle in the case of the guiding elements 38b, 40a, 40b. This is also important because this location determines how the guiding element should be oriented with respect to the connector track element such that it can cross it. According to the above it can be seen in FIG. 11A that in the case of the guiding element 40a the small circle is situated right in front of the connector track element 32a′ (i.e. it is arranged in front of the entrance thereof; this corresponds to the setup that the centerline of the connector track element 32a′ and the centerline of the first main track element 10a intersect right in the middle of the small circle corresponding to the guiding element 40a), while the guiding elements 38b are slightly shifted along the first main track element 10a with respect to the introducing portions of the connector track elements 30a″ and 32a″, respectively.

In FIG. 11B a detail similar to the one shown in FIG. 11A is depicted; it is, however, not exactly the same part of the arrangement. In this figure, in contrast to FIG. 11A, there can be seen another panel to the right of the panel 12d; FIG. 11B can thus be considered a separate embodiment.

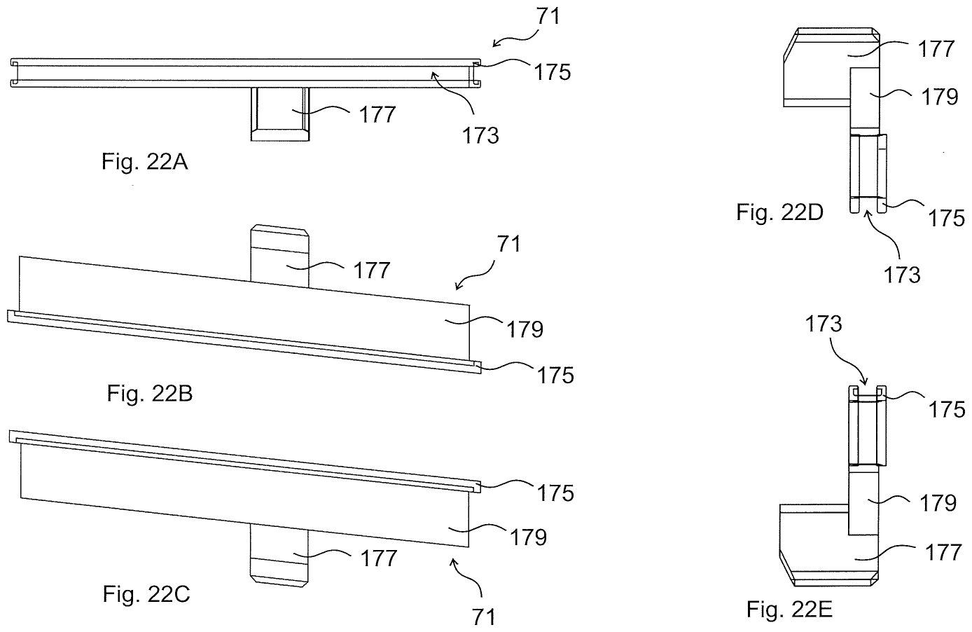

In addition to that, FIG. 11B also shows further details, namely the arrangement of the brush sealings. More precisely, there are shown brush sealings 73 arranged along the main track elements 10a-10c (see marking of this at the main track element 10c, shown only schematically, indicating that the seals are there, i.e. in reality they typically protrude in a different manner) and also brush holder elements 71 of the brush sealings of the connector track elements (for a more detailed depiction of their preferred configuration see FIGS. 22A-22E). The configuration of the brush sealing system on the illustrated detail is shown that extends to the entire track construction 5 to be arranged in the lower structure portion 13.

An appropriately oriented brush holder element 71 is arranged at both sides of each angled connector track element. In an example, the brush holder element 71 is preferably a 3D-printed component that has an inclined layout in top view, and is adapted for closing off ends of threshold elements and for holding brush. The included brush sealings are therefore implemented applying mutually oppositely arranged brushes facing each other, with the shaft of the guiding element (a connecting shaft 29, preferably a threaded rod) running between them.

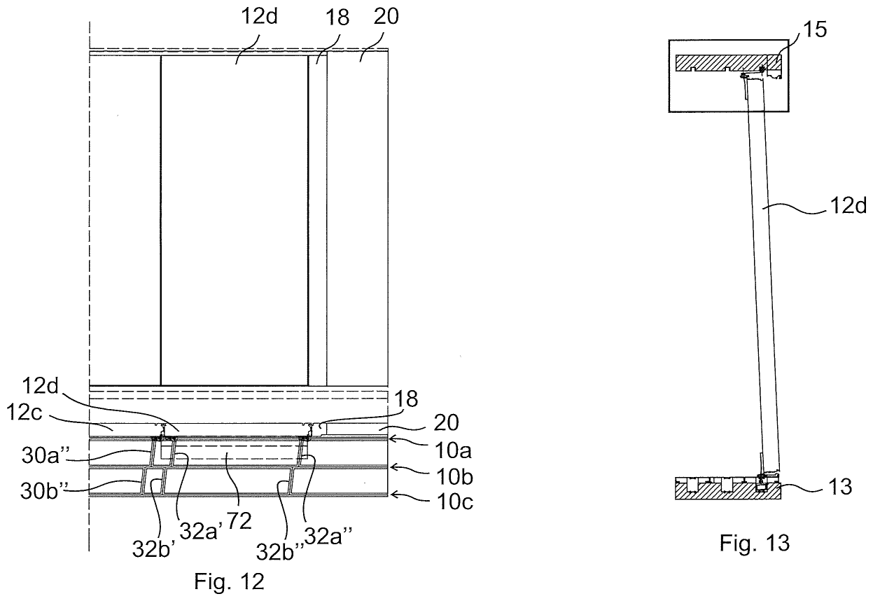

FIG. 12 shows a view similar to FIG. 7, however, in FIG. 12 the panel 12d is in a tilted position. At the bottom of FIG. 12, in the top plan drawing the tilted state is shown only schematically, in dashed lines. The tilted state can be better observed in the sectional view of FIG. 13 wherein the detail shown in magnification in FIG. 14A is boxed.

As shown in the schematic portion of FIG. 12 and in FIG. 13, the panel 12d is in a tilted state, i.e. it has been brought into a tilted position. It can be observed at the top portion of the panel 12d that the tilted state is controlled by means of an ironing scissors element, manner of which is illustrated in the magnified view shown in FIG. 14A of the boxed detail of FIG. 13. In the case of an inward tilt—i.e. of opening the ironing scissors element 74—the guiding element at the bottom can absorb the small angular deviation. Therefore, the roller 60 and the rail pair 58a are in a stable relationship, however, the roller rim is not abutted against the rail pair 58a, i.e. there is no danger of tipping out. There is sufficient room for the controlled inward tilting of the retaining element 51, because the width dimension of the machined, extended extruded thermal-bridge aluminium load-bearing main track elements formed in the structure portion 13 is preferably specified to allow for such a tilt.

In FIG. 14A, therefore a similar detail is shown as in FIG. 10A, with the difference that in FIG. 14A the panel 12d is shown in a tilted state. Accordingly, the panel 12d is tilted (to the left of the figure) from its sealed position assumed together with the frame profile 17. It has also to be noted here that the sealed position assumed together with the frame profile 17 is also terminated when the panel 12d is displaced, however, in that case the panel 12d is displaced by “opening” it (with a similar action like opening a door; by turning it about an axis crossing the lower and upper guiding elements being at one lateral side), while in this case it is tilted inward; the two different movement types can be understood by contemplating how a tilt (tilt and slide) balcony door can be opened.

Ironing scissors elements are also applied for conventional tilt windows and doors; the operation thereof is described below. The ironing scissors element has two arms that are interconnected via a shaft; when the arms are released, these can turn about the shaft with respect to each other.

The arms of the ironing scissors element can be implemented such that one arm has a longer, straight shape with the shaft being disposed along its length, while the other arm (second, openable arm) extends from the shaft. If such an ironing scissors element is applied in the present invention, the longer arm can be arranged on the panel (more precisely, in the illustrated embodiments only on the shorter leg of the L-shaped console 44 that has a corresponding length measured along the panel), while the guiding roller 42 can be arranged at the end of the second arm on a shaft protruding therefrom (cf. FIGS. 20A-21B wherein such a solution is shown, that is it can also be implemented as a double roller). FIG. 14A shows the ironing scissors element 74, in accordance with the open state; the reference points at its second arm.

The ironing scissors element functions as follows in the invention. If the scissors are not open, that is the ironing scissors element is secured in its closed state (cf. a tilting window in the closed state, in such a case only complete closure or complete—non-tilted—opening is possible), then the two arms of the ironing scissors element are brought in alignment, i.e. the guiding roller 42 will be situated above the console 44 (cf. FIG. 10A), and the guiding roller is capable of guiding the panel 12d. When, in turn, the tilted state is activated (for example by bringing the handles arranged on the panel 12d into the appropriate position; cf. also a tilting window), the ironing scissors element opens and the state shown in FIG. 14A is brought about. In this state, therefore, the arm that is not fixed with respect to the panel 12d opens, and thereby the guiding roller 42 situated in the first track element 21a can be displaced from above the console 44 and the panel 12d can be tilted.

In line with FIG. 14A, therefore, in this embodiment in at least one of the fenestration panels the second guiding roller is connected to the fenestration panel by means of an ironing scissors element enabling the tilted opening of the fenestration panel (to enable tilting, of course both guiding elements—comprising guiding rollers—on a given side have to be configured in this way).

In FIG. 14B a state similar to the state shown in FIG. 14A is shown; in this figure there can also be seen the internal structure of the frame profile 17 and the upper profile element 48 of the panel 12d (cf. FIG. 10B), and the manner of releasing the seals in the tilted state can also be observed.

In FIGS. 10A-10B and 14A-14B the ironing scissors element is shown in closed and open state, respectively. In the closed state the two arms of the ironing scissors element are situated above each other, i.e. in this state both arms are arranged over the console. In the open state the arms are opened from each other; in FIGS. 14A-14B one arm of the ironing scissors element is shown accordingly.

In relation to the arms, it is noted that a non-openable (remaining) arm can also be integrated in the console, or alternatively it may lift up the openable arm from the console. By including a washer under the guiding roller 42 it can be provided that the opened arm is distanced to a greater extent from the plane of the upper structure portion.

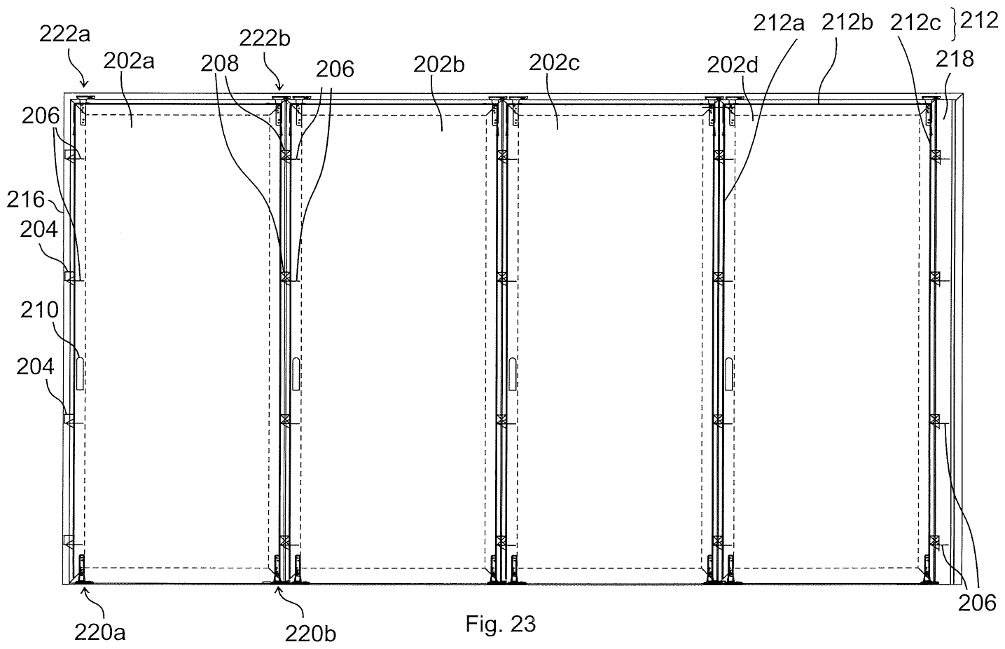

In the case of the illustrated arrangement, between the ironing element arranged in the panel (at the rim thereof) and the ironing scissors element taken to the console a connection is formed that ensures that—at the appropriate position of the handle—the scissors can be released or fixed, that is, by appropriately coupling the scissors and the ironing element the scissors are opened by the ironing element when the latter is turned (cf. FIGS. 23-26E: with a horizontal handle position the scissors are not released, but when the handle is turned upwards they are released).

Such an operating mode and such an implementation of the connection can also be conceived wherein in the closed state the arms of the scissors are perpendicular to the panel, with a projection (being expediently flat) protruding from each arm (the projections being rotatably interconnected at their ends opposite the scissor arms), said projections in their closed state being parallel with the plane of the panel. In addition to that, a cut with a shape ending in an open portion is made in each projection (under each other in the closed state) that receives a connection element of the ironing element (the cut is L-shaped, with the shorter leg of the L ending in the open portion, so the short leg extends to the edge of the projection in a direction opposite the console, the connection element of the ironing element can come free of the cut at this location, and the longer leg of the L is a closed portion wherein the connection element of the ironing element can move without being opened, when the scissors are not yet released).

So, by displacing the ironing element the projections are released and the opening arm of the scissors is started off by tilting the panel (now the scissors are able to open, because the connection element of the ironing element can come freely out of the cut). If the ironing element (i.e. the handle—to ensure that the scissors are opened only when the tilt function is activated) is displaced only to an extent corresponding to opening the panel, the connection element of the ironing element (expediently a cylindrical element) is displaced, but only to an extent that the connection element stays in the closed portion of the cut, so for the moment the scissors remain closed, and the connection element comes free from the cut only in case the ironing element is further displaced and reaches the open portion. Until this happens, the scissors stay closed which implies that the roller connected to the scissors can leave the main track element only in the direction of the connector track element, i.e. the panel can be opened only via (along) the track construction.

Other solutions are also conceivable, for example such that in order to activate the tilt function (for example at a given orientation of the handle) the scissors have to be opened by manual release at the top of the panel.

Based on the top and other figures it can be understood that in case of a parallelogram-shaped cross-sectional configuration, the side of the panel that was not “started off” directly along a connector track element—said side slightly “hiding” behind the corner of the adjacent panel—has to be “pulled out”. From that it also follows that with this configuration the tilt function of the panels cannot be activated in the closed state, because the adjacent panels or the closing lateral element obstruct the tilting of the upper portion of the panels at one side thereof. However, when a panel is brought out from its obstructed position (by pulling the panels sideways at their location, or by bringing them into a “free state” on a main track element), its tilt function becomes available. If the cross-sectional shape of the panels is not parallelogram-like but rectangular, then of course the tilt function can be applied without restrictions, i.e. in such a case the panel is lifted out from the closed state at 90°. It is also possible in the case of the illustrated configuration that only the last panel (the panel 12d) has a tilt function, because therein a trapezoidal panel cross section can be applied instead of a parallelogram-like one, i.e. the configuration is resolvable.

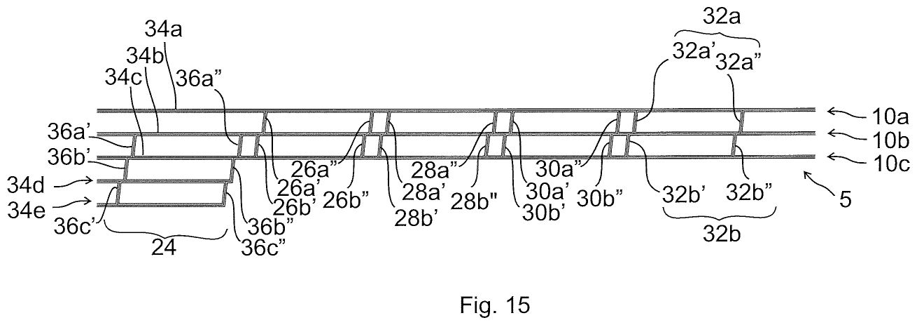

In FIG. 15 a rail system 5 (in an example, a layout of a rail track system) is shown separately from the panels 12a-12d such that the arrangement of the track elements can be even better observed in the figure.

FIG. 16A-16G illustrate the movement of the panels 12a-12d. In the figures some kind of a sequence is illustrated, i.e. the respective positions of the panels shown in each of FIGS. 12a-12d can be interpreted as occurring one after the other. These figures will be described in accordance with that.

In FIG. 16A, a state also illustrated in FIG. 3 is shown, i.e. the panels 12a-12d are in their base position corresponding to the closed state, arranged in a row and sealed against each other and against the closing lateral elements 14, 20. As it is also shown in the figures, the closing lateral elements are built-in, fixed elements (wall portions) that form a lateral boundary of the region covered/closed off by the fenestration panels 12a-12d in the closed state of the panels 12a-12d. Based on this, they can alternatively be termed “lateral panels” or “encasing wall elements”.

Therefore, in FIG. 16B such a state is shown that can be obtained starting from the state illustrated in FIG. 16A, i.e. from the closed state. Namely, FIG. 16B illustrates that the panels 12a and 12c are opened, i.e. their guiding elements being on the left according to the figure are passed along the connector track elements arranged at them (i.e. these guiding elements of them are brought from the first main track element 10a onto the second main track element 10b). In comparison with FIG. 6 it can be established that the other guiding element of the panels 12a, 12c arrives at the connector track element along which it can be passed through just in this time instance. Meanwhile the panels 12b and 12d remain in place.

FIG. 16C shows the state wherein the panels 12a, 12c have been fully transferred from the first main track element 10a onto the second main track element 10b, i.e. also their second guiding element have been passed along the corresponding connector track element. It can be observed that, in comparison with FIG. 16B that in this state the leading portion of the panels 12a, 12c (i.e. the portion at which the guiding element that was transferred first is located) is situated further to the left.

In FIG. 16D, further modifications of the panel 12a-12d positions are shown. In this figure, the position of all the panels 12a-12d have been modified with respect to FIG. 16C. It is noted here also that the panels 12a-12d may also move differently than what is described here, since it may happen that two panels are exchanged, and another one will assume the indicated position (for example, in FIG. 16D, it is not necessarily the panel 12a that will end up in the block of parking tracks).

As it was touched above in FIG. 16D, compared to FIG. 16C, the panel 12a was displaced from its position on the second main track element 10b and was introduced into the block corresponding to parking tracks, more precisely onto the second parking track portion 34b.

Furthermore, the guiding element of the panel 12c shown further left in the figure was transferred from the second main track element 10b onto the third main track element 10c. Preferably, this guiding element will be situated at the corresponding connector track element when the panel 12c is fully transferred onto the second main track element 10b, i.e. when the guiding element thereof situated further right is transferred from the first main track element 10a onto the second main track element 10b.

In addition to that, in FIG. 16D the panels 12b and 12d are displaced relative to the states illustrated in the previous figures, i.e. their guiding elements situated to the left on the figure (arranged at the connector track element) are transferred from the first main track element 10a onto the second main track element 10b. Also, in its current state (shown in FIG. 16D) the panel 12c is not in a blocking position with respect to any of these movements.

FIG. 16E illustrates how the panel movements initiated in the previous figure are finished, i.e. in this figure the panels 12b, 12d are fully transferred from the first main track element 10a onto the second track element 10b.

In FIG. 16F further movements with respect to FIG. 16E are shown. The panel 12c is fully transferred from the second main track element 10b onto the third main track element 10c, while the panels 12b, 12d are displaced relative to their positions shown in FIG. 16E.

FIG. 16G shows a situation wherein already the panels 12a-12d can all be found in different parking track portions of the block 24 corresponding to parking tracks.

Assuming that the panels 12a-12d are arranged in the order shown in FIG. 16G, they can be brought into the illustrated position in the following possible manner: Assuming that the panel 12a (that is already in place as shown in the previous figures) is not moved, first the panel 12d has to be brought into place, followed by the panel 12c, and then by the panel 12b (since due to the blocking caused by the panel 12a only a single entrance to the block 24 remains free, and because the panels cannot change their places once inside the block, i.e. they can only be moved along via the auxiliary parking track portions).

In order that the panel 12d can be brought into place first, it has to be passed beside the panel 12c in some manner, and then—expediently already on the third main track element 10c—also beside the panel 12b. This expediently involves sliding the panel 12d beside the panel 12c along the second main track element 10b, followed by transferring it—passing it before the location of the panel 12b shown in FIG. 16F—onto the third main track element 10b (advancing it, in the section outside the block corresponding to parking tracks 24, via the connector track elements of the second track element-connecting pair). This presumably results in a less comfortable situation, although it is not impossible to slide it beside the panel 12c in the position shown in FIG. 16F, the latter preferably has to be slid slightly to the right in order that the panel 12d can be moved more comfortably. After the panel 12d has been transferred onto the third main track element 10c, it has to be introduced into the block corresponding to parking tracks 24, and therein it has to be brought into the position shown in FIG. 16G, i.e. onto the bottommost auxiliary parking track portion in the figure, via the track element-connecting pairs formed inside the block.

Thereafter, the panel 12c and then the panel 12b can be relatively simply brought in place inside the block 24. The panel 12c is situated on the third main track element 10c already in FIG. 16F; it has to be slid into the block 24 on the third main track element 10c and has to be brought down onto the parking track beside the auxiliary parking track portion occupied by the panel 12d. The panel 12b has to be transferred from the second main track element 10b onto the third main track element 10c; this can be achieved by sliding it to the right of the figure from the position shown in FIG. 16F (expediently only to a small extent, to the first track element-connecting pair). Then, it has to be slid into the block of parking tracks 24.

FIG. 16G illustrates such a situation wherein the closed state of FIG. 16A is opened up in its entirety, i.e. all panels 12a-12d are put aside from the opening that they are collectively responsible for closing off in the base position. In such a manner, the two spaces originally separated by the panels 12a-12d can be joined together.

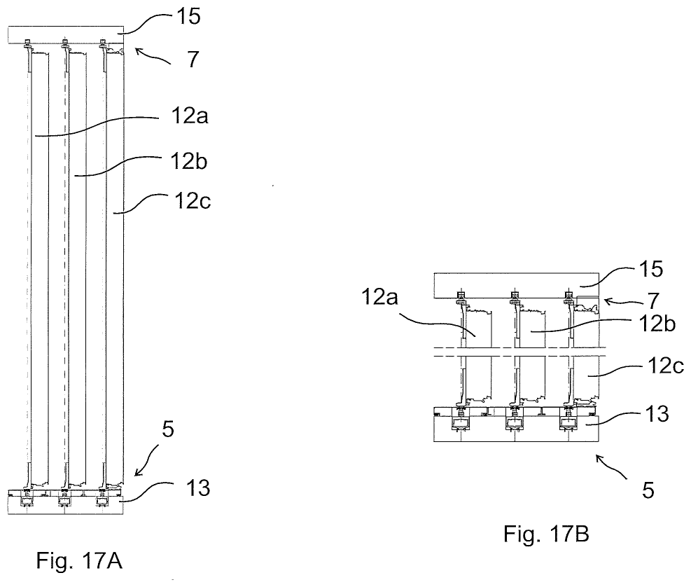

FIG. 17A shows a side sectional view wherein the panels 12a, 12b, 12c are pulled onto track sections situated behind each other. Accordingly, in FIG. 17A it is also illustrated that the panels can be passed beside each other along adjacently extending main track elements of the track constructions.

FIG. 17B illustrates the state of FIG. 17A, showing only the upper and bottom portions of the panels 12a-12c. Thereby, the guiding methods applied at the bottom and at the top can be compared even better.

FIGS. 18A-21B show spatial drawings cut at a given section, which are relatively closely related to the above embodiments. The drawings described below are based on the same principles as involved in the embodiment detailed above, but the spatial depictions and the applied different aspects make it easier to observe certain characteristic features. In FIGS. 18A-21B the panels 82a, 82b are illustrated in closed state and in a slightly opened-up state.

FIG. 18A-19B illustrate configuration details situated at the bottom portion of the panels 82a, 82b, i.e. details of the present embodiment of the arrangement that belong to a lower structure portion 113. In FIGS. 18A-19B some of the blocks supporting the threshold cover profiles have been removed for easier comprehension, i.e. that the track elements, especially the connector track elements can be seen better. FIG. 18A shows a view “under” the threshold cover profiles, and the connector track elements are also shown because the blocks have been removed from the view (just for this purpose). In the following, the system of track elements is explained referring to the figure.

FIG. 18A shows a first, a second and a third main track element 80a, 80b, 80c implemented by rail pairs. For the sake of comprehension, individual rails of the rail pairs are marked separately with the same reference numeral. Accordingly, there are shown the rails of a first, second and third rail pair 95a, 95b, 95c. The rails are however interrupted by the crossings. E.g., of the two rails of the rail pair 95c only one is cut by the section because it crosses a crossing in the case of this rail pair 95c In FIG. 18A, the components are described from the top to the bottom.

In the figure connector track elements 86a″ and 88a′ situated between the first main track element 80a and the second main track element 80b are shown (in the spatial drawings the connector track elements are marked in accordance with the above; the references a′, a″ and b′, b″ are applied also here for identifying the members of track element-connecting pairs; in FIGS. 18A-18B the connector track elements that shown between the main track elements 80a-80c do not form a pair as they are situated close to each other). Also, between the second main track element 80b and the third main track element 80c connector track elements 86b″ and 88b′ are shown that are slightly shifted in the direction of the section plane with respect to the connector track elements 86a″, 88a′.

In FIG. 18A there is indicated a rail pair 97a of the connector track element 86b″ and also a rail pair 97b of the connector track element 88b′. A rail system 100 comprises the rail pairs 95a-95c and 97a-97b; in the view shown in the figure these rail pairs can be seen of the rail pairs constituting the rail system 100.

The illustrated section is perpendicular to the main track elements 80a-80c, so the view clearly shows that the connector track elements lie at a non-perpendicular angle with respect to the main track elements 80a-80c. FIG. 18A shows where the rails of the main track elements and the connector track elements are connected to each other (for example, they are fitted together as being obliquely cut).

In FIG. 18A there are shown guiding rollers 83 and 85. The guiding roller 83 belongs to the panel 82a, namely it is that guiding roller thereof which, in the base position, is not situated at the connector track element. It therefore holds true also for this embodiment that one of the guiding rollers (more generally, guiding elements) of a panel is situated at the connector track element, and this is shown in the figure in case of guiding roller 85 belonging to the panel 82b. If we look at the panels 82a, 82b from the right of the figure, then these figures are identical with the above figures in that the left-side guiding roller of the panels 82a, 82b is situated at the connector track element, and the right-side guiding roller is slightly shifted therefrom.

It can also be observed in FIG. 18A that in the region situated behind the connector track elements 88a′ and 88b′ the blocks 93 are slightly shifted from the rail pairs to give way to the guiding rollers, i.e. to the guiding rollers 83 and 85 shown in FIG. 18A. This can be better observed in the case of the main track elements 80a-80c due to the applied view, but the connector track elements are also arranged in such a way relative to the blocks.

In the view of FIG. 18A brush sealings 90 corresponding to the main track elements 80a-80c are shown, but, as it was mentioned above, brush sealings of the same configuration are also applied at the connector track elements (the corresponding components are illustrated in FIGS. 22A-22E).

The brush sealings 90 are retained in threshold cover profile elements 106 (in specially configured grooves thereof, in the same manner as is shown in FIG. 9A). The edge of the returning portion of the threshold cover profile elements 106 can be secured applying clips like above. FIG. 18A also shows that in the applied view the threshold cover profile elements 106 are cut at the connector track elements. These threshold cover profile elements 106 are however marked uniformly.

In the view shown in FIG. 18A there can be easily observed a guiding element 116b and guiding elements 118a, 118b (the latter in the background of FIG. 18A) affixed, respectively, to the panels 82a and 82b. The first guiding roller 83 is connected to the console 124 of the guiding element 116b with the help of a first connecting shaft 98, and a second guiding roller 85 is connected to the console 124 of the guiding element 118a with the help of a second connecting shaft 102. In this view, only the console 124 and the third connecting shaft 104 are shown at the guiding element 118b.

The guiding elements 116b, 118a, 118b are configured identical to the guiding element 65 (cf. FIG. 9A), but in these figures their shape can be observed also in a spatial view. Like the console 64, the console 124 has an L-like shape (see also in FIG. 9A) when viewed from the direction of the main track element 80a. In FIG. 18A a vertical elongated portion of the console 124 is shown that is fixed to the panel, as well as a portion sideways extending from it (the latter also extending along the panel perpendicular to the elongated portion), and a connecting shaft connected to the guiding roller starts from the vertical elongated portion. As shown in the views above, the console 64 is also configured based on these principles.

In the view shown in FIG. 18A there is also shown the internal structure of the panel 82a that is configured in the same way as the internal structure of the panel 12d in FIG. 9A. Accordingly, in FIG. 18A there is shown a (thermal bridge-free) threshold profile 108 and a profile element 110 of the panel 82a that retains the insertion—in this case, the glazing—of the panel 82a (a seal between the profile element 110 and the threshold profile 108 is also shown). In the spatial view of FIG. 18A it can also be observed how the bottom edge of the panels 82a, 82b extends along the threshold cover profile elements 106.

In contrast to the closed state of the panels 80a, 80b illustrated in FIG. 18A, in FIG. 18B an open state is illustrated; i.e. such an open state wherein the panel 82a stays in place, while the panel 82b is opened by pulling its guiding roller 85 into the second main track element 80b. Meanwhile, the other guiding element of the panel 80b that can be seen in the background remains in place. In the open state shown in FIG. 18B an overlap sealing portion 122 comes into view (analogous sealing portions 68 and 70 are shown in FIGS. 11A and 11B in top view) that shuts (seals) against the sealing portion of the oppositely situated panel 82a in the closed state.

To assume the position illustrated in FIG. 18B, therefore, the guiding roller 85 travels all the way along the connector track element 88a′; as it can be easily observed in the figure, the roller ball of the guiding roller 85 is already in the second main track element 80b. It is also shown at the roller ball of the guiding roller 85 that after travelling all the way along the connector track element 88a′ it cannot directly advance further along the connector track element 88b′ from the position assumed in the figure, because the entrance thereof is slightly shifted towards the foreground of the figure.

The motionless state of the panel 82a is also demonstrated by the fact that the guiding roller 83 stays in place (if the panel 82a was opened at its other guiding roller, then the guiding roller 83 would also be displaced due to it being pulled along the connector track element, especially because the latter is in an angled position tending towards the foreground of the figure).

The following features also contribute to bringing about the position of FIG. 18B. It is shown in FIG. 18A that the horizontal, sideways protruding portion of the console 124 of the guiding element 116b of the panel 82a to some extent protrudes in front of the adjacent panel 82b (cf. FIGS. 11A-11B). This protrusion is resolved, as can be observed in FIG. 18B, that the corner of the panel 82b is cut out beside the horizontal portion of the console 124 of the guiding element 118a, so the panel 82b can pass beside the console 124 of the panel 82a, so the panel 82b can be opened into the position illustrated in FIG. 18B (this cutout beside the guiding element 118a can also be observed in FIG. 19B; there can also be such situations at the top—for example related to the arrangement of the ironing scissors element—that it is necessary to allow for the opening movement this way also at the top).

In FIGS. 19A-19B the states illustrated in FIGS. 18A-18B are shown in another view. In FIG. 19A the closed state is shown; due to the changed angle of view a greater part of a connecting shaft 98 can be seen that forms a part of the guiding element 116b and interconnects the console 124 and the guiding roller 83, and it can also be seen how it extends through the brushes of the brush sealing 90.

FIG. 19A is more head-on to the main track elements 80a-80c, so the path related to the second main track element 80b (having a straight configuration interrupted by crossings) is shown better. There are also shown blocks 93 arranged between the pairs of main track elements 80a-80b and 80b-80c and allowing sufficient room for the movement of the guiding rollers. Some of the blocks are removed from the figure for easier comprehension (in that sense these are exploded figures).

Like FIG. 18B, FIG. 19B also shows the open state. The guiding roller 85 travels all the way along the connector track element 88a′ and reaches the second main track element 80b, with the edge of the latter stopping its motion, allowing the panel 82b to be displaced further along the second main track element 80b. In this state of the guiding roller 85 it can be observed how it has enough space on the second main track element 80b between the blocks 93, guiding its roller ball along the rail pair 95b of the second main track element 80b. Behind the guiding roller 83 additional portions of the first main track element 80a come into view.

Like in FIGS. 18A-19B, in FIGS. 20A-20B the closed and open states of the panels 82a, 82b are shown, but these figures (and also the subsequent FIGS. 21A-21B) show the upper portion of the panels 82a, 82b, i.e. that portion of the present embodiment of the arrangement which corresponds to the upper structure portion 115.

FIG. 20A illustrates the closed state of the panels 82a, 82b, wherein a guiding element 153b corresponding to the panel 82a and also guiding elements 155a and 155b corresponding to the panel 82b are arranged in a first main track element 151a. In FIG. 20A second and third main track elements 151b and 151c are also shown. In the view of FIG. 20A connector track elements 142a″ and 144a′ (in the foreground of the figure) and connector track elements 144a″ and 146a′ (in the background of the figure) are shown between the main track elements 151a and 151b, as well as connector track elements 142b″ and 144b′ (in the foreground of the figure) and connector track elements 144b″ and 146b′ (in the background of the figure) between the main track elements 151b and 151c. The track construction thus extends further in this direction.

It is therefore shown in FIG. 20A that in this embodiment the main track elements (in FIG. 20A, main track elements 151a-151c) and connector track elements (in FIG. 20A connector track elements 142a″, 144a′, 144a″, 146a′, 142b″, 144b′, 144b″, 146b′ are shown) of the second track construction adapted to be arranged in the upper structure portion are formed by means of an interconnected guiding trough system (in FIG. 20A the visible guiding troughs of a guiding trough system 135 can be observed) of main guiding troughs (in FIG. 20A, first, second and third main guiding troughs 133a, 133b, 133c; the guiding troughs are marked at their bottom side) and connecting guiding troughs (a connecting guiding trough 137a is marked at its end—this forms the connector track element 142a″—, and a connecting guiding trough 137b is marked at that portion thereof where the corresponding connector track element 142b″ runs to the section plane; cf. that the connector track element 86b″ also runs to the section plane, these latter two components collectively guide the corresponding panel) having (i.e. both of these having) guiding side walls (this is shown in FIG. 14A), respectively.

In FIG. 20A—like in FIG. 18A also illustrating the closed state—there can be observed that in the closed state a guiding roller 140 of the guiding element 153b corresponding to the panel 82a is situated slightly further apart from the connector track element 142a″ At the same time, the guiding roller 140 of the guiding element 155a of the panel 82b that is arranged adjacent the guiding element 153b is situated right at the connector track element 144a′, as it can be clearly seen in FIG. 20A (in FIG. 20B it even crosses it), as well as the guiding roller 85 of the guiding element 118a (cf. FIG. 18A). Although it is shown less clearly, but the guiding roller of the guiding element 155b is arranged also slightly further apart from the connector track element 144a″.

In FIG. 20A a frame profile 117 and, at the upper portion of the panel 82a, a profile element 148 are also shown.

In contrast to FIG. 20A, in FIG. 20B an open state is illustrated (cf. the states shown in FIGS. 18A-19B); accordingly, the guiding roller 140 of the guiding element 155a has been passed along the connector track element 144a′, but the other guiding element 155b of the panel 82b still remains in place.

FIGS. 21A-21B also show the region corresponding to the upper portion of the panels 82a, 82b in a closed and open state, respectively, with different features being easily visible compared to FIGS. 20A-20B because of the different view.

In FIG. 21A certain other details of the guiding element 153b are also shown. The figure shows the elongated portion of the console 154 arranged (vertically) along the panel 82a. The shorter part of the L shape extending from the elongated portion outwards and also in the direction of the adjacent panel 82b relative to the panel 82a (this protruding portion is optionally arranged above the upper edge of the panels 82a, 82b, i.e. it protrudes in front of the frame profile 117; cf. also FIG. 21B) is shown. A connecting shaft supporting the guiding roller 140 (which is implemented as a double roller also in this embodiment) is connected to the portion of the console 154 that protrudes in the direction of the panel 82b.

In the view of FIG. 21A it is allowed to see further along the first main track element 151a, while the manner of guiding a guiding roller 140 arranged in it is also illustrated in FIG. 21A, as it is shown that the guiding roller 140 is adapted to roll along the guiding side walls of the guiding trough 133a constituting the main track element 151a (the guiding trough is dimensioned such that the roller can rotate about its axis). In addition to that, FIG. 21A also shows the guiding rollers 140 of guiding elements 155a and 155b that are also adapted to be introduced into the first main track element 151a.

In FIG. 21A the system of main guiding troughs and connecting guiding troughs is shown, while the connecting guiding trough 137b is indicated at the spot where the second main track element 151b and the connector track element 142b″ meet.

As with FIG. 20B, in FIG. 21B the guiding roller 140 of the guiding element 155a has already been displaced along the connector track element 144a′ into the second main track element 151b. As it is clearly shown in FIG. 21B, meanwhile the guiding roller 140 of the other guiding element 155b corresponding to the other panel 82b is still situated in the first main track element 151a.

The above mentioned threshold cover (such as e.g. threshold cover profile elements 56 and 106) are typically made of extruded aluminium profiles, like every aluminium fenestration profile. In addition to the brush sealing arranged in the longitudinal groove (cf. the brush sealings shown in FIG. 9A and in FIGS. 18A-21B, arranged along the main track elements) receiving transverse-direction seals must also be implemented. For this function a unique part is needed, which is illustrated in FIGS. 22A-22E.

In FIGS. 22A-22E the brush holder element 71 (or butt closing brush holder) is illustrated in various views, the arrangement of such brush holder elements 71 is shown in FIG. 11B. In line with FIG. 11B, the brush holder element has two variants (which can be typically called “left-hand” and “right-hand” according to which direction the brush extends from them in their built-in state, they can optionally be differentiated by different reference numerals). The two different-orientation brush holder elements 71 is shown in top view in FIGS. 22B and 22C, and in side view in FIGS. 22D and 22E.

The brush holder element 71 shown in FIG. 22A has a block 177, with the help of which it can be retained (see FIG. 11B). The block 177 supports—according to FIGS. 22B and 22C, via an extension piece 179—brush retaining rails 175 that in turn encompass the brush retaining portion 173 (the lateral grooves of the brush holder—at the edges of the brush retaining portion 173—fit into the brush holding groove of the threshold cover profile of the main track element.

The brush holder elements 71 with unique development (preferably 3D-printed) illustrated in FIGS. 22A-22E allow that brush sealings can also be arranged along the connector track elements, that is, they make it possible that the application of brush sealings can be advantageously extended to the entire system of track elements in order to protect it against debris to a greater extent.

The illustrated component therefore has the following parts: a vertical block (a block 177) adapted for securing the component to the substructure and/or to the threshold covers; a horizontal element (a brush retaining rail 175) adapted for receiving the groove of the brush sealing and also provides the horizontal securing of the threshold cover elements; and finally a brush retaining groove (a brush retaining portion 173) that passes around 3 sides of the component and is adapted for receiving the retractable brush sealing.

The unique components are therefore made in pairs (left hand-right hand), and in addition to receiving a seal they also stiffen the threshold elements. We also wondered on forming the component adapted for providing transverse sealing utilizing aluminium profiles with ends cut at 45 degrees (a “mitre joint”), but this would result in a very small piece, so it is more expedient to apply the unique component illustrated above that can even be made with a 3D printer, and can also be suitable for serial production.

According to the above, therefore, in an embodiment the rail pairs of the track construction to be arranged in the lower structure portion are arranged in a recessed configuration, that is the interconnected rail system of the main rail pairs and the connector rail pairs is arranged in a recessed configuration (as illustrated in the figures, the rail pairs are preferably recessed (sunk) between blocks, but the recessed configuration can also be provided in another way). The recessed configuration preferably ensures that the rail pairs are not disturbing.

Furthermore, preferably there are threshold cover profile elements arranged along the main and connector track elements; this can also be formulated as the main and connector track elements are formed between threshold cover profile elements (thereby the threshold cover profile elements appoint the track elements, with the threshold cover profile elements also extending above which), the connecting shaft (to be arranged at a right angle with respect to the rail pair) that is coupled to the panel via a console and is coupled to the guiding rollers extending between the threshold cover profile elements. Therefore, also concealing the rail pairs is provided.

In the illustrated embodiment, therefore,
the first guiding roller is connected to the fenestration panel by means of a connecting shaft, and
the main track elements and the connector track elements adapted to be arranged in the lower structure portion are formed between threshold cover profile elements, and the connecting shaft is formed being suitable for extending between threshold cover profile elements.

Preferably, brush sealings are also arranged along the main track elements and along the connector track elements, i.e. at the end portions of the threshold cover profile elements preferably cut at an inclined angle (the shape of this portion corresponds to the shape of the connector track elements, cf. the description of the shape of the connector track elements); this is preferably implemented applying the element illustrated in FIGS. 22A-22E. Accordingly, brush sealings can be applied along the entire lower track construction.

In an embodiment, therefore, a brush sealing protruding above the main track elements and the connector track elements is connected to the threshold cover profile elements along the main track elements and the connector track elements.

In FIGS. 23E-26E a further embodiment of the arrangement according to the invention is illustrated. An important consideration related to the arrangement for moving fenestration panels can be whether—for example, for security reasons, or for reasons related to protection against wind and moisture—the closed state of the panels can be maintained (i.e. whether the panels can be opened without performing a particular activity, for example utilizing a handle). If, for example, the fenestration panels separate and indoor region from an outdoor region in their closed state, it is expedient to ensure that the arrangement can be opened from its closed state only from the inside (for example that it cannot be pushed inward).

This condition is not strictly necessary, because the arrangement according to the invention can also be situated indoors, or may also be applied as a separator that must be ready to be opened any time, i.e. that for opening it from the closed state—even without turning a handle, i.e. by means of a simple tab or even by only grabbing the panel—the closed state should be broken at one of the panels.

In FIGS. 23-26E such an embodiment is illustrated wherein the closed state can be maintained, and the panel is adapted to be displaced from the closed state by turning a handle. This solution can be applied for example for indoor-outdoor separation such that the handles are arranged on the indoor side.

FIG. 23 illustrates the closed state. In case of fenestration panels 202a-202d (i.e. for all panels 202a-202d) it is the downward-pointing state of a handle 210 that corresponds to this state. As with the above, four panels 202a-202d are illustrated because they form a sufficiently large unit for the purposes of illustration, but there are still not too many panels present; the number of panels can of course be increased further but it is subject to the above specified conditions (at least two, preferably at least three, particularly at least four).

In FIG. 23 the outlines of the panels can be observed, however, the lines seem to be thick illustrate the operating ironing element 212 (see below, this is shown at the top and at both sides of the given panels). In reality, the outlines of the panels are the lines situated outside these lines: at the top, the line extending below the shorter (horizontal) leg of the L shape of the consoles of the guiding elements 222a, 222b, while at the sides the line situated outside the line corresponding to the operating ironing element 212 with respect to the interior of the panel. Along this line, also the schematically depicted connection elements (members) are shown that are otherwise concealed by the edges of the panel, but in this schematic depiction they are not obstructed from view (see below).

A function group involving three positions of the handle 210 is described below. These functions may also involve handle positions that are different from the ones described below, and it is also important to mention that there can be such situations wherein the tilt function is not available (e.g., due to certain configuration features, such as angled sealing portions, it is not possible to tilt the panel from the closed state), in such cases the handle may expediently only be turned between two positions.

If large and heavy panel is applied, it can be expedient to apply a longer handle (providing greater lever arm), or to arrange another handle on the other edge of the panel that faces in the same direction. In the latter case the two handles belonging to the same panel operate the same ironing, so the two handles have to be turned in a synchronized manner.

FIG. 23 also illustrates the guiding elements corresponding to each of the panels 202a-202d, in the figure lower guiding elements 220a and 220b and upper guiding elements 222a and 222b corresponding to the panel 202a are provided with reference numerals. These are expediently configured identically to the above illustrated guiding elements. In FIG. 23 there can be observed how and where they are affixed to the panels 202a-202d.

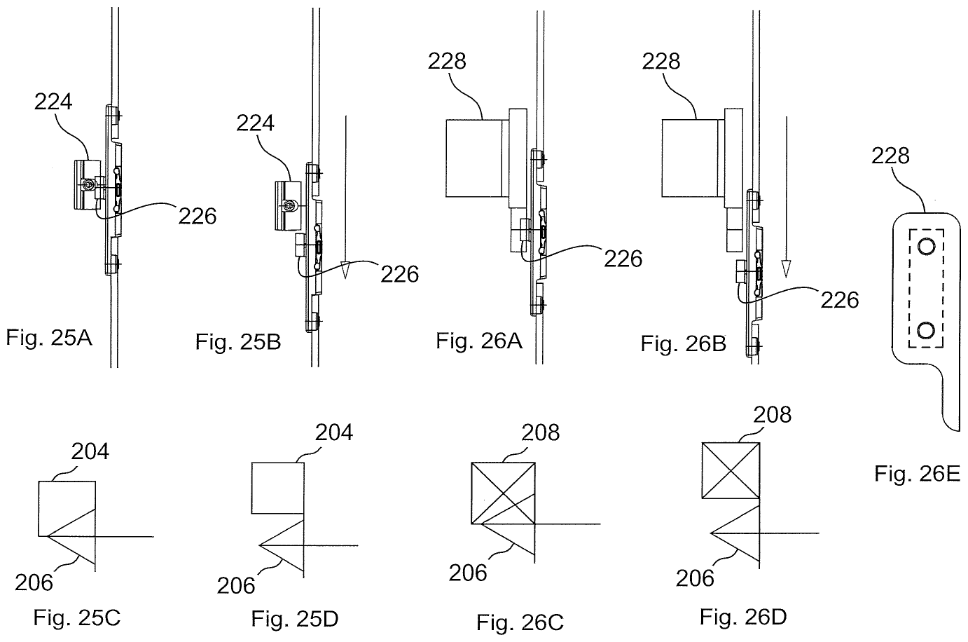

FIG. 23 also depicts the connection elements that form an important part of this embodiment; their operational details are described below. In FIG. 23 the connection elements are shown schematically. In FIGS. 25A-26E this is illustrated both in detailed views and schematically; the related description is also helpful for better comprehending the present figure.

Firstly, it is important to note that a great advantage of the illustrated embodiment lies in that the configuration and arrangement of the connection elements allows that the panels can be handled completely separately from each other. In other words, it allows for freely selecting the particular panel that we would like to open in order to release the closed state; and it is also important to emphasize that if a particular panel is selected for opening, then the connection elements need to be activated (released) on the given panel, i.e. it is not necessary to adjust the other panels (see in more detail below). This also makes possible that even two panels can be opened simultaneously at the start of the process.

In FIG. 23 protruding connection elements 206 (indicated for illustration by small arrows) arranged on the left side of the panels 202a-202d are shown. As shown, these connection elements protrude to the left from each panel, and also from a closing lateral element 218. The connection elements 206 of the closing lateral element 218 are not movable (it would not be expedient if a handle were to be taken on the closing lateral element 218), but it is not necessary as well. The connection elements 206 of the panels 202a-202d are arranged on a first ironing element branch 212a of the ironing element 212, and can be operated, displaced (downward) by turning the handle 210.

Opposite the connection elements 206 auxiliary latching connection elements 204 are arranged on a closing lateral element 216, and latching connection elements 208 are arranged on the panels 202a-202d (the latching connection elements can also be called “receiving” in the sense that—as it will become apparent below—the protruding connection element can be introduced behind them into a latching position). The auxiliary latching connection elements 204 are fixed, the connection elements 206 are movable relative to them by turning the handle 210 of the adjacent panel 202a. At the same time, the latching connection elements 208 are arranged on a third ironing element branch 212c of the ironing element 212, and can also be operated displaced also by turning the handle 210, but upwards.

A second ironing element branch 212b of the ironing element 212 is adapted for interconnecting the first and third ironing element branches 212a and 212c, such that the turning of the handle affects the entire ironing element 212.

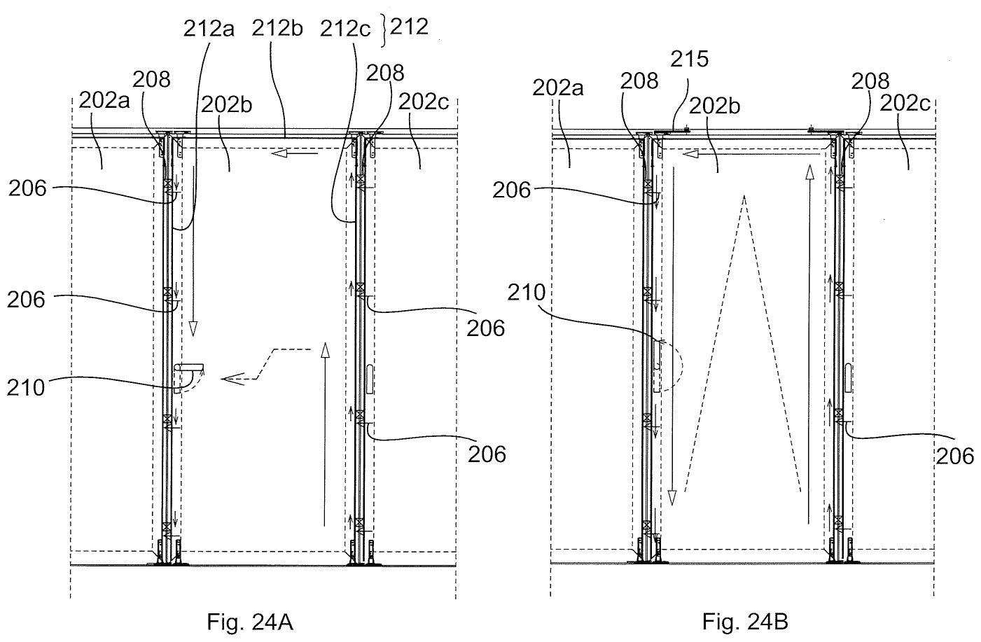

The operation of the embodiment that is illustrated also in FIG. 23 is explained referring to FIGS. 24A-24B, firstly with the activation of the “open” function. In FIGS. 24A-24B we focus on a single panel; in FIGS. 24A-24B it is marked as the panel 202b, but the panel 202c could also have be chosen, what is important—in line with the drawing—is that there are other panels situated on both sides of the illustrated panel. Based on the description of operation, the manner of connection to the closing lateral elements 216 and 218 can also be understood.

By turning the handle 210 by 90° (this is illustrated by a dashed quarter-circular arrow drawn at the handle 210)—said handle points downwards in FIG. 23—the ironing element 212 becomes in a released state, so by pulling the handle the wing is brought in a state wherein it can be displaced (slid sideways).

The closure points and the counterparts (protruding and latching connection elements 206 and 208) are expediently affixed to the ironing element 212 (preferably implemented as an aluminium rod), as was touched upon in the foregoing. Like a train on its tracks, upon turning the handle 210 the ironing element branches 212a-212c of the ironing element 212 slide in a longitudinal groove (recess) formed in the side of the profile of the panel (wing). As it was mentioned above, the auxiliary latching connection elements 204 are an exception, as they are fixedly arranged on the frame (the closing lateral element 216; this also applied for connection elements 206 arranged on the closing lateral element 218 that are also fixed, so when the panel 202 is opened the connection elements 208 are pulled therefrom). The extent to which the components are displaced by sliding relative to each other depends on the extent to which the handle 210 is turned; thereby the sliding (FIG. 24A) and tilting (FIG. 24B) function can both be accessed.

Both the sliding and the tilting functions require the release of the closure points, so the sliding displacement of the connection elements and the distance of the closure points have to be configured such that the latter are released in both states (sliding and tilting; accordingly, the positions of connection elements 206 and 208 are identical in FIGS. 24A-24B). The functions have a predetermined sequence, for example the tilting function can only be accessed after the slide function (the latter cannot be omitted).

In FIG. 24A the displacement of the protruding and latching connection elements 206, 208 with the help of the ironing element 212 can be observed. Thanks to the configuration of the ironing element 212, they are displaced simultaneously when the “open” function of the panel 202b is operated. In accordance with the figure, in a manner described below, the arrangement allows that only the activation (expediently by a handle 210) of the ironing element of a particular panel is needed for opening the given panel. In FIGS. 24A-24B the movement of the ironing element is indicated by large arrows ending in a hollow triangle, while the movement of the connection elements are indicated by small arrows drawn beside them. In FIG. 24B the arrows illustrating the movement of the ironing element are longer, because the activation of the tilt function involves a greater displacement of the handle 210 which expediently results in a greater displacement of the ironing element 212.

In the case of activation, i.e. in this case, if the handle 210 is turned by 90°, the protruding connection elements 206 of the panel 202b are displaced downwards and pulled out from the latching connection elements 208 of the panel 202a (in the case of the outermost panel 202a, they are pulled out from the latching connection elements 204). In general, it can be rephrased that these connections are released by displacing the protruding connection elements 206. To achieve that it is not needed that the latching connection elements 208 (or at the sides, the connection elements 204) are displaced.

Furthermore, in the case of activation, the latching connection elements 208 of the illustrated panel 202b are also displaced with the help of the ironing element 212. Because the protruding connection elements 206 of the adjacent panel 202c are fixed (assuming that the opening function of the panel 202c has not been activated), they are displaced (moved) upwards. It can be observed in FIG. 24A that at the two sides of the panel 202b in the normal position the latching connection elements 208 of the panel 202a on the left side are situated lower than the latching connection elements 208 of the panel 202b on the right side because the latter are released. Therefore, it can be maintained in general that these connections are released by displacing the latching connection elements 208. This principle also allows that the connection between the outermost-lying panel 202d and the closing lateral element 218 can be released by activating the opening of the panel 202d.

The panel 202b can then be opened because it is not locked against the adjacent panels. The protruding connection element 206 is configured such that (cf. FIGS. 25A-25B, 26A-26B) in its released state the panel 202b can be opened, i.e. that it does not block the panel from opening (like with opening a window sash). In this case the latching connection elements 208 of the panel 202b also do not block the opening of the panel 202b because the connection element 206 is not tensioned therein. Based on the above description it can be understood that the outermost panels 202a and 202d do not pose a problem either for the opening process as they operate the same way.

If, therefore, the handle 210 is turned by another 90° (also in the anti-clockwise direction) according to FIG. 24B, then in this embodiment the tilt (ventilation) function can be accessed as a secondary function (in line with the above described features of the tilt function, this function is not necessarily available), and the wing is thus tilted inward (in the customary manner it is tilted inward utilizing the handle 210).

For accessing the slide function from the ventilation function, the panel has to be pushed inwards at its upper portion to eliminate the tilt, then the slide function can be accessed by turning the handle clockwise by 90°. Turning the handle by another 90° will close the panel. Expediently, the tilt function cannot be accessed in the slide state, but because in such a state the arrangement can be applied for airing/ventilation so there is no need for tilting the panel/wing also when it is slid aside.

Ironing scissors elements 215 allowing for the tilt function is affixed to the consoles of the upper guiding elements (such as the guiding elements 222a, 222b in FIG. 23), and the ironing scissors element 215 (if included such a function) is activated by an appropriate displacement (i.e. by turning the handle 210 further from its 90°, horizontal position) of the ironing element 212 (for example, aluminium rod), and the arms of the ironing scissors elements 215 (both of which are shown at the top of FIG. 24B) move away from each other (i.e. the ironing scissors elements 215 are opened). The ironing scissors elements cannot be opened without being activated, so the rollers of the guiding elements stay above the console and ensure rolling (see above for more details).

In relation to FIG. 24B it is noted that the connection elements 206 and 208 are positioned like in FIG. 24A, i.e. only the arrows beside them indicate that they have been displaced further but for the sake of simplicity the elements themselves are not shown slightly further.

In FIGS. 25A-26E the closed state of the connection elements and the manner of their release is illustrated in spatial and schematic drawings. Release of the closure can be performed like in the case of a conventional fenestration panel (window or door); see in the followings.

In the case of such a fenestration arrangement wherein the moving wing/element and the fixed portion are closed against each other at an inclined connection angle, due to the applied configuration overlapping contacts are formed both along the inside and along the outside faces. The components can butt against each other only in one direction, so it is possible that the mechanism has an inward or outward opening function (in most cases, fenestration mechanisms are inward or outward opening due to their configuration; in most cases, this is also determined by the mutually contacting portions of the sashes).

In the case illustrated in FIGS. 23-24B internal closure can only result in an inward release; it is necessary to prevent this applying the connection elements if we would like to maintain the closed state. For preventing, closure points and, opposite them, closure counterparts are arranged (above, these are uniformly called “connection elements”, for differentiation the adjectives “protruding” and “latching” are used).

The protruding connection elements (closure points) are typically cylinders with their axis set parallel to the inside plane of the fenestration element. These are some kind of rollers against which the closure counterpart (latching connection element) is tensioned by rolling on it, and thereby ensures tightness for the closure (the roller can also move with respect to the closure counterpart, cf. for example the release mechanism of the connection elements 204 and 206). Tightness of closure can be achieved by the appropriate shape/configuration of the closure points.

The shape of this (i.e. of the latching connection element) can be socket-like near the edges of the structure, but because a solution has to be found also for the middle fields (between the pairs formed by the panels 202a-202d), and because the closure point can only be displaced perpendicular to the axis of the closure point, it has to be configured as some kind of a projection thereof (see also FIG. 26E). The projection is pulled from the mantle of the roller, i.e. their connection is released (by displacing the roller or the projection) such that by turning the handle, it is forced by the ironing mechanism (rod) to move inside the groove of the panel (wing).

For these, further illustration is given in relation to FIGS. 25A-26E.

In FIGS. 25C-25D, the schematically shown protruding and latching connection elements 206, 204 are illustrated in magnified views. Latching and protruding connection elements 224 and 226 are shown in FIGS. 25A and 25B in closed and open state, respectively. In case of the closed state, the projecting connection element 226 is introduced beside the projection of the latching connection element 224, which brings about the closed state.

It is important to note here that the closed state with the projection will be brought about together with the surrounding configuration (this was referred to above), because the configuration of the projection makes use of the opening direction of the fenestration element (that the panel can be opened in a particular direction may be caused by the inclined connection faces on the sides of the panel, but the panel can even be prevented from opening in the opposite direction by the track construction; the closure method illustrated in FIGS. 23E-26E is not dependent on whether the panel has inclined sides or not). If the panel can be opened in both directions, then a socket (U-shaped closure element) is required instead of a projection. Accordingly, the projection is arranged such that it prevents the protruding connection element (for example, roller) from being displaced in the opening direction, thereby provides latching.

Markings of FIGS. 25C-25D illustrate this schematically by depicting the latching connection element 204 as a square (this is the projection) from before which the protruding connection element 206 is pulled away, and thus during the opening process the connection element 206 can be passed under the connection element 204 in an “inward” direction in the figure (during closure exactly this passing is blocked). This can also be observed in the views of FIGS. 25A-25B, wherein the protruding connection element 226 is depicted as a roller, and the ironing portion connected thereto is also shown in the figure. The opening direction is indicated by an arrow in FIG. 25B (and likewise in FIG. 26B).

FIGS. 26C-26D can be described similarly; to the latching connection element 208 also corresponds a projection, and is shown in the front view of FIG. 26E as a portion projecting downward from the block. In FIGS. 26A-26B, the projection is that portion of the latching connection element 228 in front of which the protruding connection element 226, also depicted as a roller, is brought in the closed state (in FIG. 26A it is shown as brought in, while in FIG. 26B it is shown in the displaced state). The connection element 226 is secured to the ironing element in the same way in FIGS. 25A-25B and 26A-26B, because the same component is shown.

In the embodiment illustrated in FIGS. 23-26E, therefore, on each fenestration panel
a first connection element (this is preferably formed by a protruding connection element) on a first lateral side interconnecting the guide sides of the fenestration panel, and
a second connection element (this is preferably formed by a latching connection element) on a second lateral side interconnecting the guide sides of the fenestration panel

(the first and second connection elements) adapted to be arranged facing an adjacent fenestration panel or a closing lateral element, fixed to an operating ironing element are arranged, wherein the first connection element and the second connection element are adapted to be displaced by means of the operating ironing element, and are configured to be connected, respectively, to a second connection element and a first connection element, adapted to be arranged oppositely, of an adjacent fenestration panel or a closing lateral element.

According to the above, therefore, the first and second connection elements are adapted to be connected to each other; they can be interconnected by displacing them, and their connection can of course be released in a similar manner; in this case their interconnection implies—according to the above—that in their interconnected state they prevent the panel from being opened with respect to the adjacent panel, optionally in cooperation with other configuration features—for example, panel edges, track configuration.

The following is noted concerning the dimensions: The dimensions of the wing can be determined, expediently for two-handed operation, for example as follows. In such a case, possible preferred values are given below.

The height of the wing/panel equals the storey height, maximum 3.0 metres, its maximum width is 1.5 metres. Wider panels are expediently moved by a motor.

About masses: Sashes with a mass greater than 300-350 kg are already uncomfortable to move by manually, but applying motorized operation even several tons can be moved if the roller can bear the load (the illustrated roller can).

Basically, the minimum wing width can be approximately 1000 mm, with manual operation the maximum width can be 1500 mm. The height can be 2700-3000 mm, which equals the height of room. The size of the parking tracks is minimum the width of the sashes. Distance between track axes is approximately twice the thickness of the panels+20 mm. The console is arranged at a distance from the edge that is minimum the same as the wing thickness.

In an example, the characteristic values are the following: The number of panels is four. The width of the panels is for example 963 mm (i.e. approximately 1 m as specified above), while their thickness is 86 mm. In the example, the mass of the panel is 100 kg (glazed panel with an aluminium frame).

In this example, the distance between the connector track elements in a track element-connecting pair is 832 mm, and between connector track elements (closer to each other) not forming a pair the distance is 131 mm. In an example, the panel height is 2200 mm, but this can of course be adjusted according to the height of room.

In this example, furthermore, the distance between the centerlines of the main track elements is 185 mm, the width of the lower main track elements is 60 mm (at the portion under the threshold, around the roller), and the width of the roller socket fitting thereto is 55 mm; also, the width of the upper main track elements is 20 mm, and the width of the roller (shown as double) fitting thereto is 18 mm.

The width of the closing lateral element 14 characterizing well width of the block of parking tracks is 1200 mm in the example (the sealing edge is further 29 mm).

In the example, the shaft protruding from the console is at a distance of 18 mm from the edge of the panel, and the console extends 10 cm upwards along the panel, and the end of the roller ball extends 8 cm downwards from the bottom of the console.

Further dimensions of the example can also be obtained from the scaled drawings.

Thanks to this arrangement, therefore, the portion of the guiding element that is directly responsible for guiding is preferably recessed and concealed, and the bottom plane of the panel is situated above the threshold profile (with a tolerance; i.e. it is arranged in a manner to prevent contact). Thus, the rollers and the rail system are not visible, because preferably the size of the gaps between the threshold profile elements is such that the connecting shaft of the guiding roller can (comfortably) fit between the brush sealings arranged along their edges (the distance between the oppositely arranged brush sealings is preferably smaller than the diameter of the connecting shaft).

In the invention a suspension mechanism is not expediently applied because it is not needed; guiding at the top is sufficient also in the case of sliding or folding-systems. In case of sliding panel systems there are two types of existing approaches: the first comprises rollers for a “floating” configuration at the bottom frame (i.e. the panel—which in many cases is very heavy—runs on the rollers) and a guiding configuration at the top (which is essentially adapted for ensuring that the panel does not fall out, that is why the rollers of the illustrated type are applied at the top guiding), the embodiments illustrated in the figures are based on this principle; while according to the other approach the panels are suspended at the top applying guiding at the bottom portion (in this case, the panel runs along a rail arranged at the top by means of a carriage, while at the bottom a pin is arranged on a rail to guide the panel and prevent it from falling out).

The approach disclosed in HU 223 805 B1, mentioned in the introduction, is adapted for vertically moving window sashes; the accessible functions are provided accordingly, with a number of natural limitations on the movements that stem from the functions. In this approach the window sashes can only be moved from their base position one after the other, and even thereafter the sashes can only be moved considering each other, because only two rail tracks allowing for the simple opening of the window (i.e. freeing up the lower part) are arrange behind each other.

HU 223 805 B1 does not aim at extending the set of functions as the desired functionality can be achieved by the disclosed approach. On the contrary, one of the advertised advantages of this approach is its small space demand. In contrast to that not the space demand, but for the invention the primary consideration was providing the greatest possible variability.

In HU 223 805 B1 the configuration of the rails (grooves) also serves the sole function that is disclosed in the document (i.e. utilizing the turnout track sections perpendicular to the main track sections, and applying the curved pullaway track section). In contrast to that, in the invention the tracks (rails at the bottom) are arranged as a system, preferably even modularly, the connector track elements are arranged parallel to each other (i.e. generally at the same distance from each other along their entire length). This also allows for a modular configuration, i.e. an arbitrary number of the repeated blocks (as shown in the drawings) can be applied, so the number of the applied fenestration panels can be chosen freely.

In HU 223 805 B1 such modularity is not desirable, so local (non-modular, non-repeating) configuration types adapted for providing the given function are applied (see for example the arrangement of the rail tracks adapted for tilting the lower window sash backwards and for introducing the upper sash into the wall portion under the window, and also the internal arrangement of the rail tracks inside the wall portion under the window). Accordingly, the approach of HU 223 805 B1 is does not have a continuous (raster-net) configuration.

It is mentioned in HU 223 805 B1 that the window can also be manually operated. It has to be noted that, due to the complexity of the movements, there can occur a lot of such situations in the approach of HU 223 805 B1 wherein it would not be possible to manually operate the arrangement (due to obstructions or inaccessible parts), or it could be manually operated only by simultaneously approaching it from both sides, which is not really feasible in the case of a window. In contrast to that, the high degree of variability of the arrangement according to the invention can be made use of even by applying manual operation.

In the introduction more documents were mentioned that include tracks (typically two of them) extending beside each other, but the tracks are not connected by means of connector track elements (i.e. switching between the main tracks is not implemented utilizing such elements) but by other (e.g. lifting) mechanism.

Also, certain prior art approaches apply divider ribs between the panels (see further below) that can be expedient for the given application. In contrast to that, according to the invention it is not desirable to apply divider ribs. Without applying divider ribs, an opening covered by the fenestration panels arranged in a row can be freed up completely, so the spatial regions divided by the fenestration arrangement can be joined fully (see the state illustrated in FIG. 16G).

In such an embodiment of the arrangement according to the invention wherein, in a base position of the fenestration panels corresponding to the closed state
the guiding elements of the fenestration panel are arranged in the first main track element, and
the outermost fenestration panels are connected to a first closing lateral element and a second closing lateral element, respectively,

it preferably also holds true that in the base position of the fenestration panels corresponding to the closed state thereof each of the fenestration panels are connected (a connecting seal—with parallelogram-shaped layout outlines —, or one meeting at edges—with rectangular-shaped layout outlines) directly (that is, expediently without inserting a fixed divider rib affixed in the lower and upper guiding element)
to adjacent fenestration panels (such panels are the fenestration panels that are arranged in the base position between two other fenestration panels; in such a case wing-to-wing connections are made, producing an overlapped tightness—with parallelogram-shaped layout outlines —, or one meeting at edges—with rectangular-shaped layout outlines), or
to an adjacent fenestration panel and a closing lateral element (such are the fenestration panels arranged in outermost positions in the base state; in the case of identical panel sizes these are interchangeable, but panels of different width may also be applied).

In relation to the prior art approaches the following additional points are made.

Hungarian patent No. HU 223805 discloses a sliding window structure that is made up of two sashes balanced by suspended counterweights and guided by pins in guiding grooves in the two vertical sides of the frame. Each of the two sashes moves along a respective vertical track. The sashes can be placed on both tracks in the wall portion under the window—in that case the opening above said wall portion is freed up completely. This prior art approach has the drawbacks that the sashes are not able to exchange their places, and that the sashes are guided only along two guiding rails.

GB 1,263,866 discloses a window structure wherein the sashes can be displaced from their base position in a horizontal plane—perpendicular to their principal surface—by a special roller system, whereupon the sashes can slide in front of each other's plane. A disadvantage of the approach that it utilizes a vertical divider rib. The wing does not connect with wing, so they do not form a surface that could be freed up completely (and thus could be used e.g. for terrace access). The sashes cannot be pushed away to the left or right (cannot be stacked) because only two tracks are included, and the sashes can move at 90°.

U.S. Pat. No. 4,574,524 A discloses a sliding door cupboard wherein the doors can be lifted in front of each other's plane applying a special ironing system disposed at the bottom, and thus they can be freely and independently moved in front of/behind the other door panel. The disadvantages of the approach are that the sliding and lifting displacement are only at right angles, and that the doors are moved applying special mechanisms rather than a rail track.

In CN204370956 U a sliding door cupboard is disclosed similar to the approach disclosed in U.S. Pat. No. 4,574,524 A wherein the doors can be lifted in front of each other's plane applying a special ironing system arranged at the top, and thus they can be freely and independently moved in front of/behind the other door panel. A drawback of the approach is that the doors can be displaced only sequentially—like a train with carriages—along a track including switches. It has a suspended system, and there is an angle of 90° between the track and the direction of displacement. It cannot be applied for implementing a windproof and waterproof frontage fenestration element, and it is also not suitable as an indoors acoustic barrier, while the door segments cannot be moved in a tilted position.

In JP2010-024800 A a guide system is disclosed by means of which flat panels/fenestration elements can be moved in two directions. Panel movement is enabled horizontally in the two principal directions (parallel to and perpendicular to the plane of the panels) by a suspension rail system. A disadvantage of the approach is that it has an “office chair” mechanism, i.e. the wheel rotates.

In KR100806171 B1 a movable terrace door arrangement is disclosed that allows for modifying the size of a terrace by moving fenestration elements in directions perpendicular to the plane thereof. The glazed elements can be moved guided by bottom and top rails (concealed in the bottom and top floor); with mesh/foil built into the frame structure extending between the edges of fenestration elements pulled away from each other. The approach has the disadvantage that the tracks cannot be moved laterally. The sashes are not interchangeable, cannot be tilted, and the surface cannot be freed up completely (in lack of parking tracks).

As a summary of the foregoing, the followings are also noted in relation to the invention (referring also to the figures; the features described below are optional which fulfilled in some cases).

In Europe only thermal bridge-free (i.e. thermally insulated) facade fenestration elements can be put on the market. In the closed (i.e. rest) state every system component has to contribute to perfect sealing, while there is a constant need for temporarily opening up the facade surface. One of the dominant trends in contemporary architecture is minimalism. This trend aims at implementing glazed surfaces extending from floor to ceiling and along the entire width of the façade, consisting of as large uninterrupted panes as possible.

The object set before the invention is to provide a complex solution for operating fenestration elements that fulfils all needs for various modes of opening, and allows for moving the panels both simultaneously and individually, and preferably provides a thermal bridge-free closed state. The weight limit of the movable frames preferably allows for moving panels weighing 1500 kg.

The essential feature of the system preferably implemented by the invention is that panels (e.g. thermal insulating glass panels) are moved in a restricted manner along raster-net rail tracks recessed into the floor and in the ceiling plane, on special suspension and support elements, by way of manual, electromagnetic, or electric force, by tensioned wires, or optionally by a combination thereof, such that in the rest position the panels can be arranged in a row with each other along a vertical plane in a sealed (windproof) manner to fulfil the need of closing off an opening in the building and facade (see FIGS. 1 and 3).

Standing angle of the facade panels during operation is not necessarily vertical, because due to the properties of the rail system and the lower and upper guiding elements it may be necessary to implement an inward tilt function at the top (see FIGS. 13 and 14A-14B), an inward ascending function at the bottom, a parallel inward displacement function, and also displacements may be demanded along the shortest possible route in horizontal tracks (preferably according to commands issued utilizing a special software application) in infinite arrangements of the variation.

In case the number of the lower and upper guiding elements does not exceed 2-2 pieces each, then the panels can also perform “corner turns” on certain arcuate or broken-line rail systems. If all the guiding elements of the 2-2 piece set are in a sliding (retractable) relationship with the panel, then the panels can also perform the openable function (i.e., when one (top and bottom) pair of the preferably four consoles can be retracted with the rollers from the lower and upper rails, while the other side is fixed below and above them by the corresponding consoles utilizing protruding pins, then it will be possible to open the wing; this, however, works only for edge-sealed sashes).

Utilizing the special guiding mechanism preferably applied in the invention a product that is unique in the world market has been produced, with which applying the largest currently available thermal insulating glass panes with the highest transparency, functions performing almost all the opening modes, individually for each panel, or even simultaneously can be performed, while it is also possible to move away the panels and stack them at a given location. The panels can be glazed or solid but may practically also have any filling that is allowed as a result of static dimensioning.

The frame structure of the panels and the sealing approach included around them, as well as the control and/or power supply of the suspending and supporting guiding elements do not fall into the competence of the present patent claim. The system established with the invention preferably is operable only with parallel bottom and top raster-net track guiding.

In relation to guiding and supporting the panels at the bottom, the followings are given. The facade being in connection with the panels preferably receives a framing extending fully around. The framing is preferably fully built into the receiving structure (floor, ceiling, and side walls) in a recessed implementation.

The bottom framing is a load relieving element that extends all along, is partially thermal bridge-free, but incapable of water absorption, which element is preferably also adapted for draining water (e.g. splash water in a pool room, condensation water leaking from the panels) in a non-visible manner.

The bottom framing receives the bottom raster-net rail track that can be formed applying prefabricated rails, rail crossings, and special module elements, built as a raster connectible by means of claws. The bottom raster-net rail track is preferably built from modules to provide an easy modular design (manufacturing) and easy on-site installation and establishing free from human errors.

Preferably, a step-proof covering is placed on top of the modules of the raster-net rail track aligned with the level of the indoor floor, in which the entire track layout and its crossings are milled out from. The width of the milling-out is chosen to the connector stem between the bottom guiding element and the supported panel. The inclusion of such a covering is expedient (necessary if certain parts are to be concealed), because without it the passages of the modular raster-net rail track may become blocked, even an occasional fallen foreign object may cause operational obstructions, as well as in the fully open state this is also required for providing that user may pass comfortably.

In relation to guiding and suspending at the top, the followings are given. The upper framing is identical in appearance to the bottom one, but it does not have waterproofing tasks. Like with the bottom raster-net rail track, track modules are also arranged in the upper framing mirrored to a horizontal axis parallel to the floor plane, which can be done by prefabricated rail and rail crossing module elements (crossing point), building in a raster interconnectable mechanically by claws.

A covering is fixed on the underside of the track modules place to the upper framing, aligned with the level of the indoor ceiling, and the entire track layout and its crossings are milled out from the covering. The width of the milling is chosen to the connector stem between the upper guiding element and the suspended panel. The upper covering is implemented applying material dimensioned for tensile and shear loads and corresponding retaining elements, because suspension is realized only by means of the guiding element supported on the upper edges of the milled-out portions of the covering.

The invention is preferably a logistic system for moving fenestration elements, which—like a marshalling yard—is able to realize the moving of fenestration panels independent of each other, exchanging their positions, in an airtight-sealed manner utilizing more than two rail tracks. Rail track moving can be realized by an expedient modification of the fenestration threshold such that a guiding upper threshold is also applied together with the bottom threshold suitable for providing the independent movement.

The system provided by the invention is preferably such an ironing mechanism that is adapted for tilting, opening, sliding, parallel-opening, collecting to a place of fenestration panels (optionally glazed) which can be installed along straight, arcuate or broken-line layouts that is characterised by that it operates/moves an unlimited number of frames guided simultaneously at multiple points by means of stems, connector elements and/or sliding or rolling elements in continuously installed raster-net rail tracks simultaneously and/or independent of each other depending on the track capacity, operated and moved manually, or by electromagnetic, electric means, tensioned wires, or motorized, or a combined force thereof.

Not all buildings are of straight base layout, but opening up a corner is also frequently needed. The guiding function of the transverse-direction tracks can also operate in a broken-line configuration, but in this case their relative position (distance and angle) at the breaking edges will be different in the case of the first and the second pusher tracks and of the second and third pusher tracks (main track element).

In the case of an arcuate or broken-line layout, the position of the transverse tracks is preferably calculated by software, and fully unique manufacturing is done, so we cannot speak of modularity.

Arcuate configuration: In the case of a guiding requiring any curve that differs from the straight track path, the main track paths are not kept parallel to each other because, although the arcs they describe have the same radius, these have different focal points. The path of the track switch (connector track element) can be designed accordingly; the bottom support and the top guide paths are still required to be parallelly extending.

Broken-line configuration: The main track may also have a path that is different from the straight-line, i.e. a broken-line guiding configuration can be formed such that the corner points of the main track path (path of the main track elements) are situated on a constructed (not mutually parallel) curved line, with the arcs having identical radius but different focal points. The paths of the track switches can be designed accordingly; the bottom support and the top guiding are still required to be parallelly extending. The breaking points can be arranged symmetrically along the arcs situated between the track switches; however, if we would like to arrange them more densely, or the radius of the arcs would be highly reduced, then some track switches must be eliminated proportionately.

The invention is, of course, not limited to the preferred embodiments described in details above, but further variants, modifications and developments are possible within the scope of protection determined by the claims.

1. An arrangement for moving fenestration panels, the arrangement comprising
fenestration panels (12a-12d, 82a-82b, 202a-202d) each having two guiding elements (38a, 38b, 40a, 40b, 52, 65, 116b, 118a, 118b, 153b, 155a, 155b, 220a, 220b, 222a, 222b) protruding respect to each of opposite guide sides thereof, and
two track constructions (5, 7) having identical paths, each adapted oppositely arranged for guiding the two guiding elements (38a, 38b, 40a, 40b, 52, 65, 116b, 118a, 118b, 153b, 155a, 155b, 220a, 220b, 222a, 222b) protruding respect to each of the opposite guide sides of the fenestration panels (12a-12d, 82a-82b, 202a-202d),
characterised in that
the two track constructions (5, 7) are adapted to be arranged in a lower structure portion (13, 113) and in an upper structure portion (15, 115), respectively,
each of the track constructions (5, 7) comprising
a first, a second and a third main track element (10a-10c, 21a-21c, 80a-80c, 151a-151c) adapted to be arranged beside each other, and
connector track elements (26a′-26b″, 28a′-28b″, 30a′-30b″, 32a′-32b″, 86a″, 88a′, 86b″, 88b′, 142a″, 144a′, 142b″, 144b′) adapted for interconnecting the first main track element (10a, 21a, 80a, 151a) and the second main track element (10b, 21b, 80b, 151b), as well as the second main track element (10b, 21b, 80b, 151b) and the third main track element (10c, 21c, 80c, 151c), wherein a respective track element-connecting pair (32a, 32b) of the connector track elements (26a′-26b″, 28a′-28b″, 30a′-30b″, 32a′-32b″, 86a″, 88a′, 86b″, 88b′, 142a″, 144a′, 142b″, 144b′) is configured being suitable for separated transferring of the two guiding elements (38a, 38b, 40a, 40b, 52, 65, 116b, 118a, 118b, 153b, 155a, 155b, 220a, 220b, 222a, 222b) of each of the fenestration panels (12a-12d, 82a-82b, 202a-202d) corresponding to the given track construction (5, 7) between the respective main track elements (10a-10c, 21a-21c, 80a-80c, 151a-151c).

2. The arrangement according to claim 1, characterised in that
in a base position of the fenestration panels (12a-12d, 82a-82b, 202a-202d) corresponding to a closed state the guiding elements (38a, 38b, 40a, 40b, 52, 65, 116b, 118a, 118b, 153b, 155a, 155b, 220a, 220b, 222a, 222b) of the fenestration panels (12a-12d, 82a-82b, 202a-202d) are arranged in the first main track element (10a, 21a, 80a, 151a), and
a separate track element-connecting pair (32a) of the connector track elements (26a′-26a″, 28a′-28a″, 30a′-30a″, 32a′-32a″, 86a″, 88a′, 142a″, 144a′) corresponds to each of the fenestration panels (12a-12d, 82a-82b, 202a-202d) between the first main track element (10a, 21a, 80a, 151a) and the second main track element (10b, 21b, 80b, 151b), and in the base position of the fenestration panels (12a-12d, 82a-82b, 202a-202d) at least one of the guiding element (38a, 38b, 40a, 40b, 52, 65, 116b, 118a, 118b, 153b, 155a, 155b, 220a, 220b, 222a, 222b) pairs of the guiding elements (38a, 38b, 40a, 40b, 52, 65, 116b, 118a, 118b, 153b, 155a, 155b, 220a, 220b, 222a, 222b) of the fenestration panels (12a-12d, 82a-82b, 202a-202d) located at the opposite guide sides and corresponding to each other according to the identical paths of the track constructions (5, 7) is arranged at a connector track element (26a′, 28a′, 30a′, 32a′, 88a′, 144a′).

3. The arrangement according to claim 2, characterised in that a separate track element-connecting pair (32b) of the connector track elements (26b′-26b″, 28b′-28b″, 30b′-30b″, 32b′-32b″, 86b″, 88b′, 142b″, 144b′) corresponds to each of the fenestration panels (12a-12d, 82a-82b, 202a-202d) between the second main track element (10b, 21b, 80b, 151b) and the third main track element (10c, 21c, 80c, 151c).

4. The arrangement according to claim 3, characterised in that connection locations
of first track element-connecting pairs (32a) of the connector track elements (26a′-26a″, 28a′-28a″, 30a′-30a″, 32a′-32a″, 86a″, 88a′, 142a″, 144a′) between the first main track element (10a, 21a, 80a, 151a) and the second main track element (10b, 21b, 80b, 151b), and
of second track element-connecting pairs (32b) of the connector track elements (26b′-26b″, 28b′-28b″, 30b′-30b″, 32b′-32b″, 86b″, 88b′, 142b″, 144b′) between the second main track element (10b, 21b, 80b, 151b) and the third main track element (10c, 21c, 80c, 151c)
to the second main track element (10b, 21b, 80b, 151b) are shifted with respect to each other along a longitudinal direction of the second main track element (10b, 21b, 80b, 151b).

5. The arrangement according to claim 1, characterised in that in the track element-connecting pairs (32a, 32b) of the connector track elements (26a′-26b″, 28a′-28b″, 30a′-30b″, 32a′-32b″, 86a″, 88a′, 86b″, 88b′, 142a″, 144a′, 142b″, 144b′) a distance between respective principal lines of the connector track elements (26a′-26b″, 28a′-28b″, 30a′-30b″, 32a′-32b″, 86a″, 88a′, 86b″, 88b′, 142a″, 144a′, 142b″, 144b′) is smaller than a distance between the two guiding elements (38a, 38b, 40a, 40b, 52, 65, 116b, 118a, 118b, 153b, 155a, 155b, 220a, 220b, 222a, 222b) of the fenestration panels (12a-12d, 82a-82b, 202a-202d) corresponding to the respective track constructions (5, 7).

6. The arrangement according to claim 5, characterised in that
lateral sides interconnecting the guide sides of the fenestration panels (12a-12d, 82a-82b, 202a-202d), adapted for being arranged to face adjacent fenestration panels (12a-12d, 82a-82b, 202a-202d) or an adjacent fenestration panel (12a-12d, 82a-82b, 202a-202d) and a closing lateral element (14, 20, 216, 218) are configured as sealing portions (68, 70, 122) adapted for sealing against the portions of the adjacent fenestration panels (12a-12d, 82a-82b, 202a-202d) or an adjacent fenestration panel (12a-12d, 82a-82b, 202a-202d) and a closing lateral element (14, 20, 216, 218) that are to be arranged opposite the lateral sides, and
the sealing portions (68, 70, 122) have an inclined configuration such that the guide sides have a parallelogram-like shape, and in a base position of the fenestration panels (12a-12d, 82a-82b, 202a-202d) corresponding to a closed state thereof, a connector track element (26a′, 28a′, 30a′, 32a′, 88a′, 144a′) of the track element-connecting pair (32a) of the given fenestration panel (12a-12d, 82a-82b, 202a-202d) is arranged near those guiding elements (38a, 40a, 52, 65, 118a, 155a, 220a, 222a) corresponding to the respective track constructions (5, 7) to which sealing portion (70, 122) with inclined configuration having the inclined configuration starting in a direction opposite the main track elements (10a-10c, 21a-21c, 80a-80c, 151a-151c) towards inside of the fenestration panel (12a-12d, 82a-82b, 202a-202d) is situated closer.

7. The arrangement according to claim 1, characterised in that
the main track elements (10a-10c, 80a-80c) and the connector track elements (26a′-26b″, 28a′-28b″, 30a′-30b″, 32a′-32b″, 86a″, 88a′, 86b″, 88b′) of the first track construction (5) adapted to be arranged in the lower structure portion (13, 113) are formed by means of an interconnected rail system (50, 100) of main rail pairs (58a-58c, 95a-95c) and connector rail pairs (97a, 97b), respectively, and
first guiding elements (38a, 38b, 40a, 40b, 65, 116b, 118a, 118b, 153b, 155a, 155b, 220a, 220b) of the fenestration panels (12a-12d, 82a-82b, 202a-202d) corresponding to the first track construction (5) adapted for arranging in the lower structure portion (13, 113) each have a first guiding roller (60, 83, 85) adapted for guiding on the rail system (50, 100).

8. The arrangement according to claim 7, characterised in that the first guiding roller (60, 83, 85) has a roller housing (61) and a roller ball (62, 81, 87) arranged therein and adapted for guiding on the rail system (50, 100).

9. The arrangement according to claim 7, characterised in that the interconnected rail system of the main rail pairs (58a-58c, 95a-95c) and the connector rail pairs (97a, 97b) is arranged in a recessed configuration.

10. The arrangement according to claim 9, characterised in that
the first guiding roller (60, 83, 85) is connected to the fenestration panel (12a-12d, 82a-82b, 202a-202d) by means of a connecting shaft (29, 98, 102, 104), and
the main track elements (10a-10c, 21a-21c, 80a-80c, 151a-151c) and the connector track elements (26a′-26b″, 28a′-28b″, 30a′-30b″, 32a′-32b″, 86a″, 88a′, 86b″, 88b′, 142a″, 144a′, 142b″, 144b′) adapted to be arranged in the lower structure portion (13, 113) are formed between threshold cover profile elements (56, 106), and the connecting shaft (29, 98, 102, 104) is formed being suitable for extending between threshold cover profile elements (56, 106).

11. The arrangement according to claim 10, characterised in that a brush sealing (66, 73, 90) protruding above the main track elements (10a-10c, 21a-21c, 80a-80c, 151a-151c) and the connector track elements (26a′-26b″, 28a′-28b″, 30a′-30b″, 32a′-32b″, 86a″, 88a′, 86b″, 88b′, 142a″, 144a′, 142b″, 144b′) is connected to the threshold cover profile elements (56, 106) along the main track elements (10a-10c, 21a-21c, 80a-80c, 151a-151c) and the connector track elements (26a′-26b″, 28a′-28b″, 30a′-30b″, 32a′-32b″, 86a″, 88a′, 86b″, 88b′, 142a″, 144a′, 142b″, 144b′).

12. The arrangement according to claim 1, characterised in that
the main track elements (21a-21c, 151a-151c) and the connector track elements (142a″, 144a′, 144a″, 146a′, 142b″, 144b′, 144b″, 146b′) of the second track construction (7) adapted to be arranged in the upper structure portion (15, 115) are formed by means of an interconnected guiding trough system (25, 135) of main guiding troughs (23a-23c, 133a-133c) and connecting guiding troughs (137a, 137b) having guiding side walls (27), respectively, and
second guiding elements (52, 153b, 155a, 155b, 222a, 222b) of the fenestration panels (12a-12d, 82a-82b, 202a-202d) corresponding to the second track construction (7) adapted for arranging in the upper structure portion (15, 115) each have a second guiding roller (42, 140) adapted for guiding on guiding side walls (27) of a guiding trough system (25, 135).

13. The arrangement according to claim 12, characterised in that in at least one of the fenestration panels (12a-12d, 82a-82b, 202a-202d) the second guiding roller (42, 140) is connected to the fenestration panel (12a-12d, 82a-82b, 202a-202d) by means of an ironing scissors element (74, 215) enabling the tilted opening of the fenestration panel (12a-12d, 82a-82b, 202a-202d).

14. The arrangement according to claim 1, characterised in that in a base position of the fenestration panels (12a-12d, 82a-82b, 202a-202d) corresponding to a closed state thereof
the guiding elements (38a, 38b, 40a, 40b, 52, 65, 116b, 118a, 118b, 153b, 155a, 155b, 220a, 220b, 222a, 222b) of the fenestration panels (12a-12d, 82a-82b, 202a-202d) are arranged in the first main track element (10a, 21a, 80a, 151a), and
the outermost fenestration panels from the fenestration panels (12a-12d, 82a-82b, 202a-202d) are connected to a first closing lateral element (14, 216) and a second closing lateral element (20, 218), respectively.

15. The arrangement according to claim 14, characterised in that in the base position of the fenestration panels (12a-12d, 82a-82b, 202a-202d) corresponding to the closed state thereof each of the fenestration panels (12a-12d, 82a-82b, 202a-202d) are connected directly
to adjacent fenestration panels (12a-12d, 82a-82b, 202a-202d), or
to an adjacent fenestration panel (12a-12d, 82a-82b, 202a-202d) and a closing lateral element (14, 20, 216, 218).

16. The arrangement according to claim 14, characterised in that each of the track constructions (5, 7) comprises, adapted to be arranged along the first closing lateral element (14, 216) and/or the second closing lateral element (20, 218)
a second parking track portion (34b) and a third parking track portion (34c) being connected, respectively, to the second main track element (10b, 21b, 80b, 151b) and to the third main track element (10c, 21c, 80c, 151c), as a continuation thereof, and
one or more auxiliary parking track portion (34d, 34e), adapted for arranging beside the third parking track portion (34c), in such a number that a summed number of the second parking track portion (34b), the third parking track portion (34c) and the one or more auxiliary parking track portion (34d, 34e) is equal to or greater than the number of the fenestration panels (12a-12d, 82a-82b, 202a-202d), and each auxiliary parking track portion (34d, 34e) is connected to the third parking track portion (34c) or to an adjacent auxiliary parking track portion (34d) situated closer to it than the third parking track portion (34c) by a track element-connecting pair (36c) of connector track elements (36c′, 36c″).

17. The arrangement according to claim 1, characterised in that a principal line of each of the connector track elements (26a′-26b″, 28a′-28b″, 30a′-30b″, 32a′-32b″, 86a″, 88a′, 86b″, 88b′, 142a″, 144a′, 142b″, 144b′) is at a non-perpendicular angle with respect to the main track elements (10a-10c, 21a-21c, 80a-80c, 151a-151c) connected to the connector track element (26a′-26b″, 28a′-28b″, 30a′-30b″, 32a′-32b″, 86a″, 88a′, 86b″, 88b′, 142a″, 144a′, 142b″, 144b′).

18. The arrangement according to claim 17, characterised in that each of the connector track elements are rounded off at their connection location to the main track elements.

19. The arrangement according to claim 17, characterised in that
in the track element-connecting pairs (32a, 32b) of the connector track elements (26a′-26b″, 28a′-28b″, 30a′-30b″, 32a′-32b″, 86a″, 88a′, 86b″, 88b′, 142a″, 144a′, 142b″, 144b′) the distance between the principal lines of the connector track elements (26a′-26b″, 28a′-28b″, 30a′-30b″, 32a′-32b″, 86a″, 88a′, 86b″, 88b′, 142a″, 144a′, 142b″, 144b′) is smaller than the distance between the two guiding elements (38a, 38b, 40a, 40b, 52, 65, 116b, 118a, 118b, 153b, 155a, 155b, 220a, 220b, 222a, 222b) of the fenestration panels (12a-12d, 82a-82b, 202a-202d) corresponding to the respective track constructions (5, 7),
lateral sides interconnecting the guide sides of the fenestration panels (12a-12d, 82a-82b, 202a-202d), adapted for being arranged to face adjacent fenestration panels (12a-12d, 82a-82b, 202a-202d) or an adjacent fenestration panel (12a-12d, 82a-82b, 202a-202d) and a closing lateral element (14, 20, 216, 218) are configured as sealing portions (68, 70, 122) adapted for sealing against the portions of the adjacent fenestration panels (12a-12d, 82a-82b, 202a-202d) or an adjacent fenestration panel (12a-12d, 82a-82b, 202a-202d) and a closing lateral element (14, 20, 216, 218) that are to be arranged opposite the lateral sides,
the sealing portions (68, 70, 122) have an inclined configuration such that the guide sides have a parallelogram-like shape, and in a base position of the fenestration panels (12a-12d, 82a-82b, 202a-202d) corresponding to a closed state thereof, a connector track element (26a′, 28a′, 30a′, 32a′, 88a′, 144a′) of the track element-connecting pair (32a) of the given fenestration panel (12a-12d, 82a-82b, 202a-202d) is arranged near those guiding elements (38a, 40a, 52, 65, 118a, 155a, 220a, 222a) corresponding to the respective track constructions (5, 7) to which first sealing portion (70, 122) with an inclined configuration having the inclined configuration starting in a direction opposite the main track elements (10a-10c, 21a-21c, 80a-80c, 151a-151c) towards inside of the fenestration panel (12a-12d, 82a-82b, 202a-202d) is situated closer, and
the angle between the principal line of the connector track elements (26a′-26b″, 28a′-28b″, 30a′-30b″, 32a′-32b″, 86a″, 88a′, 86b″, 88b′, 142a″, 144a′, 142b″, 144b′) and the main track elements (10a-10c, 21a-21c, 80a-80c, 151a-151c) connected to the connector track element (26a′-26b″, 28a′-28b″, 30a′-30b″, 32a′-32b″, 86a″, 88a′, 86b″, 88b′, 142a″, 144a′, 142b″, 144b′) differs from the perpendicular such that the connector track element (26a′-26b″, 28a′-28b″, 30a′-30b″, 32a′-32b″, 86a″, 88a′, 86b″, 88b′, 142a″, 144a′, 142b″, 144b′) extends in a direction opposite with respect to the first sealing portion (70, 122) with the inclined configuration.

20. The arrangement according to claim 1, characterised in that on each fenestration panel (12a-12d, 82a-82b, 202a-202d)
a first connection element on a first lateral side interconnecting the guide sides of the fenestration panel (12a-12d, 82a-82b, 202a-202d), and
a second connection element on a second lateral side interconnecting the guide sides of the fenestration panel (12a-12d, 82a-82b, 202a-202d)
adapted to be arranged facing an adjacent fenestration panel (12a-12d, 82a-82b, 202a-202d) or a closing lateral element (14, 20, 216, 218), fixed to an operating ironing element (212) are arranged, wherein the first connection element and the second connection element are adapted to be displaced by means of the operating ironing element (212), and are configured to be connected, respectively, to a second connection element and a first connection element, adapted to be arranged oppositely, of an adjacent fenestration panel (12a-12d, 82a-82b, 202a-202d) or a closing lateral element (14, 20, 216, 218).

21. The arrangement according to claim 20, characterised in that the first connection element is formed by a projecting connection element (206, 226), and the second connection element is formed by a latching connection element (208, 228).
